(19) United States
(12) Patent Application Publication
(10) Pub. No.: US 2016/0286410 A1
(43) Pub. Date: Sep. 29, 2016

(54) TECHNIQUES FOR MANAGING HANDOVERS, NCLS, AND CONNECTIONS IN A RADIO NETWORK

(71) Applicant: Matthew O'Malley, Lake Balboa, CA (US)

(72) Inventor: Matthew O'Malley, Lake Balboa, CA (US)

(21) Appl. No.: 14/863,437

(22) Filed: Sep. 23, 2015

Related U.S. Application Data
(63) Continuation-in-part of application No. PCT/US2015/022342, filed on Mar. 24, 2015.

(51) Int. Cl. H04W 24/02

(52) U.S. Cl. CPC H04W 24/02

(57) ABSTRACT

Techniques for performing managing and prioritizing a plurality of cell-to-base station connections and handovers of a user equipment (UE) are described. The UE may receive a handover command to perform handover from a source base station to a target base station. The source base station may send and receive context information for the UE to the target base station, and the context information may be available to all cells of the target base station. The UE may attempt simultaneously maintain more than one source or primary cells, i.e. a first primary cell and a second primary cell; more than one target or secondary cell, i.e. a first secondary cell and second secondary cell, where handovers may occur between the cells per a list of criteria.

### BENEFIT AND REFERENCES

This Continuation-in-Part (CIP) application claims the priority benefit of U.S. Provisional Application Ser. No. 61/969,804, filed on Mar. 24, 2014, and entitled “SYSTEMS AND METHODS TO MANAGE TRAFFIC IN A MOBILE NETWORK,” the contents of which is expressly incorporated in its entirety, herein by reference; and claims benefit of a PCT Application Ser. No. PCT/US2015/22342, filed on Mar. 24, 2015, and entitled “SYSTEMS AND METHODS TO MANAGE TRAFFIC IN A MOBILE NETWORK,” the contents of which is expressly incorporated in its entirety, herein by reference.

### FIELD

Embodiments relates to the field of communications and more particularly to improved methods and systems for managing handovers, connections, and traffic on a mobile network.

### BRIEF DESCRIPTION OF THE DRAWINGS

Various features and characteristics of the non-limiting and non-exhaustive embodiments disclosed and described in this specification may be better understood by reference to the accompanying Figures, in which:

FIG. 1 is a block diagram depicting an embodiment of a typical GPRS/UMTS mobile network.

FIG. 2 is a block diagram depicting an embodiment of a Network Communication System 20 as presented.

FIG. 3 is a block diagram depicting an embodiment of the Network Communication System 20 as presented.

FIG. 4 depicts a network diagram of an embodiment of the NCS 20 for monitoring, analyzing, and managing network traffic.

FIG. 5 depicts a schematic view of one embodiment, wherein the RP 50 is communicatively coupled to a mobile switch On DPC-SSN SSx (e.g. SS7) Network 900, a mobile switch On GTT SSx (e.g. SS7) Network 901, and an Other Gateway on Other Networks 902.

FIG. 6a depicts a functional block diagram of an embodiment of the placement of the RP within an existing mobile network.

FIG. 6b also depicts a functional block diagram of an embodiment of the placement of the RP within an existing mobile network.

FIG. 6c depicts a block diagram of an embodiment of the RP 50 system for automated computing machinery comprising an exemplary network host or RP Server 52 useful in variable dynamic management of network traffic for voice/time and/or data monitoring (e.g. via the appropriate and suitable SSx (e.g. SS7)/signaling links, packet voice, packet data and/or the like), manage, analyze, and provide routing and/or overage prevention according to various non-limiting embodiments of the present disclosure.

FIG. 7a depicts an embodiment of the Fixed Routing Table (FRT), when routing by DPC-SSN is deployed end node-to-end node in a SSx (e.g. SS7) network, the FRT would preferably provide a Relay DPC and Relay CdPA for every receivable OPC and CgPA.

FIG. 7b depicts another embodiment of the FRT, when routing by GTT is deployed in an SSx (e.g. SS7) network, the Fixed Routing Table would preferably provide the Relay DPC and Relay CdPA for every receivable CgPA.

FIG. 7c depicts another more generic embodiment of the FRT, when either Routing by DPC-SSN or when Routing by GTT is deployed in an SSx (e.g. SS7) network, the Fixed Routing Table would preferably provide the Relay DPC and Relay CdPA for every receivable combination of first PMV (e.g. every conceivable first OPC and first CgPA).

FIG. 8a depicts an embodiment of the OTT, where a received TCAP message (from an MSC) that has one TCAPID where a new entry in the OTT has just been generated as a result of having received the TCAP message

FIG. 8b depicts an embodiment of the OTT, when a SCP SS7 node responds and the SCP's Originating (or Response) TCAP-ID is added to the OTT as a Response TCAP-ID .

FIG. 8c depicts an embodiment of the OTT, for example, after a TC-End type message is sent from a SCP to the MSC routed by DPC-SSN.

FIG. 8d depicts an embodiment of the OTT, for example, after a TC-End type message is sent from the MSC to the SCP routed by DPC-SSN.

FIG. 9 is a flowchart depicting a preferred embodiment of a TCAP [Transaction Capabilities Application Part] message received via a SSX (e.g. SS7) protocol from a DPC-SSN network at the Relay Platform.

FIG. 10 is a flowchart extension of FIG. 9, depicting a TCAP [Transaction Capabilities Application Part] where a message is received via a SSX (e.g. SS7) protocol from a DPC-SSN network at the Relay Platform.

FIG. 11a depicts an embodiment of the OTT, where a received TCAP message (from an MSC) that has one TCAPID where a new entry in the OTT has just been generated as a result of having received the TCAP message.

FIG. 11b depicts an embodiment of the OTT, when the SCP destination SS7 node responds and the SCP's Originating (or Responding) TCAP-ID is added to the OTT as a Response TCAP-ID..

FIG. 11c depicts an embodiment of the OTT, for example, after a TC-End type message is sent from a SCP to the MSC routed by Route by GTT (or Generic Network).

FIG. 11d depicts an embodiment of the OTT, for example, after a TC-End type message is sent from the MSC to the SCP routed by Route by GTT (or Generic Network).

FIG. 12 is a flowchart depicting alternative embodiment to the FIG. 9 embodiment, of a TCAP [Transaction Capabilities Application Part] message received via a SSX (e.g. SS7) protocol by a GTT network at the Relay Platform.

FIG. 13 is a flowchart extension of FIG. 12, depicting alternative embodiment to the FIG. 10 embodiment, where a TCAP [Transaction Capabilities Application Part] message is received via a SSX (e.g. SS7) protocol by a GTT network at the Relay Platform.

FIG. 14 depicts a lookup guide/table entitled: “Correlations of Figures/Steps with FRT and OTT Tables,” for the purpose of correlating the FRT tables in FIGS. 7a ,7b and 7c, along with the OTT tables in FIGS. 8a-8d and 11a-11d with the appropriate step labeled in FIGS. 9, 10, 12, 13, 15 and 16 in various non-limiting embodiments.

FIG. 15 is a flowchart depicting alternative embodiment to the FIGS. 9 & 12 embodiments, of a TCAP [Transaction Capabilities Application Part] message received via a SSX (e.g. SS7) protocol by a GTT network at the Relay Platform.

FIG. 16 is a flowchart extension of FIG. 15, depicting alternative embodiment to the FIGS. 10 and 13 embodiments, where a TCAP [Transaction Capabilities Application Part] message is received via a SSX (e.g. SS7) protocol by a GTT network at the Relay Platform.

FIG. 17 is a flowchart depicting a TCAP [Transaction Capabilities Application Part] transaction, for US ANSI41 or CDMA in an alternative embodiment.

FIG. 18 depicts a call flow of an embodiment employing the Relay Platform (RP) where a Mobile Device is a Prepay Subscriber connected to a Mobile Network along with a series of Detection Points (DPs).

FIG. 19 depicts an operating environment 37 in which the various systems, methods, and data structures described herein may be implemented.

FIG. 20a, depicts an example, of a relatively simple digital communication system, where the ratio Eb/No is measured at the receiver, and serves to indicate how strong is the signal, where depending on the modulation technique employed (BPSK, QPSK, etc.) and there are different curvatures for the Bit Error Rate x Eb/No.

FIG. 20b depicts an example of a simplified diagram of traditional Spread Spectrum Modulation, where the transmitter/transceiver 120 has a “Narrowband Modulated Binary Sequence” 115 step/part, say a narrowband signal with data or voice modulated.

FIG. 21a depicts an example embodiment of a rake receiver. Each signal is processed by a module called a rake finger.

FIG. 21b depicts an example of multipaths A and B1/B2.

FIG. 22a depicts an example of a hard handoff as the signal strength from one base station (Base Station 134a) becomes relatively weaker and the signal strength from another (Base Station 134b) becomes relatively stronger, prompts a handoff point 135.

FIG. 22b depicts an example of a soft handoff, where the connections to the first base station and the second base station or the say “two connections” are maintained for a period of time before releasing the connection to the first base station.

FIG. 23 is a schematic block diagram of a Universal Mobile Telecommunications System (UMTS) network architecture 222.

FIG. 24 is a schematic block diagram of an embodiment of a UMTS network architecture 223 for neighbor cell list optimization.

FIG. 25 is another embodiment of a schematic block diagram of a UMTS network architecture 242 for neighbor cell list optimization according to various non-limiting embodiments of the disclosure.

FIG. 26a depicts an illustrative diagram of existing art of a base station having three sectors. Each sector has a base station transmitter/transceiver.

FIG. 26b also depicts an illustrative diagram of existing art of the same or similar base station having three sectors and again each sector has a base station transmitter/transceiver.

FIG. 26c depicts an illustrative diagram of two overlapping base station each having three sectors and again each sector has a base station transmitter/transceiver.

FIG. 27 depicts an illustrative diagram of three overlapping base station and again each having three sectors or partitions for the Alpha Sector, Beta Sector, and a Gamma Sector.

FIG. 28a depicts an illustrative diagram of three overlapping base station and here with a different antenna transmitting pattern producing a larger overlapping pattern/area.

FIG. 28b depicts another illustrative diagram with a different overlapping antenna transmitting pattern, here with six overlapping patterns/areas.

FIG. 28c depicts an illustrative diagram with eight neighboring cells, each with a pattern of six transmitter/transceivers, as depicted in FIG. 28b.

FIG. 29 is a flowchart of existing art of a method for optimizing network neighbor cell lists. In block 350, PM data is collected regarding the performance of the network.

FIG. 30 is a flowchart of an exemplary embodiment of a method for optimizing network neighbor cell lists.

FIG. 31 is a flowchart of another non-limiting embodiment of a method for optimizing network neighbor cell lists, similar to FIG. 30, where the system would preferably be focused on collecting, generating, indexing data, tracking and testing anticipations, opposed to performing near realtime and realtime NPL proposals, criteria, and/or the like, as in FIG. 30.

FIG. 32 is a flowchart of another non-limiting embodiment of a method for optimizing network neighbor cell lists, similar to FIGS. 30 and 31, the system would preferably be focused on collecting, generating, indexing data, tracking and testing projections, opposed to performing near realtime and realtime NPL proposals, criteria, and/or the like, as in FIG. 30.

### DESCRIPTION

Acronyms/Definitions

Below is partial list of acronyms and terms with definitions per various non-limiting embodiments, but additional acronyms and/or definitions also appear throughout the disclosure/specification.

Terms and Definitions

Active Set: Set of radio links simultaneously involved in a specific communication service between a UE and a UTRAN.

Cell: A cell is a geographical area that can be identified by a UE from a (cell) identification that is broadcast from one UTRAN Access Point.

Coded Composite Transport Channel (CCTrCH): A data stream resulting from encoding and multiplexing of one or several transport channels.

The data stream of the CCTrCH is fed to a data splitter unit that splits the CCTrCH's data stream onto one or several Physical Channel Data Streams.

Contention Resolution: A functionality or procedure to solve the collision of identities on the initial random access messages from two (or more) UEs.

Forward Handover: A type of handover initiated by the UE. The UE sends the request for establishment of a new radio link in the new cell, i.e. it does not use the current radio link for performing handover but a radio link of the new cell.

Gateway UE R/Seed: A ODMA relay node that also communicates with the UTRAN using either TDD or FDD mode.

Handover: Handover is a family of procedures that adds or removes one or several radio links between one UE and UTRAN when a RRC connection exists and the position of the UE is known on cell level in the UTRAN.

Hard Handover: Hard handover is a category of handover procedures where all the old radio links in the UE are abandoned before the new radio links are established.

Logical Channel: A logical channel is an information stream dedicated to the transfer of a specific type of information over the radio interface.

ODMA Relay Node: A relay device, such as a UER or Seed, that is capable of relaying using the ODMA protocol.

Physical Channel: In FDD mode, a physical channel is defined by code, frequency and, in the uplink, relative phase (I/Q). In TDD mode, a physical channel is defined by code, frequency, and timeslot.

Physical channel data stream: In the uplink, a data stream that is transmitted on one physical channel.

In the downlink, a data stream that is transmitted on one physical channel in each cell of the active set.

Radio access bearer: The service that the access stratum provides to the non-access stratum for transfer of user data between UE and CN.

Radio frame: A radio frame is a numbered time interval of 10 ms duration used for data transmission on the radio physical channel. A radio frame is divided into 16 time slots of 0.625 ms duration. The unit of data that is mapped to a radio frame (10 ms time interval) may also be referred to as radio frame.

Radio link: The set of (radio) physical channels comprised in a transmission path between a UE to one UTRAN access point.

Radio link addition: The procedure where a new radio link is added to the active set.

Radio link removal: The procedure where a radio link is removed from the active set.

Radio Network Temporary Identifier (RNTI): A Radio Network Temporary Identifier is an identifier for a UE when an RRC connection exists. It is e.g. used by the MAC protocol on common Transport Channels (RACH, FACH, PCH).

Relay: A device capable of receiving and transmitting information for another user.

Relaying: The process of receiving and transmitting information for another user, such as carried out by a UER.

Relaylink: Relaylink is the communications line between two ODMA relay nodes.

Root Relay: ODMA relay node where communications are either sourced or sunk.

RRC connection: A point-to-point bi-directional connection between RRC peer entities on the UE and the UTRAN sides, respectively. An UE has either zero or one RRC connection.

Seed: A ODMA relay node which is deployed by a network operator and is generally fixed, constantly powered, and has no display/keypad.

Signaling connection: An acknowledged-mode link between the user equipment and the core network to transfer higher layer information between peer entities in the non-access stratum.

Signaling link: Provides an acknowledged-mode link layer to transfer the UE-UTRAN Signaling messages as well as UE—Core Network Signaling messages (using the Signaling connection).

Soft Handover: Soft handover is a category of handover procedures where the radio links are added and abandoned in such manner that the UE always keeps at least one radio link to the UTRAN.

Single Radio Voice Call Continuinty (SRVCC) provides an interim solution for handing over VoLTE (Voice over LIE) to 2G/3G networks. The voice calls on LTE network are meant to be packet switched calls which use IMS system to he made.

Transmission Time Interval: Transmission Time Interval is defined as the inter-arrival time of Transport Block Sets, i.e. the time it should take to transmit a Transport Block Set. It is always a multiple of 10 ms (the length of one Radio Frame).

Transport Block: Transport Block is defined as the basic unit passed down to L1 from MAC, for L1 processing. An equivalent term for Transport Block is “MAC PDU”.

Transport Block Set: Transport Block Set is defined as a set of Transport Blocks which is passed to L1 from MAC at the same time instance using the same transport channel. An equivalent term for Transport Block Set is “MAC PDU Set”.

Transport Block Set Size: Transport Block Set Size is defined as the number of bits in a Transport Block Set.

Transport Block Size: Transport Block Size is defined as the size (number of bits) of a Transport Block

Transport channel: The channels offered by the physical layer to Layer 2 for data transport between peer L1 entities are denoted as Transport Channels

Different types of transport channels are defined by how and with which characteristics data is transferred on the physical layer, e.g. whether using dedicated or common physical channels are employed.

Transport Format

A Transport Format is defined as a format offered by L1 to MAC for the delivery of a Transport Block Set during a Transmission Time Interval on a Transport Channel The Transport Format constitutes of two parts—one dynamic part and one semi-static part.

Transport Format Combination

A Transport Format Combination is defined as the combination of currently valid Transport Formats on all Transport Channels of a UE, i.e. containing one Transport Format from each Transport Channel.

Transport Format Combination Set: A Transport Format Combination Set is defined as a set of Transport Format Combinations to be used by a UE.

Transport Format Combination Indicator (TFCI): A Transport Format Combination Indicator is a representation of the current Transport Format Combination.

Transport Format Indicator (TFI): A label for a specific Transport Format within a Transport Format Set.

Transport Format Set: A Transport Format Set is defined as the set of Transport Formats associated to a Transport Channel

URA updating: URA updating is a family of procedures that updates the UTRAN registration area of a UE when a RRC connection exists and the position of the UE is known on URA level in the UTRAN.

User Equipment/Relay enabled (UE R): A UE with ODMA relay operation enabled.

UTRAN Registration Area (URA): The UTRAN Registration Area is an area covered by a number of cells. The URA is only internally known in the UTRAN.

UTRAN access point: A conceptual point within the UTRAN performing radio transmission and reception. A UTRAN access point is associated with one specific cell, i.e. there exists one UTRAN access point for each cell. It is the UTRAN-side end point of a radio link.

Some Abbreviations

3GPP: Third Generation Partnership Project

ARQ: Automatic Repeat Request

BCCH: Broadcast Control Channel

BCH: Broadcast Channel

BER: Bit Error Rate

BLER: Block Error/Erasure Rate

BPSK: Binary Phase Shift Keying

BSS: Base Station System

BTS: Base Station OR

BTS: Base Transceiver Station

C-: Control-

CC: Call Control

CCCH: Common Control Channel

CCH: Control Channel

Cctrch: Coded Composite Transport Channel

CDMA: Code Division Multiple Access

CN: Core Network

CRC: Cyclic Redundancy Check

DC: Dedicated Control (SAP)

DCA: Dynamic Channel Allocation

DCCH: Dedicated Control Channel

DCH: Dedicated Channel

DHO: Diversity Handover

DL: Downlink

DRNC: Drift Radio Network Controller

DS-CDMA: Direct-Sequence Code Division Multiple Access

DSCH: Downlink Shared Channel

DTCH: Dedicated Traffic Channel

DTX: Discontinuous Transmission

EARFCN EUTRA Absolute Radio Frequency Channel Number

EUTRA Evolved Universal Terrestrial Radio Access

FACH: Forward Link Access Channel OR

FACH: Forward Access Channel

FAUSCH: Fast Uplink Signaling Channel

FCS: Frame Check Sequence

FDD: Frequency Division Duplex

GC: General Control (SAP)

HO: Handover

HHO: Hard Handover

IE: Information Element

ITU: International Telecommunication Union

Kbps: Kilo-Bits Per Second

KPI: Key Performance Indicators

Ksps: Kilo-Symbols Per Second

L1: Layer 1 (Physical Layer)

L2: Layer 2 (Data Link Layer)

L3: Layer 3 (Network Layer)

LAC: Link Access Control

LTE: Long Term Evolution (EUTRA Network)

LTE-A: LTE-Advanced MAC: Medium Access Control

VoLTE: Voice over LTE

MM: Mobility Management

Mcps: Mega-Chips Per Second

MIB: Master Information Block

NCFC: Neighboring Cell or Frequency Candidates

NCL: Neighbor Cell List

Nt: Notification (SAP)

OAM: Operation And Administration Maintenance

OCCCH: ODMA Common Control Channel

ODCCH: ODMA Dedicated Control Channel

ODCH: ODMA Dedicated Channel

ODMA: Opportunity Driven Multiple Access

ORACH: ODMA Random Access Channel.

ODTCH: ODMA Dedicated Traffic Channel

PCCH: Paging Control Channel

PCH: Paging Channel

PDU: Protocol Data Unit

PHY: Physical Layer

Phych: Physical Channel

PM: Performance Measurements

Qos: Quality Of Service

RACH: Random Access Channel OR

RACH: Resources Access Channel

RAN: Radio Access Network

RE: Radio Frequency

RLC: Radio Link Control

RNC: Radio Network Controller

RNS: Radio Network Subsystem

RNTI: Radio Network Temporary Identity

RRC: Radio Resource Control

RRM: Radio Resource Management

Rxqual: Received Quality Of Speech

SAP: Service Access Point

SCCH: Synchronization Control Channel

SCH: Synchronization Channel

SDU: Service Data Unit

SIB: System Information Block

SI: System Information

SIR: Signal-To-Interference Ratio

SIU: System Information Update

SRNC: Serving Radio Network Controller

SRNS: Serving Radio Network Subsystem

SRVCC: Single Radio Voice Call Continuity

TCH: Traffic Channel

TDD: Time Division Duplex

TFCI: Transport Format Combination Indicator

TFI: Transport Format Indicator

TN: Termination Node

TPC: Transmit Power Control

TRX: Transmitter/Receiver

U-: User-

UARFCN: UTRA Absolute Radio Frequency Channel Number

UE: User Equipment

UER: User Equipment With ODMA Relay Operation Enabled

UL: Uplink

UMTS: Universal Mobile Telecommunications System

URA: UTRAN Registration Area OR

URA: UMTS Registration Area

UTRA: UMTS Terrestrial Radio Access

UTRAN: UMTS Terrestrial Radio Access Network

### SUMMARY

This summary herein is provided to introduce a selection of concepts in a simplified form that are further described below in the Detailed Description. This summary is not intended to exclusively identify key features or essential features of the claimed subject matter, nor is it intended as an aid in determining the scope of the claimed subject matter. Further, the numbering employed in this summary is not related to the numbering of specific parts or steps, but rather for contextual relationships.

Method 1. A computer-implemented method for managing a radio network, comprising: retrieving and evaluating a first criteria electronically stored in an Operation and Administration Maintenance (OAM) module; obtaining and evaluating capabilities and indicia of an active mobile terminal or User Equipment (UE) in an at least one radio network comprising a plurality of cells or frequencies regarding the capability of the active mobile terminal or User Equipment (UE) for a pairing from an at least one primary cell or frequency to a handover to an at least one secondary cell or frequency in the plurality of cells or frequencies according at least in part to the first criteria; obtaining and evaluating capabilities and indicia of the at least one radio network comprising a plurality of cells or frequencies regarding the capability of the active mobile terminal or User Equipment (UE) for the pairing from the at least one primary cell or frequency to the handover to the at least one secondary cell or frequency in the plurality of cells or frequencies according at least in part to the first criteria; and generating a prioritized list of Neighboring Cell or Frequency Candidates (NCFC) according at least in part to the first criteria, wherein OAM persistently generates prioritized NCFC comprising at least two primary cells or frequencies.

Method 2. The computer-implemented method of Method 1, wherein the generated and prioritized list of NCFC comprises prioritized primary cells and secondary cells according at least in part to the first criteria.

Method 3. The computer-implemented method of Method 2, wherein the primary cells or frequencies are sourcing cells or frequencies for an active connection with the active mobile terminal or User Equipment (UE).

Method 4. The computer-implemented method of Method 3, wherein the secondary cells or frequencies are target cells or frequencies for a handover.

Method 5. The computer-implemented method of Method 4, wherein OAM persistently generates prioritized NCFC comprising at least two secondary cells or frequencies.

Method 6. The computer-implemented method of Method 5, wherein OAM persistently generates prioritized NCFC comprising at least two tertiary cells or frequencies.

Method 7. The computer-implemented method of Method 6, wherein the active mobile terminal or User Equipment (UE) can employ more than one primary cell or frequency simultaneously.

Method 8. The computer-implemented method of Method 7, wherein the active mobile terminal or User Equipment (UE) can employ more than one secondary cell or frequency simultaneously.

Method 9. The computer-implemented method of Method 8, wherein an employment of more than one primary cell or frequency simultaneously may be accomplished by a smart transceiver or smart antenna.

Method 10. The computer-implemented method of Method 9, wherein the employment of more than one primary cell or frequency simultaneously may be accomplished by a multi-frequency transceiver or antenna.Method

11. The computer-implemented method of Method 10, wherein the employment of more than one primary cell or frequency simultaneously may be accomplished by a multi-frequency transceiver or smart antenna.

Method 12. The computer-implemented method of Method 11, wherein a base station selectively transmits to more than one primary cell or frequency simultaneously.

Method 13. The computer-implemented method of Method 12, wherein the base station selectively transmissions to more than one primary cell or frequency simultaneously can employ more than one radio technology.

Method 14. The computer-implemented method of Method 1, wherein the evaluation of the first criteria may occur in part at a base station operatively coupled to the at least one radio network.

Method 15. The computer-implemented method of Method 1, wherein the active mobile terminal or User Equipment (UE) is paired with a Node B belonging to the plurality of cells or frequencies in the at least one radio network.

Method 16. The computer-implemented method of Method 1, wherein the evaluation of the capability of an active mobile terminal or User Equipment (UE) may comprise more than one radio network each comprising the plurality of cells or frequencies regarding the capability of the active mobile terminal or User Equipment (UE) for a handover from the at least one primary cell or frequency to the handover to the at least one secondary cell or frequency in the plurality of cells or frequencies according at least in part to the first criteria.

Method 17. The computer-implemented method of Method 1, wherein the receiving and evaluating of the first criteria, further comprises a second criteria, the second criteria comprising a proximity criteria, a signal strength criteria, a relative historical handover success rate criteria, a quality of service criteria, a bandwidth criteria, a throttle criteria, a congestion limitation criteria, a temporal criteria, an emergency criteria, and an override criteria.

Method 18. The computer-implemented method of Method 1, wherein the receiving and evaluating of the first criteria, further comprises a third criteria, the third criteria comprising a UE device type criteria, a UE software version criteria, a UE plan level criteria, and a UE location criteria, a UE proximity criteria, a UE consumption criteria, a UE usage criteria, a UE history criteria, and a UE exception criteria.

Method 19. The computer-implemented method of Method 1, wherein the obtained and evaluated capabilities and indicia of the active mobile terminal or User Equipment (UE) in an at least one radio network comprising performance measurements (PM) and key performance indicators (KPI). Method 20. The computer-implemented method of Method 1, wherein the obtained and evaluated capabilities and indicia of the at least one radio network comprising performance measurements (PM) and key performance indicators (KPI).

Method 21. The computer-implemented method of Method 1, wherein the evaluation of the first criteria occurs entirely at the OAM module.

Method 22. The computer-implemented method of Method 1, wherein the evaluation of the first criteria occurs entirely at a Radio Network Controller.

Method 23. The computer-implemented method of Method 1, wherein the evaluation of the first criteria occurs entirely at the active mobile terminal or User Equipment (UE).

Method 24. The computer-implemented method of Method 1, wherein the evaluation of the first criteria occurs entirely at a passive mobile terminal or User Equipment (UE).

Method 25. The computer-implemented method of Method 1, wherein the evaluation of the first criteria occurs entirely at a base transmission station operatively coupled to the at least one radio network.

Method 26. The computer-implemented method of Method 1, wherein the evaluation of the first criteria may occur in part at the OAM module.

Method 27. The computer-implemented method of Method 1, wherein the evaluation of the first criteria may occur in part at the Radio Network Controller.

Method 28. The computer-implemented method of Method 1, wherein the evaluation of the first criteria may occur in part at the active mobile terminal or User Equipment (UE).

Method 29. The computer-implemented method of Method 1, wherein the evaluation of the first criteria may occur in part at a passive mobile terminal or User Equipment (UE).

In addition to the above, a main object of the present disclosure is to overcome at least some of the deficiencies of the prior art and current state of the art. This object is achieved by the elements defined in the appended independent claims. Optional features and alternative embodiments are defined in the subsidiary claims.

### DETAILED DESCRIPTION

Turning From the Acronyms and Definitions to the Detailed Description.

With the ever increasing proliferation of communication modes, features, and applications, especially with mobile devices, network providers, mobile network operators (MNO), hardware manufacturers, application providers, third-party application providers, Software as a Service (SaaS) providers and/or the like, are continually searching for systems and methods to best manage, connect, route, deliver, analyze, and monitor enhanced services and products. Besides voice (e.g. mobile phone calls), features and applications may incorporate such content as text, images, audio, video, maps, polls, and/or the like, where users may wish to communicate (e.g. voice, voicemail, email, IM, SMS, MMS, Chat, Social, and/or the like), consume content (e.g. view text/images/video, hear audio, feel alerts, and/or the like), share content (e.g. playlists, calendars, tasks, feedback, chat/social threads, contacts, and/or the like), and features such as prepay/postpay, location-based services, roaming, and/or the like.

These enhanced services and products also create network access and QoS management issues, where, for example, a third party Software As A Service (SAAS) providers may have limited access to virtually no access to network data or resources (and thus limited functionality), say per a particular network provider (e.g. MO and/or MNO). For example, regarding a particular subscriber, subscriber account (prepay/postpay), location, device, and/or the like. Thus there are challenges to not only third-parties, such as the SAAS providers, but even other mobile network providers, other mobile network operators, other network providers, the user/subscriber, and/or the like. Where each is challenged to provide services either require or benefit from realtime or near realtime access to a particular data source, say from a particular MN and/or MNO, such as the HLR, BSS/OSS, VLR, and/or the like. In addition, mobile network traffic may occasionally suffer from dropped calls, poor connections, faulty handoffs, assumed overages, assumed locations, assumed billing issues, assumed subscriber data, overage, and/or the like.

Consequently there is a demand for systems and methods for better managing mobile network traffic. One that can improve realtime and near realtime decisions and data access where there may be limited access to a particular data source, updates, alerts, and/or the like. In an embodiment, supporting services would preferably employ dynamic, logic-based, intelligent networks, and/or the like, to help meet this demand, and/or discover new relevant traffic data, methods, subscriber information, locations, network QoS and availability per: service provider, application, network, SaaS provider, device, subscriber, product, opportunity, goal, concern, conflict, strategy, and/or the like.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” “in another embodiment,” and similar language throughout this specification may, but do not necessarily, all refer to the same embodiment.

As used herein, the term “modules,” and as employed herein, is considered a computer-executable program stored on a computer-readable storage medium. These modules provide information to a User/Subscriber 46, with the modules carrying one or more sequences of instructions, wherein execution of the one or more sequences of instructions by one or more processors embodied therein causes the one or more processors to perform a method for providing information via a Controller 114 to the User/Subscriber 46 using a computer (e.g. a laptop computer, a desktop computer, a cellular phone, a wireless-enable-computer, and/or the like), typically with a display and input method (e.g. keypad, touchscreen, audio commands, speaker, audio translator, and/or the like) as a communication device.

A party who is operationally connected to an Relay Platform (RP) 50 using the communication device operationally connected to a Network Communication System (NCS) 20, where he/she/it may potentially relay and/or exchange information with the RP 50, together referred to as an Account (e.g. a mobile subscriber 46a, Subscriber 46b, User 46c, third party, third party network provider, third party service provider, SaaS provider, mobile network provider, device manufacturer, advertiser, application provider, and/or the like).

In an embodiment, the communication device may be a phone, such as a cell phone, mobile phone, smart phone, landlines, PDA phone, or the like that may be employed in a mobile network (e.g. a cellular network, data network, voice network, subscriber network, and/or the like). In an embodiment, the communication device may also be a Voice over Internet Protocol (VoIP) device/client. For example, the communication device may be a computing device, such as a desktop computer, laptop computer, tablet computer, or PDA, with software enabling the computing device to make VoIP calls over the Internet, or the communication device could simply be a device that plays audio and accepts commands, such as voice commands. Some embodiments do not require the communication device to have voice communication capabilities and/or where voice communications or commands are not required or utilized. Whereas, some embodiments do not require the communication device to have data communication capabilities and/or where data communications or commands are not required or utilized (e.g. an analog telecommunications environment).

The term “modules” is used in some embodiments of the present disclosure. Modules can be implemented in software for execution by various types of processors. An identified module of executable code can, for instance, comprises one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

Further, storage medium can include, but is not limited to, one or more of the following: any type of physical media, including floppy disks, optical discs, DVDs, CD-ROMs, microdrives, magneto-optical disks, holographic storage devices, ROMs, RAMs, EPROMs, EEPROMs, DRAMs, PRAMS, VRAMs, flash memory devices, magnetic or optical cards, nano-systems (including molecular memory ICs); paper or paper-based media; and any type of media or device suitable for storing instructions and/or information. Various embodiments include a computer program product that can be transmitted in whole or in part and over one or more public and/or private networks wherein the transmission includes instructions and/or information which can be used by one or more processors to perform any of the features presented herein.

A module of executable code can be a single instruction, or many instructions, and may even be distributed over several different code segments, among different programs, and across several memory devices. Similarly, operational data may be identified and illustrated herein within modules, and may be embodied in any suitable form and organized within any suitable type of data structure. In an embodiment, the operational data may be collected as a single data set, or may be distributed over different locations including over different storage devices, and may exist, at least partially, merely as electronic signals on a system or network. In an embodiment, these modules track, analyze, and relay voice and/or data traffic of the NCS 20, carrying one or more sequences of instructions, wherein execution of the one or more sequences of instructions by one or more processors embodied therein causes the one or more processors to perform a method for relaying and/or exchanging information with an Relay Platform 50, to a user of the NCS 20.

FIG. THE DRAWINGS

The following description and the annexed drawings set forth in detail certain illustrative features of the one or more aspects. These features are indicative, however, of but a few of the various ways in which the principles of various aspects may be employed, and this description is intended to include all such aspects and their equivalents.

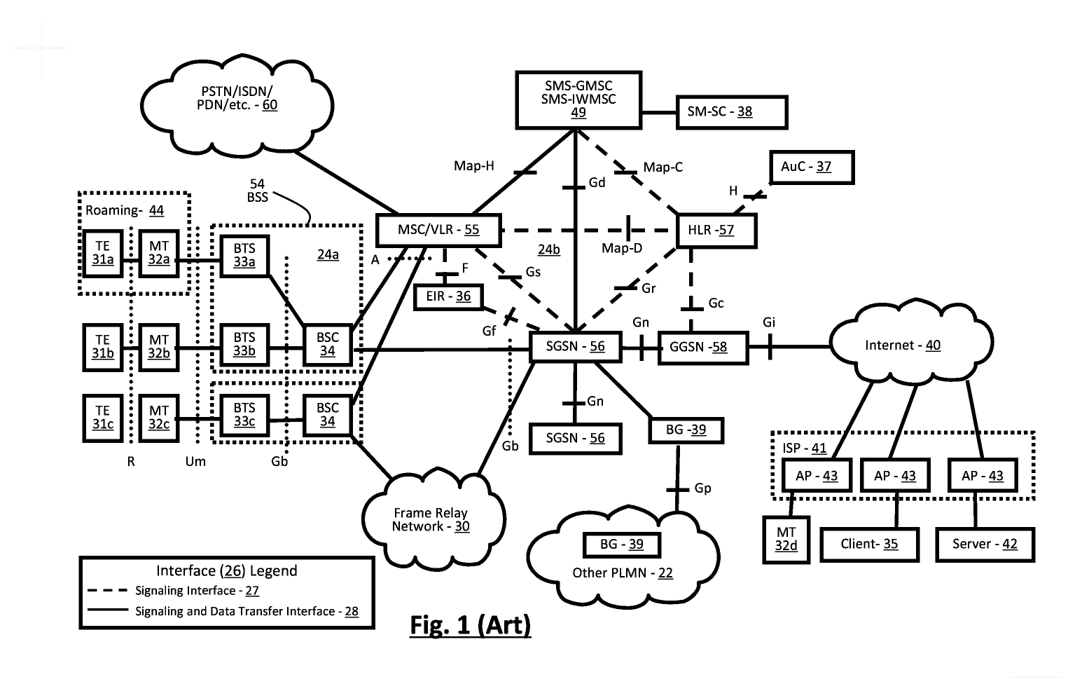

FIG. 1 is a block diagram depicting an embodiment of a typical GPRS/UMTS mobile network. U.S. Pat. No. 7,466,652 B2 to Lau et al entitled “Auto-IP Traffic Optimization in Mobile Telecommunications Systems” is hereby incorporated by reference in its entirety for all purposes, where the abstract states: A system and method for the implementation of fine-grained quality of service in a mobile telecommunications environment uses an Auto-IP Policy Decision Point (PDP) to determine what traffic optimizations actions should be taken in reaction to various network conditions. The Auto-IP PDP uses as inputs information from a Gb interface probe to determine the user identification of an IP data flow, information from the radio access network (RAN) network management system (NMS) regarding network congestion.

Here in FIG. 1, the cell traffic information is passed onto a traffic analysis and processing engine, the Auto-IP PDP which maps the real-time traffic information into an n-dimensional traffic model. An automated policy decision guiding algorithm is executed on the n-dimensional traffic model and selects policy based on the traffic and cell congestion conditions, without human intervention. Additionally, a consistency check is performed to ensure that new policies are consistent with existing policies. The policy decision outcome is forwarded to the Auto-IP Traffic Optimizer that acts on the network at a point in the network (G,) that is different from where traffic problem occurs in the RAN. The Auto-IP Traffic Optimizer implements the decisions of the Auto IP-PDP by performing traffic shaping, TCP window clamping or other traffic optimization procedures on a cell-by-cell basis, call-by-call basis, TCAP-ID-by-TCAP-ID basis, and/or trigger-by-trigger basis.

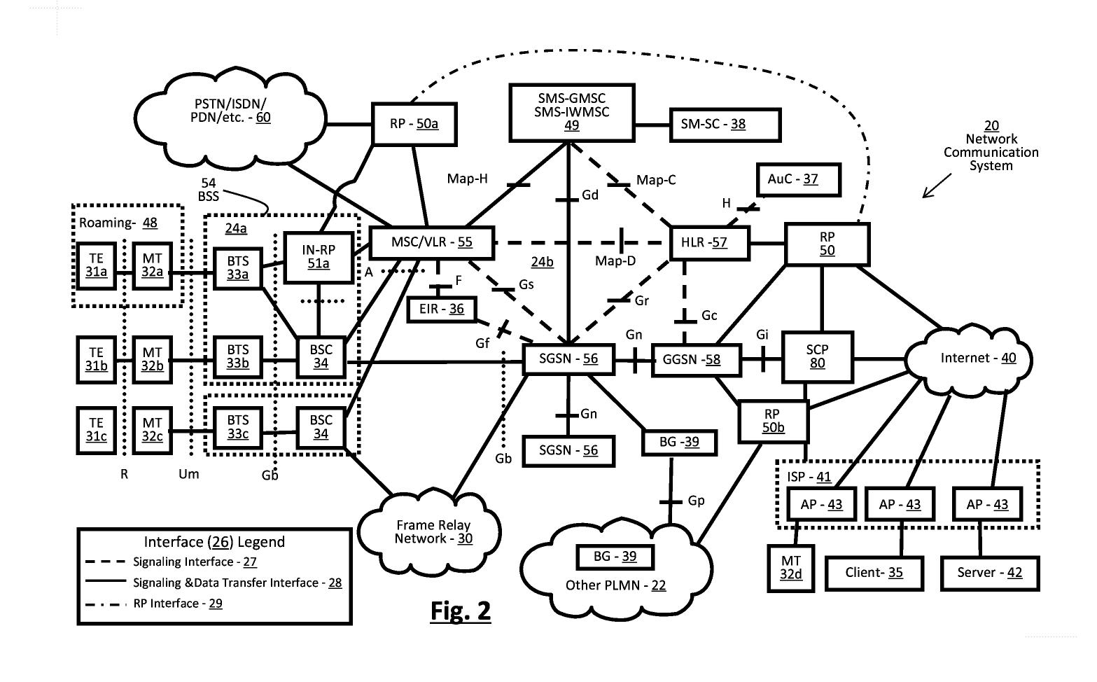

FIG. 2 is a block diagram depicting an embodiment of a Network Communication System 20 as presented. The Network Communication System (NCS) 20 may comprise any network (e.g. Mobile, LAN/ WAN, WLAN, MAN, Internet, Intranet, and/or the like) depicted here as a Mobile Network 24 (e.g. 24a, 24b); operationally connected to a Public Switched Telephone Network (PSTN), Integrated Services Digital Network (ISDN), Public Data Network (PDN), etc. (PSTN/ISDN/ PDN/ Etc.) 60; a Relay Platform (RP) 50, an internet 40, Other Public Mobile Network (PLMN) 22, Frame Relay Network 30, and/or the like; where each may be operatively connected to each other and/or a variety of computer switches, routers, control-points, clients, communication devices, servers, storage, devices, peripherals, and/or the like.

In an embodiment, the RP 50 (e.g. depicted as the RP50, an RP 50a and an RP 50b) would preferably reside outside the mobile network 24, where the RP 50 is operationally connected to the mobile network 24 via the communication link that allows for the appropriate and suitable SSx (e.g. SS7)/signaling links, packet voice, packet data and/or the like, traffic, managing, routing, monitoring, and analyzing. In an embodiment, an IN-RP 51 (e.g. depicted as an IN-RP 51a and an IN-RP 51b) would preferably operation similarly to the RP 50, but would preferably reside inside the mobile network 24. In an embodiment, the In-RP 51 is operationally connected to the mobile network 24 via the communication link that allows for appropriate and suitable SSx (e.g. SS7)/signaling links, packet voice, packet data and/or the like, traffic managing, routing, connecting, delivering, monitoring, and analysis. In an embodiment, the IN-RP 51 may also operationally connect to the RP 50 outside the mobile network 24, where both the In-RP 51 and the RP 50 are operationally connected to the mobile network 24 via the communication link that allows for appropriate and suitable SSx (e.g. SS7)/signaling links, packet voice, packet data and/or the like, traffic managing, routing, connecting, delivering, monitoring, and analysis.

In an embodiment, each operational connection, communication link, protocol, and/or the like, inside the NCS 20 may be any type suitable for a functioning network protocol, connection, communication link and/or the like, such as a Transmission Control Protocol (TCP) connection, a Transmission Control Protocol/Internet Protocol (TCP/IP) connection, a User Datagram Protocol (UDP), a User Datagram Protocol/Internet Protocol (UDP/IP), a hypertext transfer protocol (HTTP) and/or the like. In an embodiment, the network connection and communication link/protocol may also incorporate and/or comprise a Signal System Number 7 (SS7) network with a Voice Trunk Connection (SS7/VTC), an IP Multimedia Subsystem (IMS) or other Long Term Evolution (LTE) communication protocols, communication links, connections, and/or the like.

In an embodiment, there is an at least one Mobile Network Operator (MNO) 42, which is preferably operationally connected to an at least one Relay Platform 50 and where the MNO 25 typically has clients, subscribers, and/or users comprising Cellular Clients 104, Mobile Clients 61, Account Clients 103, and/or the like. In various non-limiting embodiments, the RP and SCP are interchangeable. In various non-limiting embodiments, the RP, SaaS Providers, and/or SCP are interchangeable. In various non-limiting embodiments, Account Clients and Accounts are interchangeable. In various non-limiting embodiments, Accounts and SasS providers are interchangeable. In various non-limiting embodiments, Accounts, SaaS providers, SCPs and/or SCPs are interchangeable. In various non-limiting embodiments, Accounts, SaaS providers, and/or MNOs are interchangeable.

In an embodiment, there may be a plurality of Mobile Network Operators 42 independently connected (not shown). In an embodiment, the Mobile Network Operators 42 would preferably incorporate traditional equipment and means for communication and data relay and/or data exchange comprising cell towers which allow calling parties to operationally connect via radio-telecommunications links and where the cell tower is operationally connected to a mobile switching center (MSC) 140 over multi-frequency (MF) trunk. The MSC generally includes a plurality of loop-back trunks, where the loop-back trunk has an outbound side and an inbound side with respect to the MSC.

Mobile Switching Centre (MSC)

The MSC, in general, is the mobile network subsystem's central component, where typically a large number of Base Station Controllers (BSCs) are connected and where the MSC is effectively a regular ISDN switch that connects to the BSCs via the A-interface. The MSC provides routing of incoming and outgoing calls and assigns user channels on the A-interface and acts like a normal switching node of the PSTN or ISDN and typically provides the functionality for handling a mobile station, including registration, authentication, location updating, inter-MSC handovers, and call routing to a roaming subscriber. The MSC can also provide connections to public fixed networks. In GSM call routing, the MSC, together with the HLR and VLR provide call routing and roaming capabilities.

U.S. Pat. No. 5,396,543 to Beeson, Jr. et al entitled “Signaling arrangements in a cellular mobile telecommunications switching system” is hereby incorporated by reference in its entirety for all purposes, where the abstract states: Apparatus and methods for providing cellular mobile telecommunication service in accordance with the requirements of the Global Systems for Mobile Communications (GSM) standard. A modular switching system is provided which performs the functions of the mobile switching center, plus those of a home location register, authentication center, visitor location register, and equipment identity register. In an embodiment, the latter functions are advantageously spread among the modules of the switching system, thus avoiding the getting started cost of expensive dedicated data bases. A wireless global switching module advantageously switches mobile communications control messages among the modules of the system and between the modules and the base station systems, and terminates signaling links between the mobile switching center and the base station systems.

U.S. Pat. No. 5,459,727 to Vannucci entitled “Wireless Telecommunication System” is hereby incorporated by reference in its entirety for all purposes, where the abstract states: The present disclosure overcomes the prior art limitations by dividing a coverage area into very small regions or cells. The inventive system may be built as an adjunct to a wired telecommunication system such as a PBX. Advantageously, because of the relatively small size of each cell, transceivers in the inventive system may use very low transmission power, compared with a pico-cellular communications system, to communicate with a fixed transceiver. In addition, because of the relatively short distance between the mobile handset and the fixed transceiver, the communication paths between any two transceivers are reduced and, therefore, the multipath distortion which may affect the received signals is substantially reduced.

U.S. Pat. No. 5,101,501 to Gilhousen et al entitled “Method and system for providing a soft handoff in communications in a CDMA Cellular Telephone System” is hereby incorporated by reference in its entirety for all purposes, where the abstract states: In a cellular telephone system a system for directing communications between a mobile user and cell-sites as a mobile user changes cell-site service areas. The mobile user includes an apparatus for, while in communication with another system user via one cell-site, determining a transition of the mobile user from the cell-site service area to the service area of another cell-site. The system includes circuitry responsive to the indication for coupling communications between the mobile user and the other system user via the new cell-site while the mobile user also remains in communication with the system user via the first cell-site. The system further includes apparatus responsive to the coupling of the communications between the mobile user and the other system user via the new cell-site for terminating the communications between the mobile user and another system user via cell-site with communications continuing between the mobile user and the system user via the new cell-site.

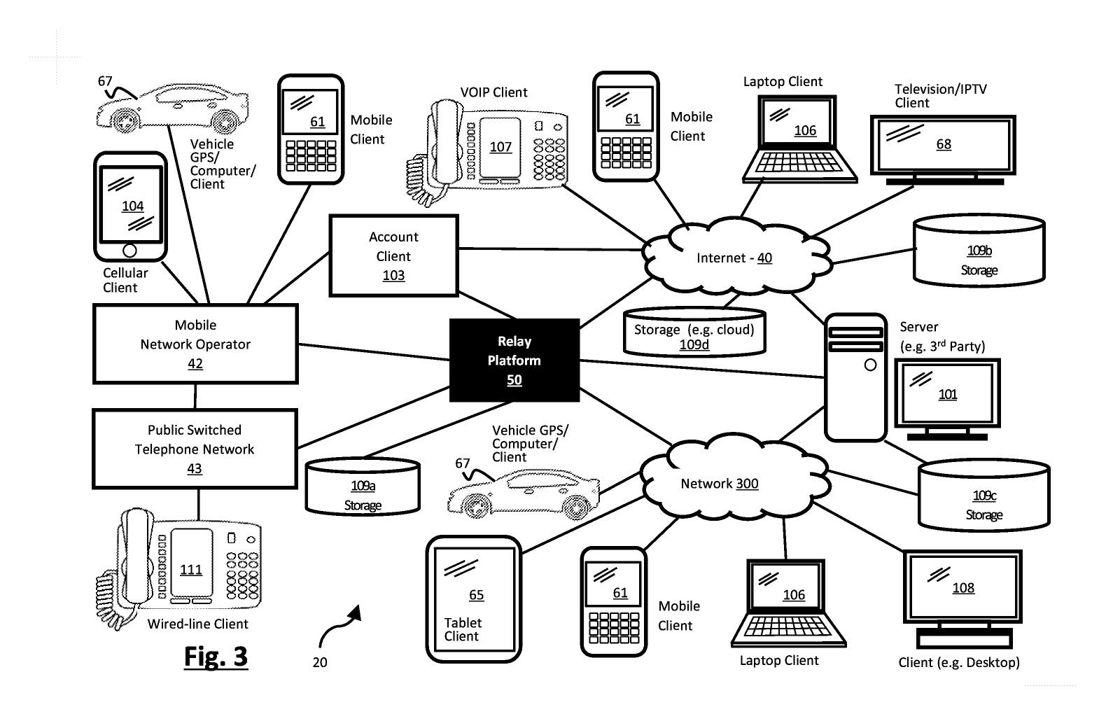

FIG. 3 is a block diagram depicting an embodiment of the Network Communication System 20 as presented. In an embodiment, the Relay Platform 50 monitors and manages voice/data traffic, TCAP message relaying, QoS, interactions, requests, updates, and/or the like, of a plurality of network communication devices/users. The plurality of network communication devices/users, in general, the network communication user utilizes a computer client/communication device comprising a Laptop Client 106, a Client 108 in-general (e.g. a desktop client), a Cellular Client 104, a Mobile Client 61, wireless-enable-computer/client, a Tablet Client 65, a vehicle with GPS and computer/client 67, a Television/IPTV Client 68, a VOIP Client/phone 107, a Server 101 (e.g. a Third-Party Server 101a), and/or the like, typically with a display and input method (e.g. keypad, touchscreen, audio commands, speaker, audio translator, and/or the like) as the communication device. In an embodiment, the Relay Platform 50 system, modules, and associated computer implemented methods track, manage, connect, route, and analyze voice/time and/or data traffic, requests, and/or the like, of the NCS 20 (e.g. appropriate and suitable SS7/signaling links, packet voice, packet data and/or the like, networks) and the plurality of operationally connected network communication devices/users.

In an embodiment, the Public Switched Telephone Network 43 would preferably operatively communicate, relay, and/or exchange voice/time and/or data with the Relay Platform 50 and allow communications, relay, and voice/time and/or data exchange with typically a Wired-Line Client 111 (not depicted here_, and/or the like. In an embodiment, there may be a plurality of PSTN 43 independently connected (not shown). In an embodiment, the PSTN 43 may incorporate traditional equipment and means for communication, relay, and voice/time and/or data exchange.

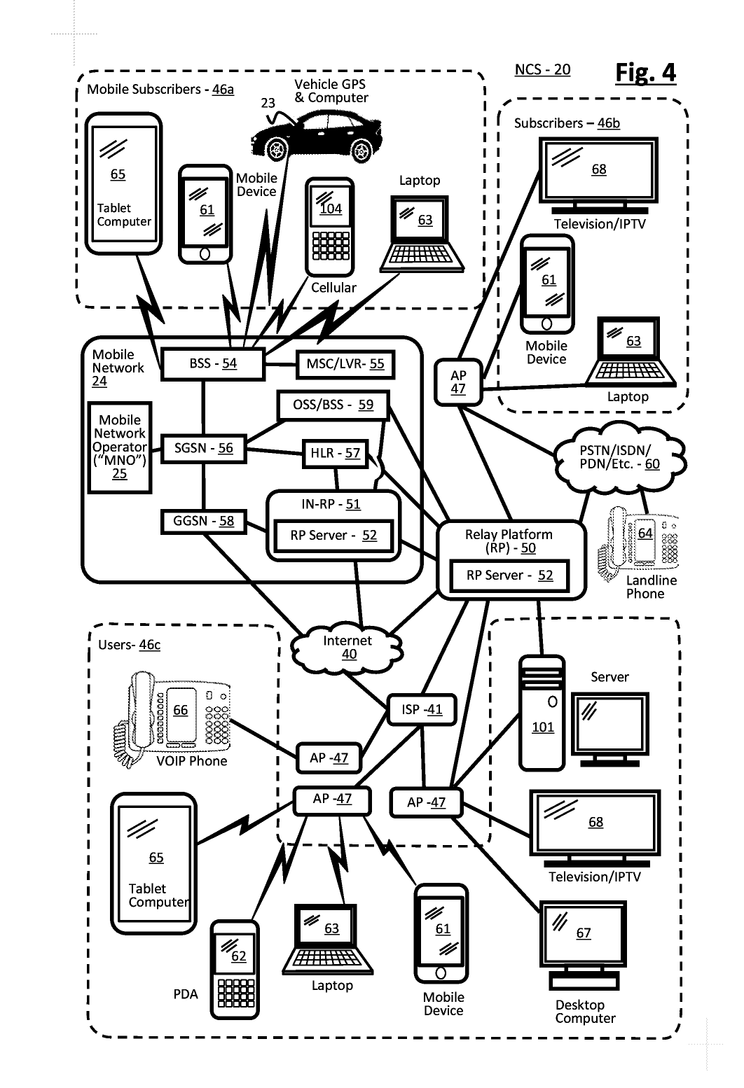

In an embodiment, the RP 50 may communicate with the Mobile Network Operator 42 from, in one embodiment, outside the network via any communication connection via the SS7VTC and/or the TCP/IP connection. In an embodiment, the RP 50 and/or components of the RP 50 may also be located within another environment, say within a Communications System 24a environment (see IN-RP 51 in FIG. 4 inside the Mobile Network 24, inside the MNO, and/or inside the MNO's MSC). In an embodiment, the RP 50 is also operatively connected to the Account Client 103 that may be via any type network connection that allows for voice and/or data communication, say a wired connection such as the TCP/IP connection, but may also be via a wireless connection.

In an embodiment, the RP 50 is typically also operatively connected to the Internet 40 and/or the Network 300 where each may allow for a variety of computer client and server two-way communications, such as a VOIP Client 107, the Mobile Client 61, a Desktop Client 108, the Server 101 (e.g. the 3rd-Party Server), and/or the like. In an embodiment, the RP 50 is typically also operatively connected to Storage 109a medium. In an embodiment, the Storage 109 medium may incorporate and/or comprise a plurality of hardware devices, virtual hardware, software, and methodologies, including stand-alone hardware, a Storage 109b medium through the Internet 40 and/or the Network 300, storage interconnected via other computers/devices such as a Storage 109c medium, storage medium in the cloud, and/or the like.

In general, mobile telecommunication systems support the Signaling System 7 (SS7) Integrated Services Digital Network User Part (ISUP) call control protocol. One system for delivering enhanced services in an ISUP network is described in U.S. Pat. No. 5,377,186 to Wegner, et al. The system uses a Local Switch (LS) connected through the network to a Service Control Point (SCP) wherein a subscriber services database resides. The SCP generally retrieves call processing information to forward a call to a desired final destination. The LS is provisioned for ISUP. A number of loop-back trunks with defined Circuit Identification Code (CIC) pairs are also provisioned on the LS. The routing table in the LS is modified to route the voice signal for calls requesting the enhanced subscriber service to the outbound connection of one of the loop-back trunks, and to route to the SCP the associated ISUP messages. The SCP is modified so that an ISUP interface will perform limited switch-type functions, e.g., number translation, using parameters in the 40 ISUP call-setup messages that were originally intended for conditions such as call forwarding. To the network, the SCP appears to be a switch.

FIG. 4 depicts a network diagram of an embodiment of the NCS 20 for monitoring, analyzing, and managing network traffic. Here, a plurality of Users (e.g. Mobile Subscribers/Subscribers/Users) 46 are interconnected via a variety of methods (e.g. networks and computer clients/devices). In various non-limiting embodiments, the RP 50 would preferably provide the computer devices/clients (e.g. devices with associated mobile subscribers 46, 46a, 46b, and 46c (users)) an ability to manage, analyze, relay, and track the voice/time and/or data traffic over the network 300 (e.g. via an Internet 40; a Mobile Network 24; and/or a Public Switched Telephone Network (PSTN), an Integrated Services Digital Network (ISDN), Public Data Network (PDN), etc. (collectively referred to here as a PSTN/ISDN/PDN/ Etc.) 60, with any type of viable and operational communication connection and computer/device, where, for example, the RP 50/IN-RP 51 may relay, monitor, analyze, and/or manage traffic.

In various non-limiting embodiments, the User/Subscriber(e.g. 46a, 46b, and 46c) are operationally connected to the RP (and/or IN-RP 51) directly and/or via a Probe 69 (depicted in FIG. 4). In various non-limiting embodiments, the Probe 69 receives and/or sends (via appropriate and suitable SSx (e.g. SS7)/signaling links) packet voice, packet data and/or the like, traffic flow, and/or the like, with/to/from the RP 50 (&/or IN-RP 51). In various non-limiting embodiments, the Probe 69 has some or all the functionality of the RP 50/Relay Platform Module (RPM) 53.

In various non-limiting embodiments, the network 300 may be, without limitation, a wireless network, such as a mobile network (MN) 24 (e.g. GSM, CDMA, TDMA, or LTE); routed on a DPC-SSN SSx (e.g. SS7) network, and/or a GTT SSx (e.g. SS7) network; a wireless local area network (WLAN); a wireless Metropolitan area network (WMAN); and/or the like, or any combination thereof. In various non-limiting embodiments, the Mobile Network 24 comprises a MSC or Mobile Switching Center (MSC) and a VLR or Visiting/Visitor Location Register (VLR), collectively a MSC/LVR 55; a OSS or Operations Support Systems (OSS) and a BSS or Business Support Systems (BSS—and not to be confused with a BSS 54—FIGS. 1 & 2, 4), collectively a OSS/BSS 59; a HLR or Home Location Register (HLR) 57; the BSS 54 or Base Station Subsystem (BSS) 54 (not to be confused with the BSS of the OSS/BSS 59).

The OSS or Operations Support Systems (OSS) are computer systems used by telecommunications service providers (e.g. MNOs 25). The term OSS broadly refers to “network systems” dealing with the telecom network itself, supporting processes such as maintaining network inventory, provisioning services, configuring network components, and managing faults. The complementary term, business support systems or BSS (of the OSS/BSS 59), is a relatively newer term and typically refers to “business systems” dealing with customers, supporting processes such as taking orders, processing bills, and collecting payments. The two systems together are often abbreviated OSS/BSS 59, BSS/OSS or simply B/OSS.

Whereas, in various non-limiting embodiments, the Base Station Subsystem (BSS) 54 broadly refers to the section of a traditional cellular telephone network (e.g. mobile network 24) which is responsible for handling traffic and signaling between the mobile device/phone and a network switching subsystem. In various non-limiting embodiments, the MSC or Mobile Switching Center (MSC) broadly refers a 3G (or similar, e.g. 4G/LTE) core network element which controls the network switching subsystem elements. The VLR or Visiting/Visitor Location Register (VLR) broadly refers to a database of the subscribers who have roamed into a jurisdiction of the MSC (Mobile Switching Center) which it serves.

In various non-limiting embodiments, the HLR 57 or Home Location Register (HLR) broadly refers to a central database that comprises details of each mobile phone/device subscriber that is authorized to use, say the GSM core network (or similar communications network). There may be several logical, and physical, HLRs 57, say per public land mobile network (PLMN), though one international mobile subscriber identity (IMSI)/MSISDN pair , in-general, associated with only one logical HLR 57 (which may span several physical nodes) at a time. Also see FIG. 4 for OSS/BSS 59 and FIGS. 1 & 2 regarding MSC, HLR, and VLR.

In various non-limiting embodiments, the Mobile Network 24 comprises a plurality of MNOs 25, which may or may not be interconnected. In various non-limiting embodiments, wherein the plurality of MNOs 25 are operationally interconnected, some MNO elements may or may not be operationally interconnected, such as the MSC,VLR, MSC/LVR 55, OSS/BSS 59, HLR 57, BSS 54. Further, where the RP 50 (&/or IN-RP 51) can become an interchange for the MNO elements, and/or provide a same, similar, redundant, and/or the like, functionality, purpose, and/or the like.

In various non-limiting embodiments, the network 300 may also be a wired network, such as local area network (LAN), wide area network (WAN), metropolitan area network (MAN), global area network such as the Internet, a Fiber Channel fabric, or any combination of such interconnects. Network communications, such as HTTP requests/responses, Wireless Application Protocol (WAP) messages, Mobile Terminated (MT) Short Message Service (SMS) messages, Mobile Originated (MO) SMS messages, or any type of network messages may be relayed and/or exchanged among the devices coupled to the network 300.

In various non-limiting embodiments, the User/Subscriber 46 is typically someone or a machine that generally consumes minutes, data, content, and may also interact, request, search, query, answer, challenge, verify, organize, track, comment, pull data, download, stream, push/share, chat, text, and/or the like; via appropriate and suitable SSx (e.g. SS7)/signaling links, packet voice, packet data and/or the like, that are contained in voice, voice minutes, audio, data, content, media, announcements, and/or the like. In various non-limiting embodiments, the Accounts/users (e.g. Mobile Subscribers/Subscribers/Users) 46 are computer clients/users, comprising the Tablet Computer 65, the Mobile Device 61, the PDA 62, the Laptop 63, the “Vehicle GPS and Computer” 23, a mobile network subscriber/user, and/or the like; who are operationally connected to the Mobile Network 24 via his/her/its Communication Device. In various non-limiting embodiments, the Mobile Subscribers 46a may all be operationally connected to the same Mobile Network Operator 25 or via a variety of Mobile Network Operators 25, including roaming, a variety of countries and/or the like. In various non-limiting embodiments, the Mobile Subscribers 46a are operationally connected and contained within to the same Mobile Network 24.

In various non-limiting embodiments, the Users 46c are computer clients/users, comprising the VOIP Phone 66, the Tablet Computer 65, the PDA 62, the Laptop 63, the Mobile Device 61, the Desktop Computer 67, the Television/IPTV 68, the Server 101 (e.g. a Third Party Server) and/or the like; who are operationally connected to the Access Point (AP) 47 via his/her/its Communication Device/Client. In various non-limiting embodiments, the Users 46c may all be operationally connected to the same Network 300 (not depicted) or Internet 40 via the same Access Point 47 and/or the same Internet Service Provider (ISP) 41; and/or via a variety of Access Points 47 and/or a variety of ISPs 41.

In various non-limiting embodiments, the User/Subscriber 46b are computer clients/users, comprising the Television/IPTV 68, the Mobile Device 61, the Laptop 63, and, not depicted in 46b: the VOIP Phone 66, the Tablet Computer 65, the PDA 62, the Desktop Computer 67, the Server 101 (e.g. the Third Party Server) and/or the like; who are operationally connected to the PSTN/ISDN/PDN/Etc. 60 directly and/or via an Access Point (AP) 47 and/or an Internet Service Provider (ISP) 41 or via a variety of Access Points 47, and/or a variety of ISPs 41, and/or a variety of the PSTN/ISDN/PDN/Etc. 60; and/or the like. In various non-limiting embodiments, the MN 24, PSTN/ISDN/PDN/Etc. 60, and Internet 40 may be operationally interconnected. In various non-limiting embodiments, the Users/Subscribers (e.g. 46a, 46b, and 46c) may be operationally interconnected, where some communication devices may, for example, seamlessly transfer from one network to another. In various non-limiting embodiments, the Users/Subscribers (e.g. 46a, 46b, and 46c) may be collectively interchangeable and/or referred to as the User, the Subscriber, and/or the Account. In various non-limiting embodiments, the plurality of network communication devices/users comprises the account, mobile subscribers, subscribers, and/or the user (e.g. 46, 46a, 46b, and 46c), and/or the like.

Generally speaking, in a computer network a proxy server is a server (a computer system or an application) that acts as an intermediary for requests from a client (e.g. device, computer, etc.) seeking resources from other servers. A client connects to the proxy server, requesting some service, such as a file, connection, web page, streaming content, or other resource available from a different server and the proxy server evaluates the request as a way to simplify and control its complexity. Broadly speaking, proxies (or proxy servers) provide additional structure and encapsulation to distributed systems (e.g. mobile networks, Internet, networks, etc.), where most proxies are web proxies, facilitating access to content on the World Wide Web.

In various non-limiting embodiments of the present disclosure, the RP 50 (&/or IN-RP 51) and/or the like, is a proxy server. In various non-limiting embodiments of the present disclosure, the RP 50 (&/or IN-RP 51) and/or the like, performs and/or provides the same or similar functionality as the proxy server. In various non-limiting embodiments of the present disclosure, the RP 50 (&/or IN-RP 51) and/or the like, perform and function in conjunction with a particular proxy server and/or a plurality of proxy servers. In various non-limiting embodiments, the terms “RP” and “proxy server” are interchangeable. In various non-limiting embodiments of the present disclosure, the RP 50 (&/or IN-RP 51) and/or the like, is an exchange platform. In various non-limiting embodiments of the present disclosure, the RP 50 (&/or IN-RP 51) and/or the like, performs and/or provides the same or similar functionality as the exchange platform (e.g. a content management hub).

In various non-limiting embodiments, the communication devices may support an application where, for example, the network connection may or may not require a connection or persistent connection. An application, also referred to as an “app,” generally refers to a software application that executes on the computing device, such as the mobile device 61 (e.g., the mobile device refers to a computing device that includes a processor for executing a software application). For example, mobile devices 61 include smart phones, tablets 65, laptops 63, and/or other mobile devices 61. Various application platforms exist for different operating systems, such as Microsoft Windows® platforms, Google Android® platforms, and Apple iOS® platforms. Application markets (e.g., app stores) exist for each of these application platforms, which can make available thousands to millions of different apps for such platforms. For example, various apps are available for executing on smart phones such as the HTC EVO® or Apple iPhone®, tablets such as the Samsung Galaxy Tab®, Microsoft Surface®, Motorola Xoom® or Apple iPad®, embedded devices executing the Google Android® operating system, and computer operating systems such as Apple Mac OS X® and Microsoft Windows 8®.

Also, as these operating system platforms for mobile devices 61 converge with legacy computer desktop and laptop operating system platforms (e.g., Microsoft Windows® 8 and Apple Mac OS X®), similar app markets and availability of common apps across such platforms are becoming increasingly common A number of enterprise challenges include the increasing usage by, for example, employees of their own devices that can have access to corporate resources (e.g., employee smart phones, tablets, etc.). The ever growing number and variety of apps also poses a significant challenge for entities to manage and monitor the downloading, installation, and usage of such apps by users on devices that can have access to corporate resources.

In addition, the tracking of a subscriber's (e.g. mobile or otherwise) budget, plan, and/or the like, such as in a mobile subscriber's prepay plan or a consumption (e.g. level/rate) in a post pay plan, for voice and/or data per user, per plan, per plan member, per device, per window of time, per location, per network, and/or the like. Further, where voice connections, content, playlists, event-list, requests-lists and/or the like, may be transferred and/or shared cell-to-cell, BTS-to-BTS, peer-to-peer (e.g. via mobile networks, BTS, cells, ad-hoc networks, mesh networks, Bluetooth, Wi-Fi, NFR, and/or the like) and/or may employ transferrable media methods, cabling, and/or the like, to transfer some voice/time and/or data/content.

In various non-limiting embodiments, the device, mobile device 61, or Communication Devices used by User/Subscriber's 46 can be referred to as a transceiver (e.g. computer, mobile device 61, mobile phone, PDA, cellular phone, and/or the like) that allows communication, relay, and voice/time and/or data exchange from itself and the RP 50. Using a cellular communication as an example, where a mobile subscriber, here a first User/Subscriber 46x uses a mobile device 61 as the communication device and may operationally connect to second User/Subscriber 46y via the MNO 25, where the RP 50 (&/or IN-RP 51) may also be employed. In various non-limiting embodiments, the RP 50 and/or some components of the RP 50 may be physically located separately from the MNO 25 and/or where all or some components are physically located inside the MN 24 or inside the MNO's 25 network (or “In Network” OR “IN”), generally referred to as the IN-RP 51. In various other non-limiting embodiments, the IN in the IN-RP 51 stands for Intelligent Network, as is applied and referred to in telecommunications. In various non-limiting embodiments, the RP 50 and the IN-RP 51 are interchangeable.

In addition, historically on many mobile devices 61, particularly smart phones, tablets, and embedded devices, the devices themselves can be resource constrained (e.g., limited CPU capabilities, limited memory capabilities, limited storage, antenna range/reception, and/or strong dependency on the battery). These resource limitations can put tight constraints on resource-intensive operations. Traditional “on-device” dynamic analysis for hardware, software, and plan perimeters (e.g. prepay plan/budget/minutes) may not only constrain and sandbox the hardware and/or software, but may also make for impractical and/or undesirable results. To help limit and/or minimize an “on-device” resource-intensive detection, HLR lookup, and/or a result that may be overly-restrictive, the present disclosure can generate permission models and/or criteria that can be implemented on the mobile device 61.

In various non-limiting embodiments, the permission models and/or criteria can successfully analyze (via appropriate and suitable SSx (e.g. SS7)/signaling links, packet voice, packet data and/or the like), apps 244 for usage, minutes/data remaining per plan, quasi-HLR access/setup/usage, potential overages (e.g. prepay and/or post pay mobile subscribers), routing/handoff improvements, opportunities (e.g. upsell, routing, roaming, location-based services, payments) and/or the like. These permission models and/or criteria can include conditions that restrict a level of voice/time and/or data throughput, performance, and accessibility, along with potential remedies, and/or cap voice/time and/or data access/usage per preset thresholds, criteria and/or conditions.

In addition, “on device” applications can monitor usage and isolate (via appropriate and suitable SSx (e.g. SS7)/signaling links, packet voice, packet data and/or the like) for further analysis based upon such characteristics as user patterns/behaviors per device, user, a group of users, a segment of users, a device characteristic, software characteristic, prepay plan, location-awareness, and/or the like. Further, the “on device” monitoring can store behavior patterns unique to the device, software, user, location, time of day, payments made or not, credit obtain or not, bids submitted/won/lost, and/or the like.

In some embodiments, on-device monitoring includes receiving a software inventory for the mobile device 61, in which the software inventory identifies a plurality of applications 244 installed on the mobile device 61; and determining whether one or more of the plurality of applications 244 identified in the software inventory are associated with behaviors likely to produce an overage, e.g. of voice/time and/or data, bandwidth, throughput, volume, capacity, characters, minutes, and/or the like.

In various non-limiting embodiments, the on-device monitoring includes enforcing the policy on the mobile device 61 via a specific application 244 or Applet (not shown). In various non-limiting embodiments, the policy includes one or more of the following: a RP Parser criteria, a usage (e.g. per prepay/post-pay plan), a malware policy, privacy policy, and/or, say an enterprise configured app security policy and/or the like. In various non-limiting embodiments, the implementing, evaluating, determining, and providing policies includes the capabilities and functions as described in PCT/U.S. Ser. No. 13/67895, O'Malley et al. referenced earlier.

In various non-limiting embodiments, the RP 50 implements a holistic approach to managing, routing, monitoring and analyzing voice/time and/or data, and can automatically analyze (via appropriate and suitable SSx (e.g. SS7)/signaling links) the packet voice, packet data and/or the like, and apps 244 to determine various voice/time and/or data attributes and properties, such as one or more of the following: network reliability, coverage availability, routing capabilities, MSC (and/or the like) access, HLR (and/or the like) access, market reputation of the SSx (e.g. SS7)/signaling links, networks, packet voice, packet data and/or the like, source, (via appropriate and suitable SSx (e.g. SS7)/signaling links) the packet voice, packet data and/or the like, destination, app utilized, and/or the like; the likely presence of voice, audio, video, SMS, text; app-ware; firm-ware; instructions; programming practices; timing, speed, volume, reliability, concerns, relative changes (e.g. historically, recently, currently, etc.); budget remaining, credit allowed, routing reliability, connection availability, malware; malicious changes to existing apps; voice/time and/or data exfiltration; intellectual property (IP) impacts; cryptographic weakness or implementation faults; security issues/risks; privacy concerns (e.g., location tracking, extracting contact book, sharing browsing history, etc.); routing usage (e.g., CPU cycles measured and compared routing methods), and/or the like.

In addition, location and mapping with network connection reliability per location (e.g. network A v. network B and/or at location C v. location D and/or utilizing Device E v. F and/or with OS/version/application and/or say, OS/Version/App G/H/I vs OS/Version/App J/K/L); along with network performance, call drops, HLR rejections per attempts, TCAP message rejections/attempts, and/or the like, management, analysis, statistics, and usage metrics (e.g. cellular v. LTE v. Wifi; home network v. roaming; tethered or not usage) and/or the like. For example, these techniques performed by the RP 50 can be implemented as a fully automated solution for quantifying the likelihood of a problem (e.g. an overage of a particular User/Subscriber, voice minutes/budget, traffic routing issue, lack of HLR access, connection quality, potential/actual dropped call, potential/actual handoff issue, and/or the like) that in turn can increase the detection of known issues, screen for new and/or unknown issues, identify behaviors, applications, and operating systems (e.g., including the Google Android® operating system and the Apple iOS® operating system), say relative to an event, location, time of day, user, budget (e.g. prepay v. post-pay) and/or the like.

In various non-limiting embodiments, the User/Subscriber (46) may be characterized as ‘potential offender’ because it is possible that he/she may not-have or has-never gone over his/her/its budget (e.g. for minutes/data/plan/user/device) , or has an non-offending status, say specific to voice/time and/or data communications (via appropriate and suitable SSx (e.g. SS7)/signaling links, packet voice, packet data and/or the like) that are found to be incorrectly indicative of suspicious and/or are incorrectly perceived as indicative of contract-offending activity. That is, legitimate, non-offending voice/time and/or data (via appropriate and suitable SSx (e.g. SS7)/signaling links, packet voice, packet data and/or the like) that may initially appear to the network host or RP-Server (52) as offending SSx (e.g. SS7)/signaling links, packet voice, packet data, unpaid usage, and/or the like. Where, in various non-limiting embodiments, the RP 50/RPM 53 would preferably perform subsequent analysis that would attempt to isolate such anomalies (per SSx (e.g. SS7)/signaling links, packet voice, packet data, unpaid usage, and/or the like) for further verification, validation, correction/modification, table updates (OTT, FTR, quasi-HLR), routing, rerouting, reassignment, and/or the like, for subsequent improvements to characterizations with associated algorithms/logic, rules, routing, throttling, switching, upselling, and/or the like.

In various non-limiting embodiments, the RP 50/RPM 53 modules track, manage, connect, route, and analyze data traffic of the network 300 of the network communication device (via the appropriate and suitable SSx (e.g. SS7)/signaling links, packet voice, packet data and/or the like) for traffic flow and routing (e.g. congestion, errors, throughput) along each communication link, including communication links and connections with any given mobile network 24, PSTN, ISDN, SIP, SIGTRAN, and/or IP network. In various non-limiting embodiments, the mobile network 24 traffic is managed, routed, tracked and analyzed by the RP 50. In various non-limiting embodiments, the RP 50 would preferably monitor the appropriate and suitable SSx (e.g. SS7)/signaling links, packet voice, packet data and/or the like, in near real-time, if not in real-time.

In various non-limiting embodiments, the RP 50 the SSx (e.g. SS7)/signaling links, packet voice, packet data and/or the like, monitoring would preferably provide means and computer-implement methods to control the appropriate and suitable SSx (e.g. SS7)/signaling links, packet voice, packet data and/or the like, an associated communication device, an associated SSx (e.g. SS7)/signaling links, packet voice, packet data and/or the like: flow, source/origination, destination, network, associated subscription plan, associated insurance policy, prepay vs. post pay, budget, credit, location, roaming, network, and/or the like.

In various non-limiting embodiments, the RP 50 the SSx (e.g. SS7)/signaling links, packet voice, packet data and/or the like, monitoring would preferably provide means and computer-implement methods to control the appropriate and suitable SSx (e.g. SS7)/signaling links, packet voice, packet data and/or the like, associated with the mobile device 61 comprising such means and methods for managing traffic/connections as a relay routing, re-routing, routing approval, extra-soft handoffs (explained further ahead), Primary/Secondary Connections, 2-3-2 connection management (ahead), throttling, variable-bit-rate (VBR), cap, injection (e.g. modify), suspension, routing, re-routing, termination, and/or the like, routing events, events (e.g. updates, triggers, alerts, handoffs, etc.) and/or the like.

In various non-limiting embodiments, the RP 50 would preferably continually (persistently and globally) manage, monitor, and analyze the appropriate and suitable SSx (e.g. SS7)/signaling links, packet voice, packet data and/or the like, transmissions per communication device. In various non-limiting embodiments, the RP 50 would continually manage, monitor, and analyze each route and/or transmission per communication device, and would preferably automatically, conditionally, and/or account/user-selectively send a notification/alert to the computer client/communication device/user of a confidence factor (e.g. a known, discerned, and/or relatively perceived confidence) of a particular event (e.g. update, trigger, alert, handoff, issue, incident, concern, potential overage, overage, opportunity, lack of HLR access, TCAP message rejection/error, handoff issue, and/or the like). In various non-limiting embodiments, the network communication device/user would preferably employ the appropriate and suitable SSx (e.g. SS7)/signaling links, packet voice, packet data and/or the like, voice/time and/or data protocol/communications suitable for tracking interactions and/or events.

In various non-limiting embodiments, the analysis of the confidence factor and/or each particular traffic event (or application event) would preferably incorporate a threshold, range, and/or the like; where the analysis would preferably incorporate computer instructions, logic, rules, filters, weighting, conditions, algorithms, and/or the like. In various non-limiting embodiments, the analysis of the confidence factor and/or each particular traffic event (or application event) would preferably include values that define each incorporated and/or associated threshold value, range start/end, threshold, range, replacement value, handoff value (also see extra-soft handoff), connection strength, budget, subscriber plan, subscriber history, and/or the like. In various non-limiting embodiments, the analysis would also incorporate the values that define each incorporated and/or associated threshold value, range start/end, and/or the like; and would preferably incorporate near-real-time, if not, real-time, network intelligence, to generate values dynamically. In various non-limiting embodiments, the analysis of the confidence factor and/or each particular traffic, voice, connection, handoff, and/or routing event (or application event) would preferably generate a collective value which could be utilized for additional analysis, scoring, criteria, thresholds, comparisons, events, algorithms/logic, and/or the like.

Implementing, evaluating, determining, and providing a system (operational via a computer processor) and method (computer-processor-based) for messages is described in U.S. application Ser. No. 13/127,993, O'Malley et al., is hereby incorporated by reference in its entirety for all purposes, which can be implemented in various non-limiting embodiments of the present disclosure. Here O'Malley et al. explain systems and methods for messaging a user, e.g. with a selected message (an audio message or play announcement/function) initiated during the call setup of a mobile call and where the selected message is selected by a “Message Selection Engine” (MSE). Further, the selected message would preferably include an associated action, wherein the associated action is selected by an “Action Selection Engine” (ASE) (more below).

Implementing, evaluating, determining, and providing a system (operational via a computer processor) and method (computer-processor-based) for messages is described in PCT/U.S. Ser. No. 13/67895, O'Malley et al., is hereby incorporated in its entirety by reference in its entirety for all purposes, which can be implemented in various non-limiting embodiments of the present disclosure. Here, “messages” typically refers to an “announcement” and not to be confused with the message associated with the routing of “message” in association with “a TCAP message” and/or the like. Where, a particular traffic event (e.g. a particular voice/time and/or data count obtained by a specific device/plan) or application event (e.g. a particular input obtained by a specific device/plan per a particular application and/or version of the application) prompts an alert when the analysis produced, say for a particular value that exceeds/surpasses a particular set threshold value and/or a particular dynamic threshold value (and/or where the value falls within the set range and/or the dynamic range). In addition, the alert would prompt the (MSE) with an associated module to send a message (e.g. an announcement) to the communication device/user accordingly. In various non-limiting embodiments, messages and announcements are interchangeable.

In various non-limiting embodiments, the alert would prompt the MSE with the associated module and the (ASE) with an associated module to collectively send a message/action (e.g. announcement with an associated action) to the communication device/user accordingly, and preferably, along with an associated mobile ID, associated announcement ID, and/or associated action ID, respectively. For example, the message/action (e.g. announcement/ID with an associated action/ID) may be generated per an analysis perception, assumption, consumption, expectation, bill, payment method, limit, restriction, and/or the like (e.g. an alert of a potential overage sent per a particular threshold). Further, the message/action (e.g. announcement with an associated action) may produce an acknowledgement, response, modification, resolution, and/or the like, from the particular user/device. In various non-limiting embodiments, the RP 50/RPM 53 tracks each message, alert, and/or the like, where a subsequent announcement/message, action, and/or message/action (e.g. announcement with an associated action) is sent, routed, re-routed, played, triggered, paused, delayed, updated, forwarded, temporarily stored, electronically stored, retrieved, handed-off, deleted, scored, challenged, parsed, and/or the like.

In various non-limiting embodiments, the audio announcement/message alert (also referred to as an Actionable Audio Message (AAM/announcement)) that is sent by the RP 50, may be initiated by a flagging of the network communication device/user by a mobile network operator (MNO) 25, wherein the flagging of the network communication device/user prompts the RP 50 to employ the MSE that may send and/or play the AAM/announcement during the call setup time of a phone call. In various non-limiting embodiments, the AAM/announcement may be sent, routed, re-routed, played, triggered, paused, delayed, updated, forwarded, temporarily stored, electronically stored, retrieved, handed-off, deleted, scored, challenged, parsed, and/or the like. In various non-limiting embodiments, the AAM/announcement may be sent, routed, re-routed, played, triggered, paused, delayed, updated, forwarded, temporarily stored, electronically stored, retrieved, handed-off, deleted, scored, challenged, parsed, and/or the like.

In various non-limiting embodiments, the AAM/announcement may incorporate a variety of associated actions (e.g. a DTMF for a particular campaign and campaign rules, logic, rules, goals, etc.), where the RP 50 would employ an action selection engine (ASE) to select a specific action to associate with the AAM/announcement (e.g. and the particular campaign and campaign rules) sent to the network communication device/user via an audio announcement/message alert (e.g. the AAM/announcement) sent by the RP 50, may be initiated by a flagging of the network communication device/user by the MNO 25, where, for example, the flagging of the network communication device/user prompts the RP 50 to employ the MSE that may send and/or play the AAM/announcement during the call setup time of a phone call.

In various non-limiting embodiments, the AAM/announcement is an audio message that may be played and/or where voice communications or commands are not required or utilized. Some embodiments do not require the communication device to have voice communication capabilities and/or where voice communications or commands are not required or utilized. In various non-limiting embodiments, the sending/playing of the AAM/announcement by the RP 50 to the network communication device/user may be sent/played to any type of network communication device, whether the device employs the appropriate and suitable SSx (e.g. SS7)/signaling links, packet voice, packet voice/time and/or data and/or the like, for voice/time and/or data protocol/communications or not.

In various non-limiting embodiments, the RP 50 and/or the RPM 53 includes user login capabilities, billing management, the ability to specify and/or modify a mobile plan, voice/time and/or data plan, payment method, insurance, roaming allowance, territory allowance, exceptions, temporary allowances, options, threshold settings, and/or the like. In various non-limiting embodiments, the RP 50 further allows users and network operators (e.g. MNO 25) to create, manage, distribute, measure, report, offer, track, sequence, revert, insure, score, adjust, update, route, re-route, play, trigger, pause, delay, forward, temporarily store, electronically store, retrieve, handoff, delete, challenge, parse, and/or the like, their messages, traffic, APIs, apps, content, voice/time and/or data, billing, service, contract, terms, media, insurance, and/or the like; for the mobile subscribers 46. In various non-limiting embodiments, the MNO 25 may access the RP 50 and/or the RPM 53 through a standard web interfaces, and the RP 50 may also provide a unique Application Programming Interface (API) solution for MNO 25 (and/or the like) who wish to provide direct and/or conditional (e.g. paid, limited, subscription, lease, streamed, downloaded, and/or the like) access to their content, media, voice/time and/or data, applications, tools, and/or the like.

In various non-limiting embodiments, the RP 50 and/or the RPM 53 allow the MNO 25 (and/or the like) to setup specific and/or conditional rules for access, as well as what specific requests, follow-up actions, feedback, logic, and/or the like, a particular account, user, subscriber, mobile subscriber, and/or particular account, user, subscriber, mobile subscriber segment type, a particular access type or a particular access segment type, another segmentation type, a particular application, application type, application user/device, device, user, a particular window of time, a particular network type, a particular account type, and/or the like, setup with rules and instructions for each particular subscriber/user, communication device, mobile plan, OS, application, version, voice/time and/or data plan (e.g. Current Plan), piece of content, voice/time and/or data, rule, and/or the like. In addition, the RP 50 provides accounts organization capabilities and reporting functionality, including revenue reports with various ways to view voice/time and/or data, such as summary totals by mobile subscribers 46a segmentations (e.g. Demographics, Psychographics, Location, Motion, Contact History, Behavioral, etc.); timing, and usage tracking; feedback, requests, consumption, application, content type, content source, alert metrics, action metrics and/or conversion metrics; and event optimization and completion goals.

Exemplary embodiments of the present disclosure are described largely in the context of a fully functional computer system for variable dynamic management of network traffic for managing, relaying, routing, and/or tracking voice/time and/or data consumption, improving connections/routing, providing quasi-HLR data (e.g. via a redundant and/or temporary third-party database) and/or quasi-HLR data support, remedying routing/handoff issues, and/or usage overages (e.g. prepay budget, plan, minutes, data, SMS, etc.), and upselling opportunities. Readers of skill in the art will recognize, however, that the present disclosure also may be embodied in a computer program product disposed on signal bearing media for use with any suitable voice/time and/or data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art.

Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the disclosure as embodied in a program product. Persons skilled in the art will recognize immediately that, although some of the exemplary embodiments described in this specification are oriented to software installed and executed on computer hardware, nevertheless, alternative embodiments implemented as firmware or as hardware are well within the scope of the present disclosure.

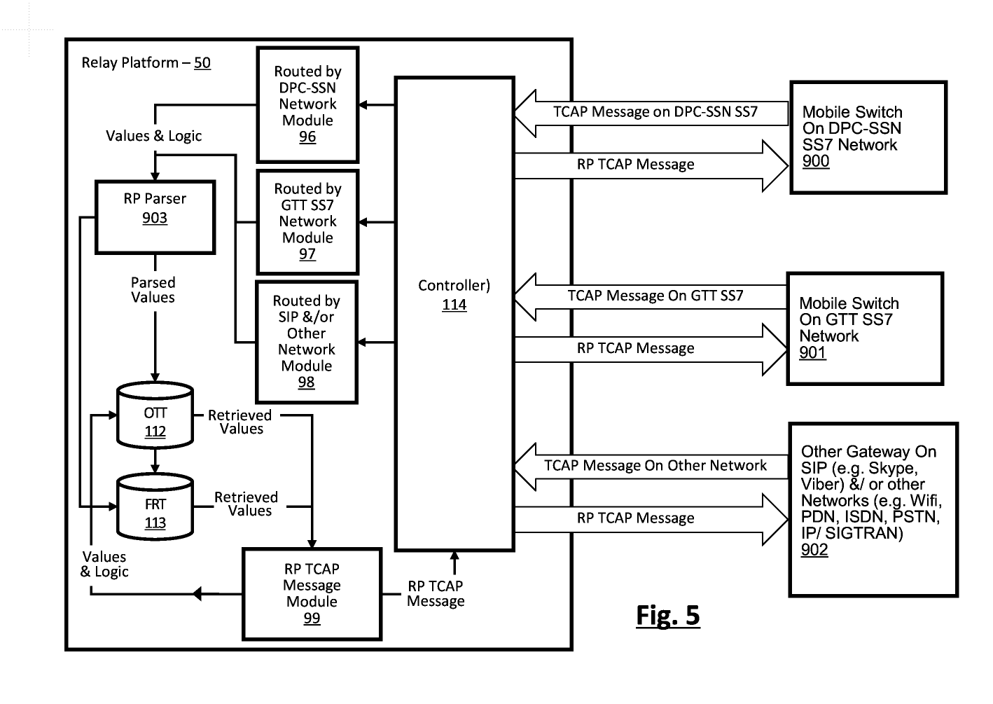

FIG. 5 depicts a schematic view of one embodiment, wherein the RP 50 is communicatively coupled to a mobile switch On DPC-SSN SSx (e.g. SS7) Network 80, a mobile switch On GTT SSx (e.g. SS7) Network 901, and an Other Gateway on Other Networks 902. In various non-limiting embodiments, the mobile switch On DPC-SSN SSx (e.g. SS7) Network 900, mobile switch On GTT SSx (e.g. SS7) Network 901, and Other Gateway on Other Networks 902 can each both send and receive TCAP messages. Here, the mobile switch On DPC-SSN SSx (e.g. SS7) Network 900 can send a TCAP Message on DPC-SSN SSx (e.g. SS7), where the mobile switch On GTT SSx (e.g. SS7) Network 901 sends a TCAP On GTT SSx (e.g. SS7), and last the Other Gateway on Other Networks 902 sends a TCAP Message on Other Networks (e.g. Wifi, Bluetooth, etc.), and where all three can receive a RP TCAP message (e.g. tailored for the specific network).

The sending and receiving of the TCAP messages are done via a connection such as the Network 300, and/or the Internet 40 (FIGS. 1-4) to the RP 50. In various non-limiting embodiments, the IN-RP 51 (not depicted) may operate independently of the depicted RP 50, in connection with the RP 50, and/or in place of the RP 50 (e.g. thus assuming the functionality of the RP 50).

In various non-limiting embodiments, the RP 50 would preferably be operationally coupled to a client (or a plurality of mobile subscribers) via a network, such as the mobile networks listed above; however, only two mobile clients/networks (e.g. mobile switch 61a and mobile switch 901) are shown for purposes of explanation. In various non-limiting embodiments, the Other Gateway on Other Networks 902 would typically comprise a computer system, gateway, or mobile switch outside a traditional mobile network. In various non-limiting embodiments, the Other Gateway On Other Networks 902 connects to clients owned by a user capable of receiving media and/or content over a network, such as the internet, Wifi, PDN, IP/SIGTRAN, ISDN, PSTN, and/or via the like. Alternatively, the Mobile Switches 900/901 may be switches equipped to send and/or receive on additional (other) networks (PDN, IP/SIGTRAN, PSTN, and/or the like) and/or via such wireless networks as wifi, Nearfield Radio, Bluetooth, Zigbee, Mesh, Ad-Hoc, and/or the like

In various non-limiting embodiments, the RP 50 is adapted to relay/transmit (e.g. send and/or receive) content, voice/time and/or data, and/or media (e.g. push, pull, talk, voice, audio, video, broadcast, stream, and/or the like) to multiple switches and /or clients. To this end, the RP 50 comprises the Controller 114 that controls the functionality of the RP 50. In various non-limiting embodiments, the RP 50 further comprises a “Routed by DPC-SSN Network Module 96, a Routed by GTT SSx (e.g. SS7) Network Module 97, and a Routed by Other Network Module 98, where each contains the appropriate logic to route values and logic to a RP Parser 903.

From the RP Parser 903, a set of parsed values are routed to an OTT (Open Transaction Table, more ahead) 112 in a storage medium for electronically storing the OTT, which performs a lookup. And if necessary, the parsed values are further routed to a FRT (Fixed Routing Table, more ahead) 113, again, in a storage medium for electronically storing the FRT. From the OTT 112 and the FRT 113, a set of Retrieved Values are forwarded to a RP TCAP Message Module 99. Here, each RP TCAP message is generated and forwarded with routing instructions to the Controller 114 and then sent onto the appropriate network/client/mobile device/user/subscriber. In addition, any table updates necessary per the logic are forwarded from the RP TCAP Message Module to the appropriate OTT 112 or FRT 113 table.

In various non-limiting embodiments, the OTT 112 and/or FRT 113 may be physically located in a storage device of the RP 50, or it may be located in storage devices remote from the RP 50, but communicatively coupled thereto. For example, the RP 50 may be coupled to the OTT 112 and/or FRT 113 over the Network 300 (see FIGS. 1-4), wherein the RP 50 retrieves data from the Storage 109c medium over the Network 300 as the values, content, voice/time and/or data, and/or media files as needed, in real-time, near real-time, asynchronously, as batch files, and/or the like. In various non-limiting embodiments, the RP 50 may have its logic, table values, content, voice/time and/or data and/or media adjusted remotely, conditionally, searched, acquired, sorted, sequenced, ranked, purchased, bid on, and/or the like.

In various non-limiting embodiments, the RP 50 may search, intelligently crawl, monitor, pull, push, score, and/or the like, content, voice/time and/or data, and/or media over the Network 300 to the clients and/or servers. In one embodiment, the RP 50 sends and/or receives data and content files according to the Mobile Operator's HLR and/or per a specific mobile device, serial number, or network address (e.g., to an IP address, an Electronic Serial Number, Access Network Identifier, Automatic Number Identification, Mobile Equipment Identifier, GSM Cell ID, and/or the like) of the client (e.g. the Mobile Client 61 or the Client 108).

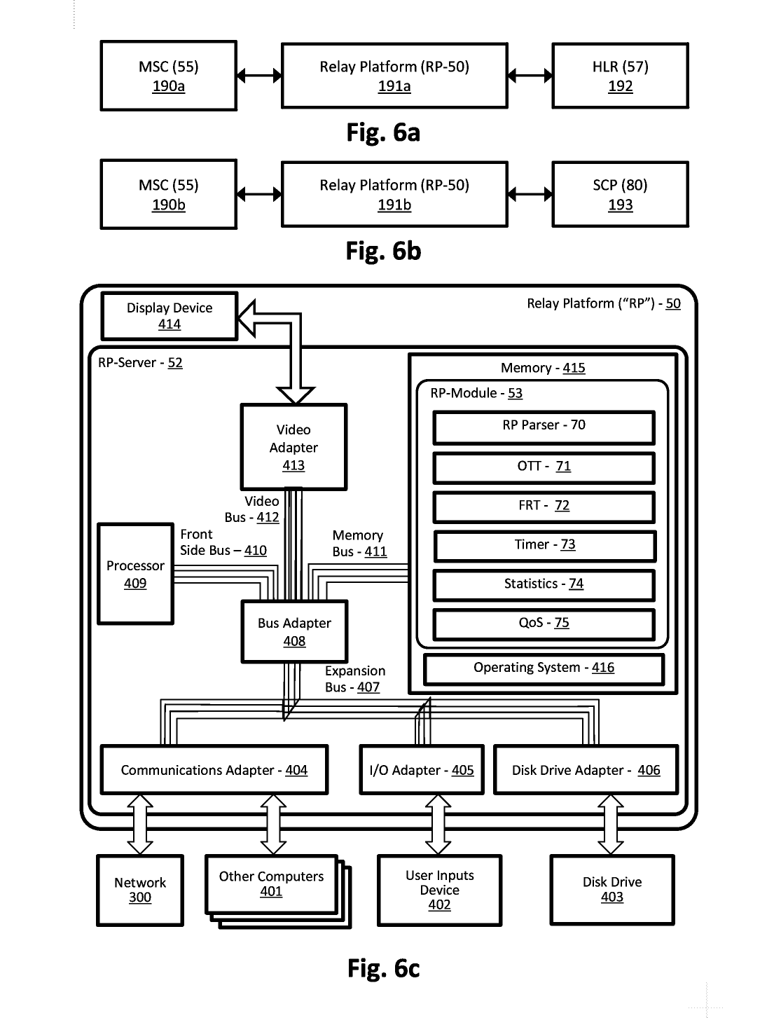

FIG. 6a depicts a functional block diagram of an embodiment of the placement of the RP within an existing mobile network. Here, a MSC (55) per a 190a container is operatively connected to the RP (50) per a 191a container which is operatively connected to the HLR (57) in a 192 container. In various non-limiting embodiments, the MSC (55) 190a and the HLR (57) 192 may both be connected to the RP (50) 191a via any of the connection methods listed in FIG. 6c, comprising a Network 300, others computers 401, User input device 402, disk drive 403, and/or the like.

FIG. 6b also depicts a functional block diagram of an embodiment of the placement of the RP within an existing mobile network. Here, a MSC (55) per a 190b container is also operatively connected to a RP (50) per a 191b container which is operatively connected to a SCP (80) in a 193 container. In various non-limiting embodiments, the MSC (55) 190b and the SCP (80) 193 may both be connected to the RP (50) 191b via any of the connection methods listed in FIG. 6c, comprising the Network 300, others computers 401, User input device 402, disk drive 403, and/or the like.

FIG. 6c depicts a block diagram of an embodiment of the RP 50 system for automated computing machinery comprising an exemplary network host or RP Server 52 useful in variable dynamic management of network traffic for voice/time and/or data monitoring (e.g. via the appropriate and suitable SSx (e.g. SS7)/signaling links, packet voice, packet data and/or the like), manage, analyze, and provide routing and/or overage prevention according to various non-limiting embodiments of the present disclosure. In various non-limiting embodiments, the RP Server 52 of FIG. 6c includes at least one computer processor (409) or ‘CPU’ as well as a Memory (415) which are connected through a Memory Bus (411) and a Bus Adapter (408) to a processor (409) and to other components of the network host or RP Server 52.

Electronically stored in the Memory (415) is the RPM (53), a module of computer program instructions for variable dynamic management of network traffic for voice/time and/or data monitoring (e.g. via the appropriate and suitable SSx (e.g. SS7)/signaling links, packet voice, packet data and/or the like), manage, analyze, and provide routing and/or overage prevention according to embodiments of the present disclosure that initialize, the RP Parser (70) module with the OTT 71, and the FRT 72.

In various non-limiting embodiments, the RPM (53) and the RP Parser Module (70) with the RP Parser Parameters (71), also starts a timer (73). In various non-limiting embodiments, the timer (73) may incorporate a set of conditions, where for example, a particular set of conditions could cause the timer (73) to remain on no longer than a predefined time interval. In various non-limiting embodiments, the RPM (53) also maintains, while the timer (73) is on/open, statistics (74) including the appropriate and suitable SSx (e.g. SS7)/signaling links, packet voice, packet data and/or the like, count by the RPM (53). For each appropriate and suitable SSx (e.g. SS7)/signaling links, packet voice, packet data and/or the like, received by the RPM (53) (e.g. via the QoS (75)), the RPM (53)/QoS (75) also determines, in dependence upon the statistics (74) and the timer (73) modules. Also electronically stored in Memory (415) is an operating system (416) (or OS).

Operating systems useful in network hosts (e.g. RP Server 52) according to embodiments of the present disclosure include UNIX™, Linux™, Microsoft Windows® platforms, Google Android® platforms, and Apple iOS® platforms.AIX™, IBM's i5/OS™, and others as will occur to those of skill in the art. Operating system (325), the RPM (53), with the RP Parser Module (70), OTT (71), FRT (72), timer (73), statistics (74), QoS Module (75), and voice/time and/or data communications via the appropriate and suitable SSx (e.g. SS7)/signaling links, packet voice, packet data and/or the like, per the RPM 70 in the example of FIG. 6c are shown in RAM Memory (415), but many components of such software typically are stored in non-volatile memory also, for example, on a disk drive (403).

In various non-limiting embodiments, the RP Server 52 of FIG. 6c includes the bus adapter (408), a computer hardware component that comprises drive electronics for the high speed buses, a front side bus (410), a video bus (412), and the memory bus (411), as well as drive electronics for a slower expansion bus (407). Examples of bus adapters useful for variable dynamic management of network traffic for voice/time and/or data monitoring (e.g. via the appropriate and suitable SSx (e.g. SS7)/signaling links, packet voice, packet data and/or the like), manage, analyze, and provide routing and/or overage prevention according to embodiments of the present disclosure include the Intel Northbridge, the Intel Memory Controller Hub, the Intel Southbridge, and the Intel I/O Controller Hub.

Examples of expansion buses useful for variable dynamic management of network traffic for voice/time and/or data monitoring (e.g. via the appropriate and suitable SSx (e.g. SS7)/signaling links, packet voice, packet data and/or the like), manage, analyze, and provide routing and/or overage prevention according to embodiments of the present disclosure include Industry Standard Architecture (‘ISA’) buses, Peripheral Component Interconnect (‘PCI’) buses, and/or the like.

In various non-limiting embodiments, the RP Server 52 of FIG. 6c includes a disk drive adapter (406) coupled through Expansion Bus (407) and bus adapter (408) to processor (409) and other components of the RP Server 52, the disk drive adapter (406) connects non-volatile data storage to the RP Server 52 in the form of the disk drive (403). Disk drive adapters useful in network hosts include Integrated Drive Electronics (‘IDE’) adapters, Small Computer System Interface (‘SCSI’) adapters, and others as will occur to those of skill in the art. In addition, non-volatile computer memory may be implemented for the network host as an optical disk drive, electrically erasable programmable read-only memory (so-called ‘EEPROM’ or ‘Flash’ memory), RAM drives, and so on, as will occur to those of skill in the art.

In various non-limiting embodiments, the example RP Server 52 of FIG. 6c includes one or more input/output (‘I/O’) adapters (405). I/O adapters in network hosts implement user-oriented input/output through, for example, software drivers and computer hardware for controlling output to display devices such as computer display screens, as well as user input from user input devices (402) such as keyboards and mice. The example RP Server 52 of FIG. 6c includes a video adapter (413), which is an example of an I/O adapter specially designed for graphic output to a display device (414) such as a display screen or computer monitor. Video adapter (414) is connected to processor (409) through a high speed video bus (412), bus adapter (408), and the front side bus (410), which is also a high speed bus.

The exemplary RP Server 52 of FIG. 6c includes a communications adapter (404) for voice/time and/or data communications with other computers (401) and for voice/time and/or data communications with a voice/time and/or data communications network (300). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network and/or the like.

Examples of communications adapters useful for variable dynamic management of network traffic for voice/time and/or data monitoring (e.g. via the appropriate and suitable SSx (e.g. SS7)/signaling links, packet voice, packet data and/or the like), to manage, analyze, and may provide routing and/or overage prevention according to embodiments of the present disclosure include modems for wired dial-up communications, Ethernet (IEEE 802.3) adapters for wired data communications network communications, and 802.11 adapters for wireless data communications network communications, cellular and/or the like.

Point Codes

In various non-limiting SSx (e.g. SS7), a point code is similar to an IP address in an IP network. It is a unique address for a node (Signaling Point, or SP), used in MTP layer 3 to identify the destination of a message signal unit (MSU). In such a message you will find an OPC (Originating Point Code) and a DPC (Destination Point Code); sometimes documents also refer to it as a signaling point code. Depending on the network, a point code can be 24 bits (North America, China), 16 bits (Japan), or 14 bits (ITU standard, International SS7 network and most countries) in length. ANSI point codes use 24 bits, mostly in 8-8-8 format. ITU point codes use 14 bits and are written in 3-8-3 format. Fourteen bit point codes can be written in a number of formats. The most common formats are decimal number, hexadecimal number, or 3-8-3 format (3 most significant bits, 8 middle bits, 3 least significant bits). In various non-limiting embodiments, a point-code and a node are interchangeable. In various non-limiting embodiments, a point code, a node, and/or a device are interchangeable.

Fixed Routing Table (FRT)

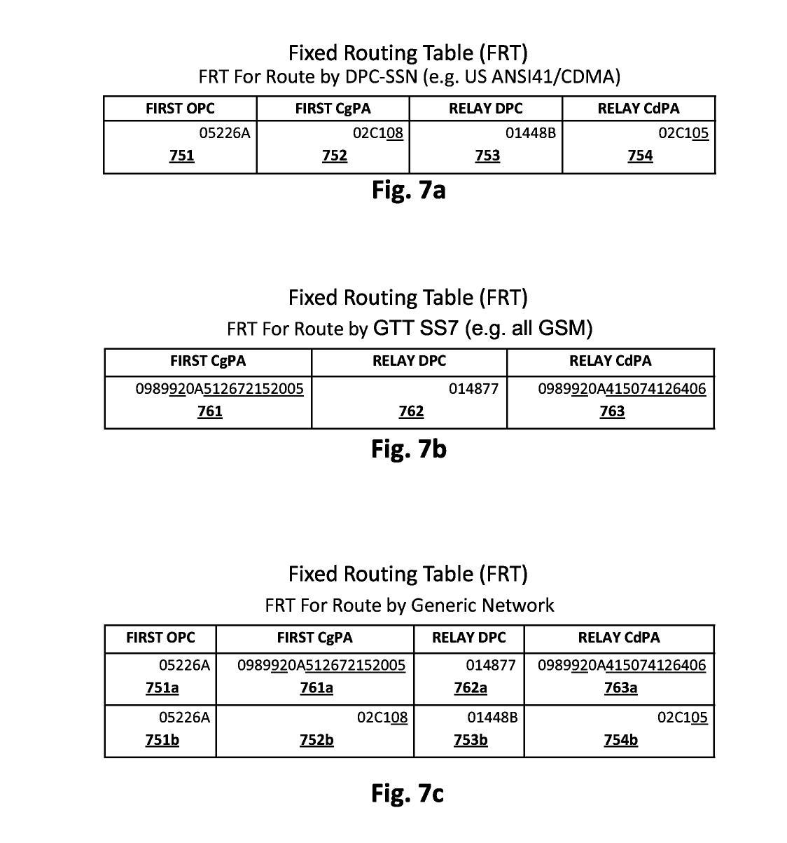

FIG. 7a depicts an embodiment of the Fixed Routing Table (FRT), when routing by DPC-SSN is deployed end node-to-end node in a SSx (e.g. SS7) network, the FRT would preferably provide a Relay DPC and Relay CdPA for every receivable OPC and CgPA. FIG. 7b depicts another embodiment of the FRT, when routing by GTT is deployed in an SSx (e.g. SS7) network, the Fixed Routing Table would preferably provide the Relay DPC and Relay CdPA for every receivable CgPA. FIG. 7c depicts another more generic embodiment of the FRT, when either Routing by DPC-SSN or when Routing by GTT is deployed in an SSx (e.g. SS7) network, the FRT would preferably provide the Relay DPC and Relay CdPA for every receivable combination of first PMV (e.g. every conceivable first OPC and first CgPA).

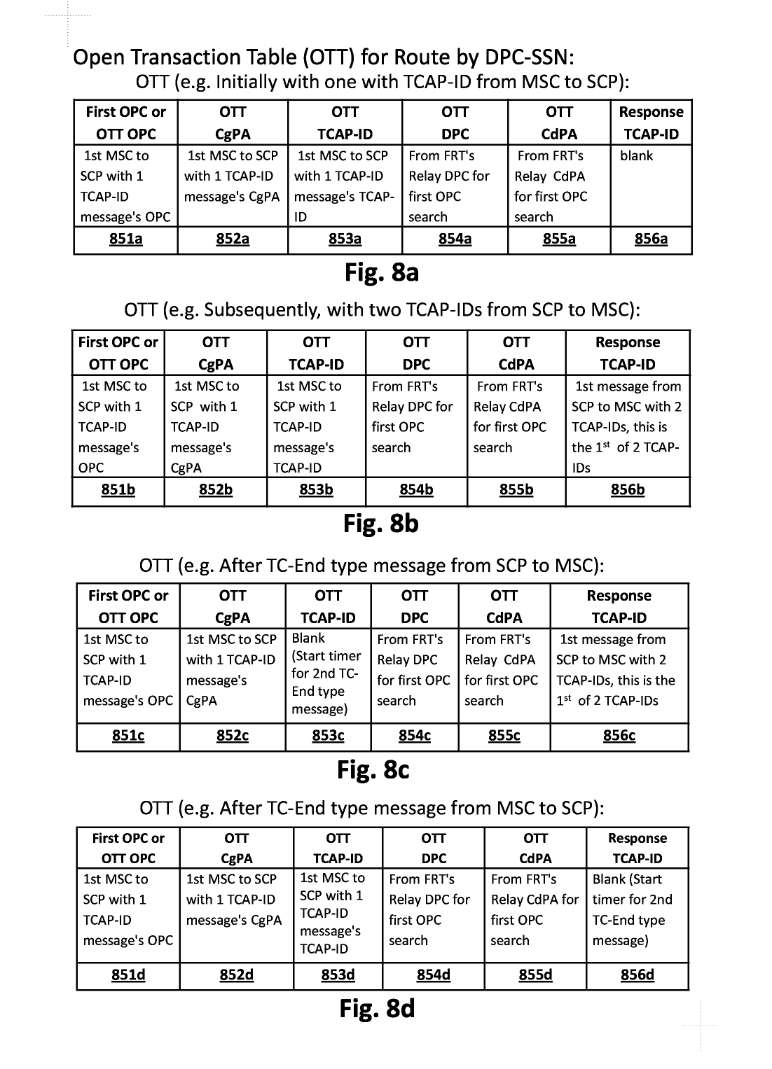

Open Transaction Table (OTT) for Route by DPC-SSN. FIG. 8a depicts an embodiment of the OTT, where there is only one TCAPID in a received TCAP message (sent by an MSC), then the message is either a message type of TC-Begin or a message type of TC-End (this terminology is a generalization of GSM CAMEL terminology that can be applied to both ANSI41 WIN messages and GSM CAMEL messages).

In various non-limiting embodiments, the OTT holds the relay parameters that are utilized to transform a received SS7 TCAP message for SS7 relay transmission. There are various ways to implement this functionality. In this example, and embodiment, a single row contains all the relay parameters, making the process of finding a matching entry for received OPC in Routing by DPC-SSN SS7 networks (or modified to be received OPC+CgPA to accommodate the exception of multiple SSNs at a wireless SCP end node -- or where a received CgPA for Routing by GTT SS7 networks is relatively more complex.

In various non-limiting embodiments, when a TCAP message parses to only one TCAPID and there is no matching entry for the received OPC+TCAPID (Route by DPC-SSN SS7 networks) or received CgPA+TCAPID (Route by GTT SS7 networks) then a new entry is entered per the Table in FIG. 8a.

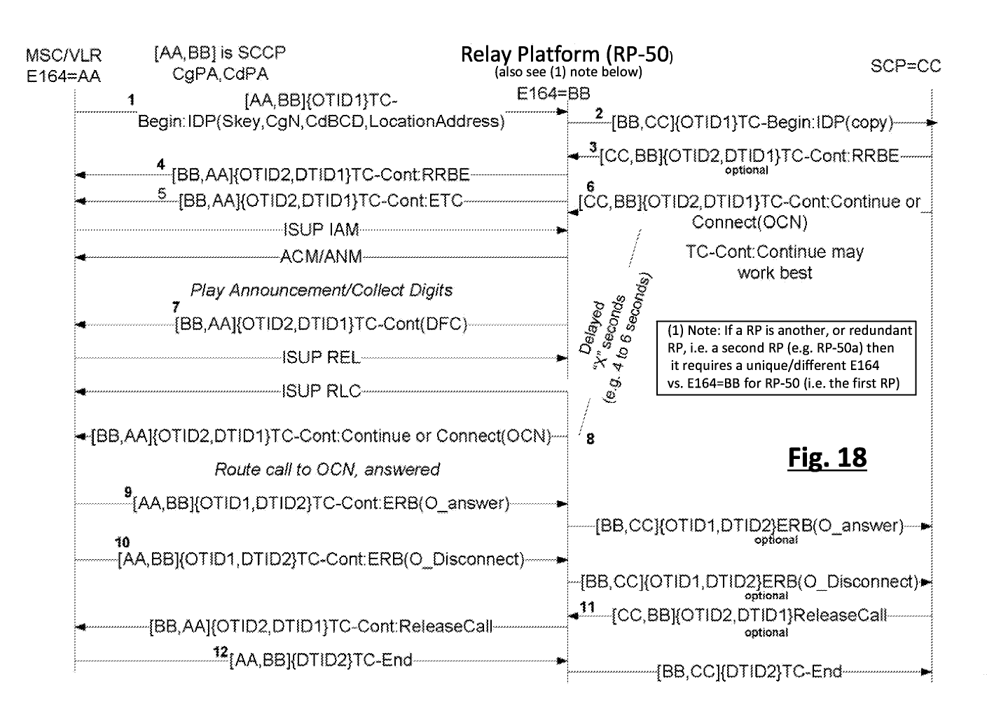

FIG. 8b depicts an embodiment of the OTT, when the destination SS7 node responds. Here, the TCAP conversation message type of message (e.g. RRBE for CAMEL Prepay see FIG. 18 that depicts the Prepay call flow will have an OPC+DTID (where DTID is the second TCAP-ID of two) or CgPA+DTID that matches an entry in OTT with an OTT DPC, or an OTT CgPA, and the OTT OTID. In various non-limiting embodiments, the received TCAP conversation message has its own OTID which can be added to the OTT entry as the Response TCAP-ID in the OTT. In various non-limiting embodiments, this would be required so that the single TCAPID of the TC-End message will find a match in OTT for OPC+TCAPID (Route by DPC-SSN) or for CgPA+TCAPID (Route by GTT).

FIG. 8c depicts an embodiment of the OTT, for example, after a TC-End type message is sent from a SCP to the MSC routed by DPC-SSN. This depicts the case for when the first TC-End type message (TC-End in GSM CAMEL, TCAP Reject or TCAP Abort for both GSM CAMEL and ANSI41 WIN) is received) and a “second TC-End timer” is started.

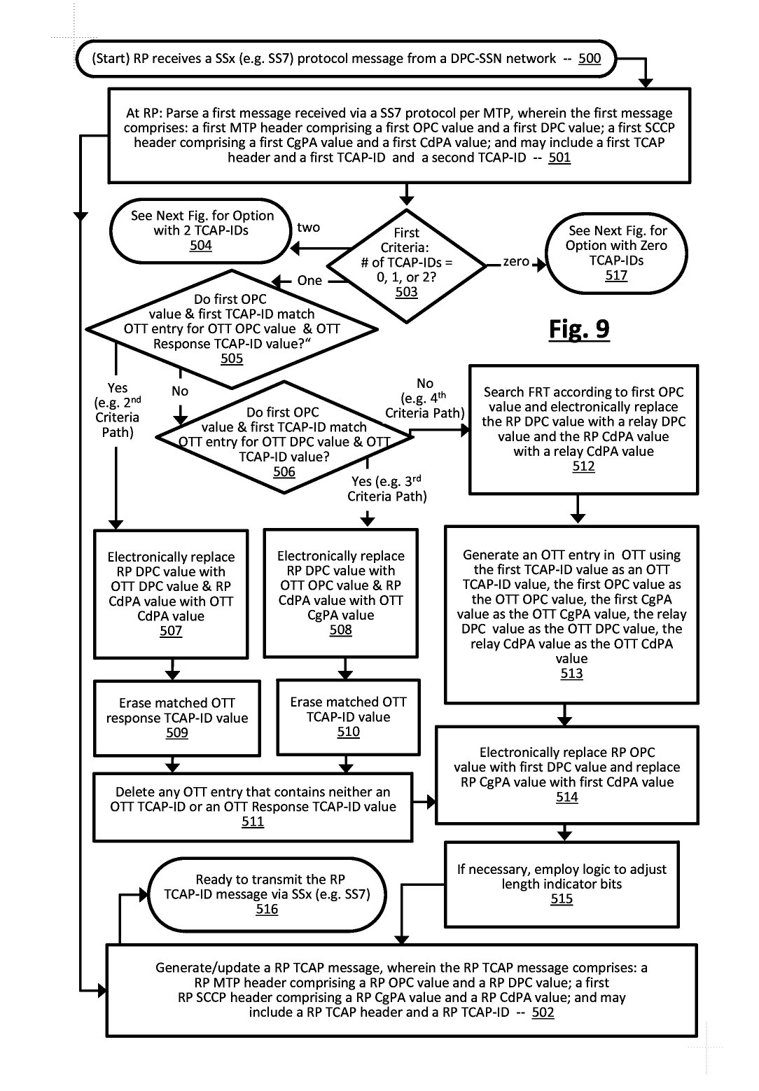

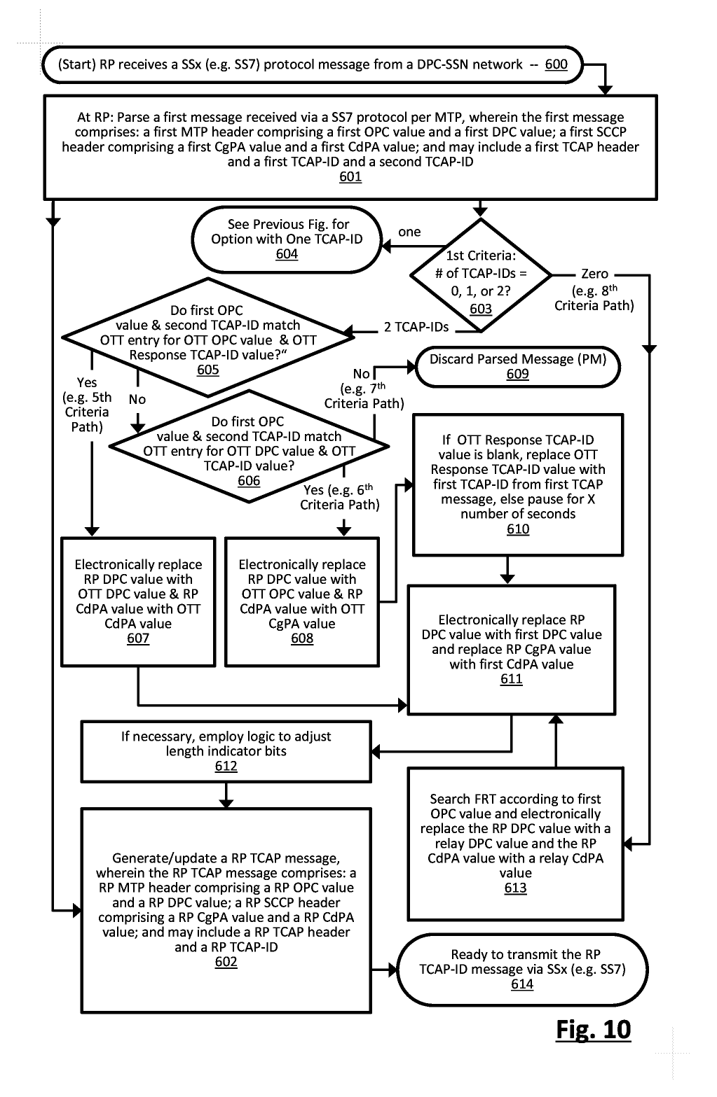

FIG. 8d depicts an embodiment of the OTT, for example, after a TC-End type message is sent from the MSC to the SCP routed by DPC-SSN. FIG. 9 is a flowchart depicting a preferred embodiment of a TCAP [Transaction Capabilities Application Part] message received via a SSX (e.g. SS7) protocol from a DPC-SSN network at the Relay Platform. FIG. 10 is a flowchart extension of FIG. 9, depicting a TCAP [Transaction Capabilities Application Part] where a message is received via a SSX (e.g. SS7) protocol from a DPC-SSN network at the Relay Platform.

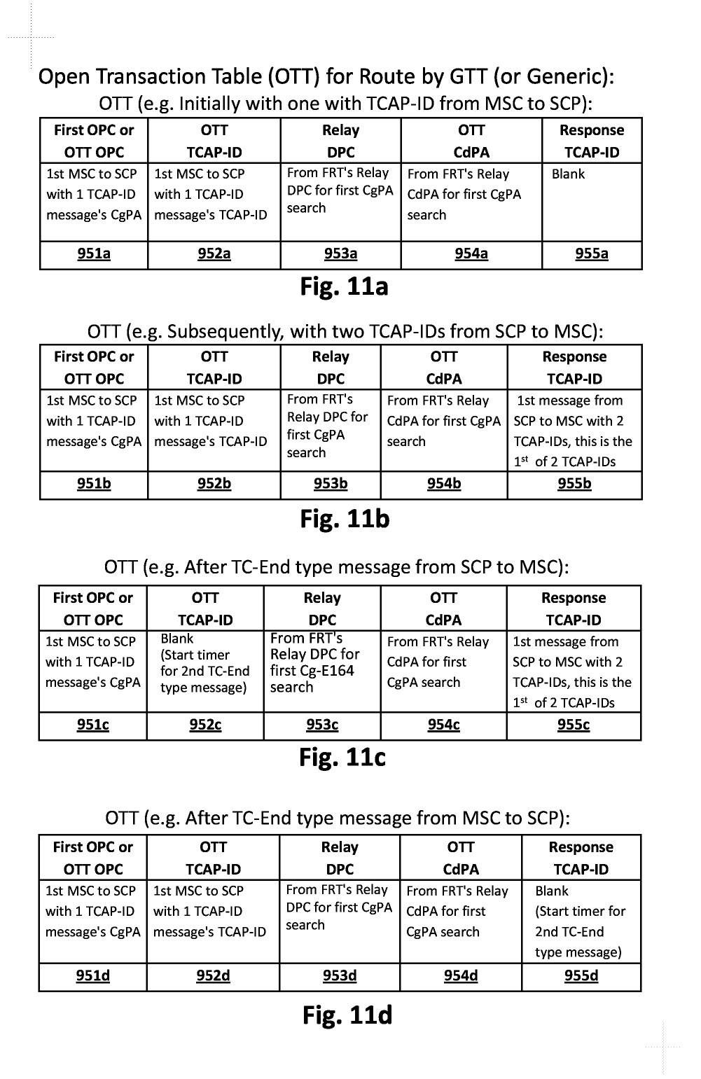

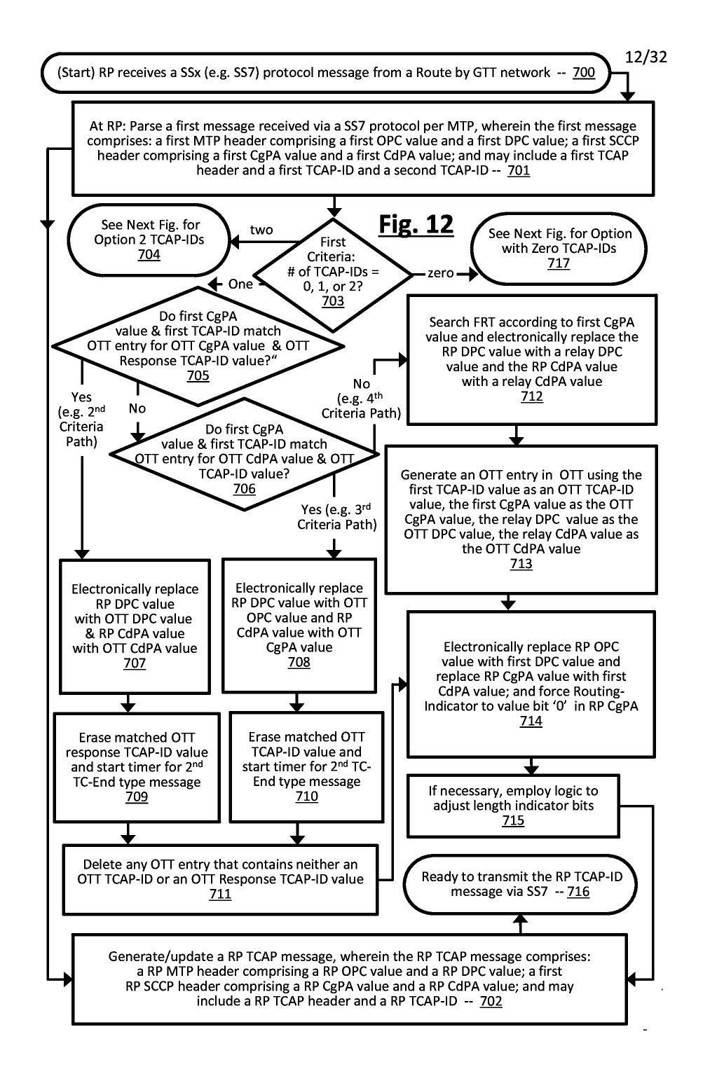

Open Transaction Table (OTT) for Route by GTT (or Generic Network). FIGS. 11-d depict embodiments of the OTT. FIG. 12 is a flowchart depicting alternative embodiment to the FIG. 9 embodiment, of a TCAP [Transaction Capabilities Application Part] message received via a SSX (e.g. SS7) protocol by a GTT network at the Relay Platform.

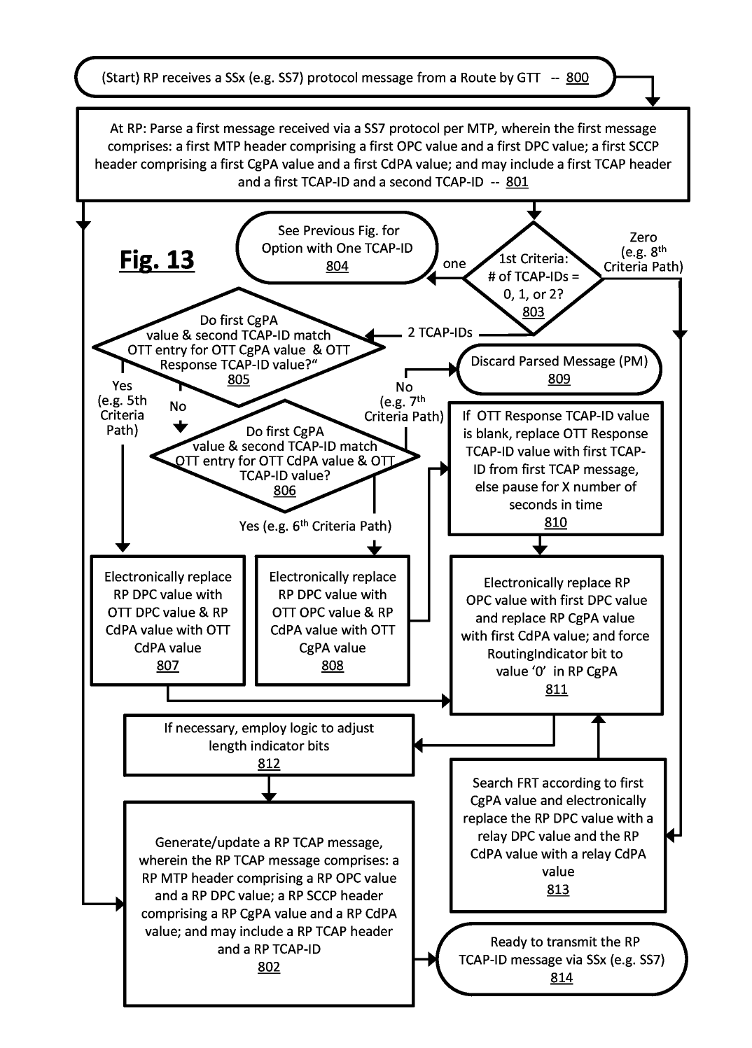

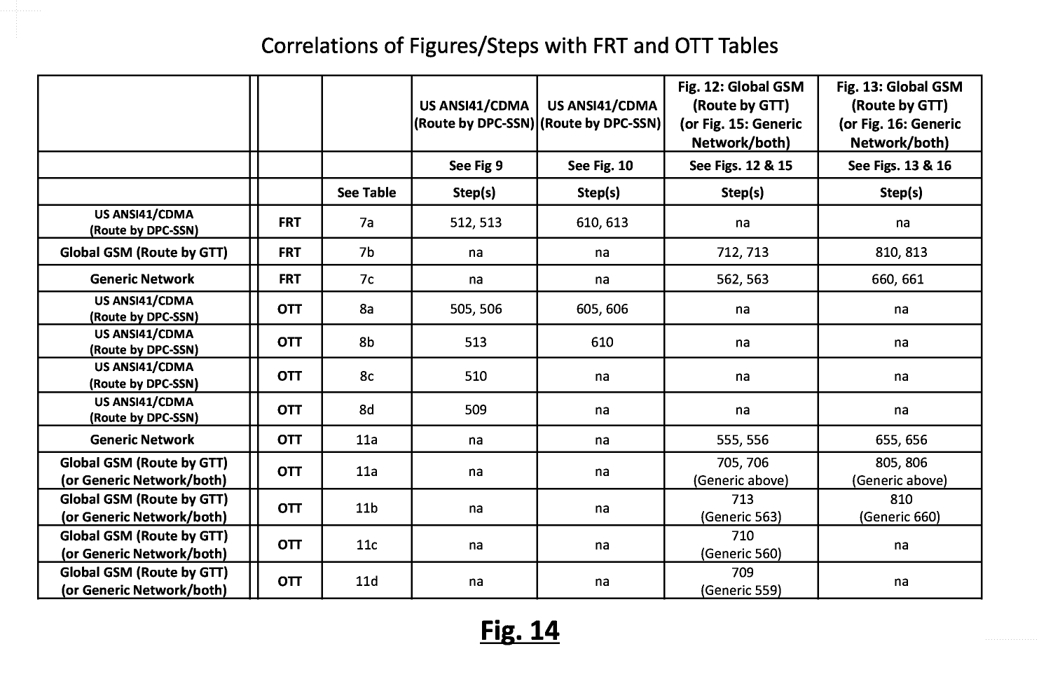

FIG. 13 is a flowchart extension of FIG. 12, depicting alternative embodiment to the FIG. 10 embodiment, where a TCAP [Transaction Capabilities Application Part] message is received via a SSX (e.g. SS7) protocol by a GTT network at the Relay Platform. FIG. 14 depicts a lookup guide/table entitled: “Correlations of Figures/Steps with FRT and OTT Tables,” for the purpose of correlating the FRT tables in FIGS. 7a ,7b and 7c, along with the OTT tables in FIGS. 8a-8d and 11a-11d with the appropriate step labeled in FIGS. 9, 10, 12, 13, 15 and 16 in various non-limiting embodiments.

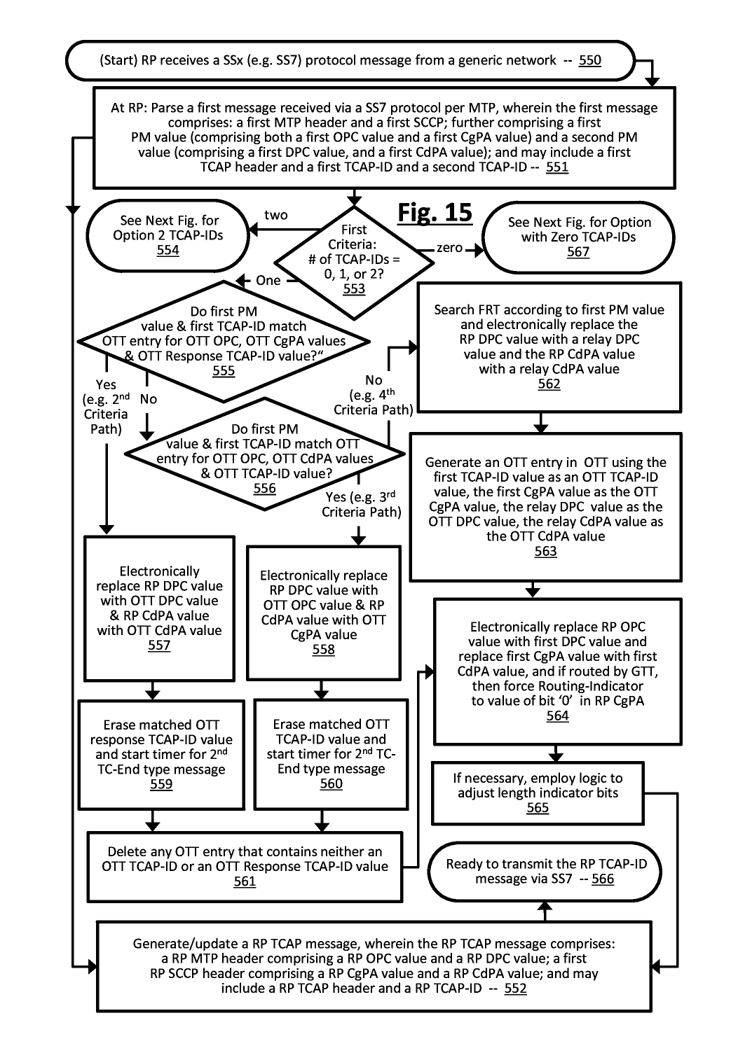

FIG. 15 is a flowchart depicting alternative embodiment to the FIGS. 9 & 12 embodiments, of a TCAP [Transaction Capabilities Application Part] message received via a SSX (e.g. SS7) protocol by a GTT network at the Relay Platform.

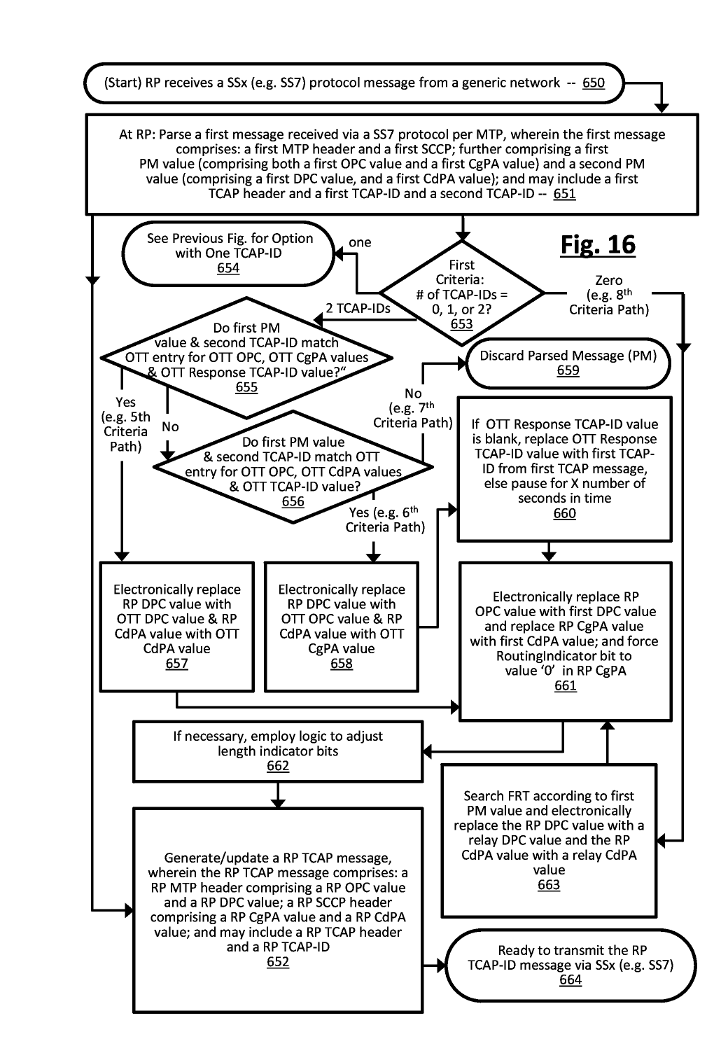

FIG. 16 is a flowchart extension of FIG. 15, depicting alternative embodiment to the FIGS. 10 and 13 embodiments, where a TCAP [Transaction Capabilities Application Part] message is received via a SSX (e.g. SS7) protocol by a GTT network at the Relay Platform.

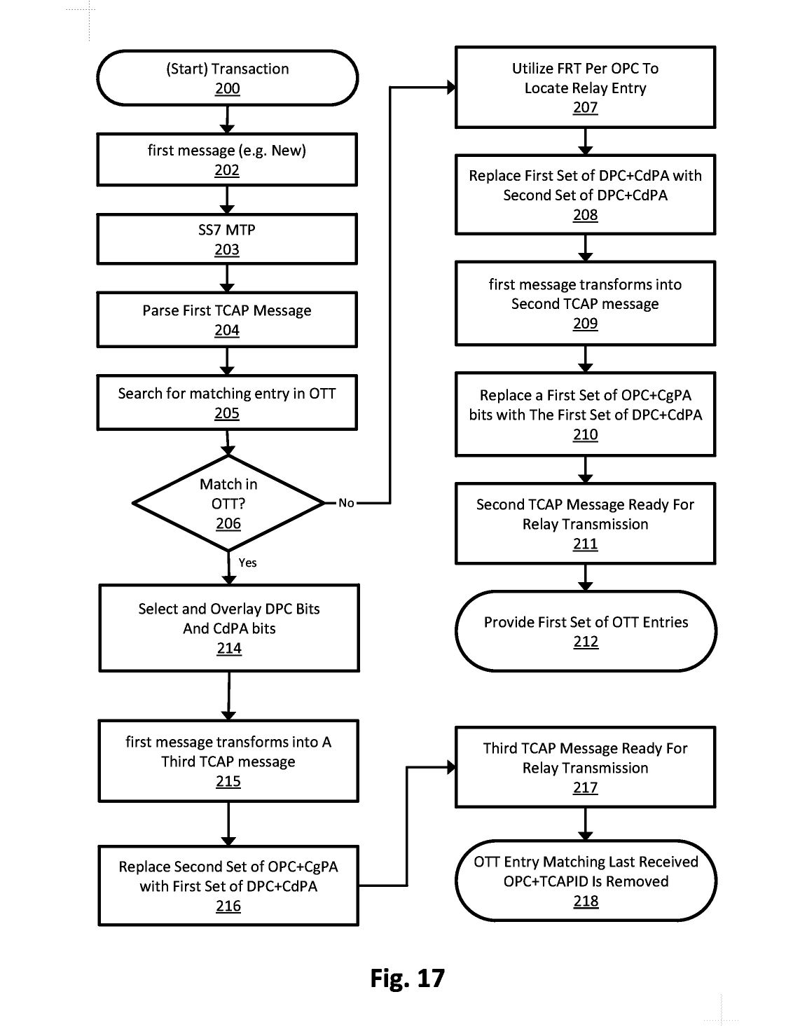

FIG. 17 is a flowchart depicting a TCAP [Transaction Capabilities Application Part] transaction, for US ANSI41 or CDMA in an alternative embodiment.

FIG. 18 depicts a call flow of an embodiment employing the Relay Platform (RP) where a Mobile Device is a Prepay Subscriber connected to a Mobile Network along with a series of Detection Points (DPs).

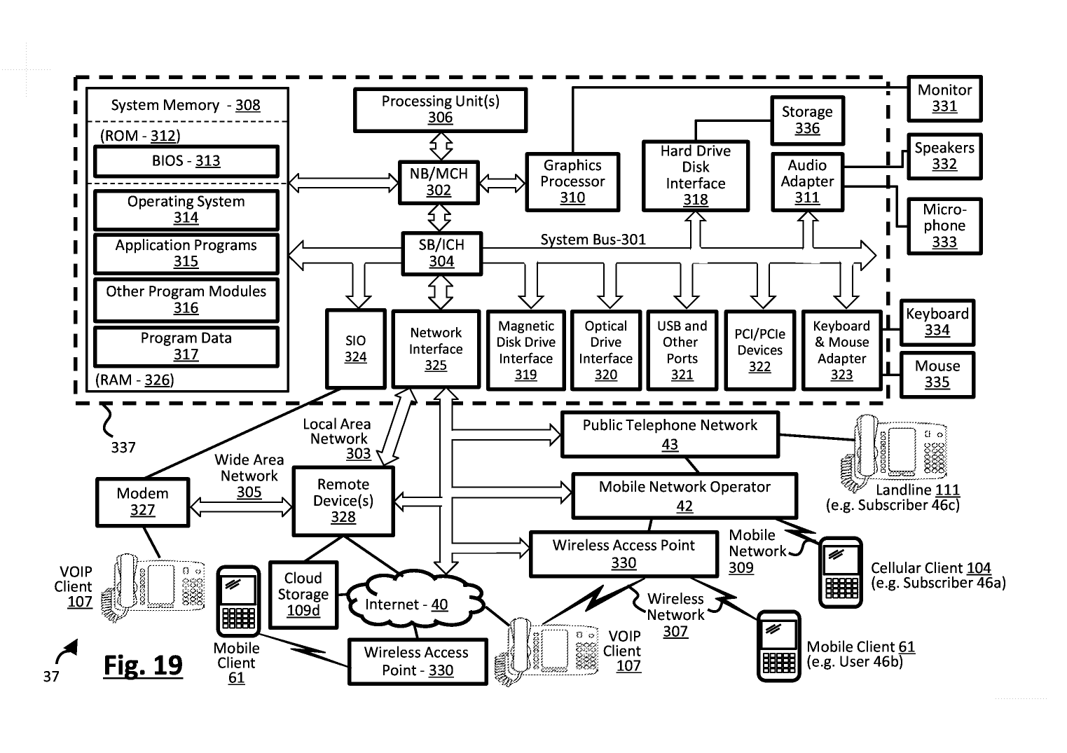

FIG. 19 depicts an operating environment 37 in which the various systems, methods, and data structures described herein may be implemented. In various non-limiting embodiments, the exemplary Operating Environment 37 of FIG. 19 includes a general purpose computing device in the form of a Computer 337, including a Processing Unit 306, a System Memory 308, and a System Bus 301 that operatively couples various system components, including the System Memory to the Processing Unit 306. In various non-limiting embodiments, there may be only one or there may be more than one processing unit 306, such that the processor of Computer 337 comprises a single central processing unit (CPU), or a plurality of processing units, commonly referred to as a parallel processing environment. In various non-limiting embodiments, the Computer 337 may be a conventional computer, a distributed computer, or any other type of computer.

In various non-limiting embodiments, and in-general, the Computer 337 represents the computer utilized in the RP 50, and/or RP 50, preferably wherein the functionality required to perform a variety of disclosed system and module functions is provided by the Computer 337 and/or similar. In various non-limiting embodiments, the Computer 337 represents a particular computer associated with the RP 50 and/or RP 50, preferably wherein the functionality required to perform a variety of disclosed system and module functions is provided by the Computer 337 and/or similar.

In various non-limiting embodiments, the Computer 337 may represent the computer and functionally utilized in the third party server, and/or account, preferably wherein the functionality required to perform a variety of disclosed system and module functions is provided by the Computer 337 and/or similar. In various non-limiting embodiments, the Computer 337 represents a particular computer associated with the third party server, and/or account, preferably wherein the functionality required to perform a variety of disclosed system and module functions is provided by the Computer 337 and/or similar.

In various non-limiting embodiments, the Computer 337 may represent the computer and functionally utilized in the client, and/or device, preferably wherein the functionality required to perform a variety of disclosed system and module functions is provided by the Computer 337 and/or similar. In various non-limiting embodiments, the Computer 337 represents a particular computer associated with the client, and/or device, preferably wherein the functionality required to perform a variety of disclosed system and module functions is provided by the Computer 337 and/or similar.

In various non-limiting embodiments, the System Bus 301 may be any of several types of bus structures, including a memory bus or memory controller, a peripheral bus, and/or a local bus using any of a variety of bus architectures. In various non-limiting embodiments, the system memory may also be referred to as simply the memory, and includes Read Only Memory (ROM) 312 and random access memory (RAM) 326. A basic input/output system (BIOS) 313, containing he basic routines that help to transfer information between elements within the Computer 337, such as during start-up, is stored in ROM 312. In various non-limiting embodiments, the Computer 337 further includes a hard disk drive (e.g. storage 336 or storage medium) for reading from and writing to a hard disk (e.g. Storage medium 336, Storage medium 109, 109a, 109b, 109c), a magnetic disk drive for reading from or writing to a removable magnetic disk, and an optical disk drive for reading from or writing to a removable optical disk, such as a CD-ROM, digital versatile disk (DVD), or other optical media.

In various non-limiting embodiments, the hard disk drive, magnetic disk drive, and optical disk drive are connected to the System Bus 301 by the Hard Disk Drive Interface 318, a Magnetic Disk Drive Interface 319, and an Optical Disk Drive Interface 320, respectively. In various non-limiting embodiments, the drives and their associated computer-readable media provide nonvolatile storage (e.g. storage medium) of computer-readable instructions, data structures, program modules and other data for the computer 337. It should be appreciated by those skilled in the art that any type of computer-readable media which can store data that is accessible by a computer, such as magnetic cassettes, flash memory cards, flash memory devices (e.g. card, stick), smart cards, digital video disks, Bernoulli cartridges, random access memories (RAMs), read only memories (ROMs), and the like, may be used in the Operating Environment 37.

A number of program modules may be electronically stored on the hard disk, magnetic disk, optical disk, ROM 312, or RAM 326, including an Operating System 314, one or more Application Programs 315, Other Program Modules 316, and Program Data 317. At least one of the Application Programs 315 is a host application operable to control presentation of media and/or content using a playlist and respond to user and application initiated events.

A user may enter commands and information into the personal computer 337 through input devices such as a Keyboard 334 and pointing device or a Mouse 335. Other input devices may include a Microphone 333, a (not shown) joystick, game pad, satellite dish, scanner, and/or the like. In various non-limiting embodiments, these and other input devices are often connected to the Processing Unit 306 through a serial port interface or SIO 324 that is coupled to the System Bus 301, but may be connected by other interfaces, such as a parallel port, game port, a universal serial bus (USB) and Other Ports 321, or a PCI/PCIe Devices (IO) 322. A Monitor 331 or other type of display device is also connected to the System Bus 301 via an interface, such as a video adapter and may include a Graphics Processor 310. In addition to the monitor, computers typically include other peripheral output devices, such as a Speaker(s) 332, and printers (not shown).

In various non-limiting embodiments, the Computer 337 may operate in a networked environment using logical connections to one or more remote devices (e.g. clients, servers, storages, and/or the like), such as a Remote device 328 or connect to one or more than one additional storage devices, such as the cloud storage 109d medium. In various non-limiting embodiments, these logical connections may be achieved by a communication device coupled to or a part of the Computer 337, or in other manners. In various non-limiting embodiments, the Remote device 328 may be another computer, a server, a router, a network PC, a client, a peer device or other common network node, and typically includes many or all of the elements described above relative to the Computer 337. In various non-limiting embodiments, the logical connections depicted herein include a local-area network (LAN) 303, a wide-area network (WAN) 305, and the Internet 40. Such networking environments are commonplace in office networks, enterprise-wide computer networks, intranets and the Internal, which are all types of networks.

In various non-limiting embodiments, the use/subscriber/customer, representatives of the use/subscriber/customer, corresponding network operator, and/or accounts, may access or communicate with a manager via a device (e.g. customer device) over a communication channel. The device (e.g. customer device) may be a server, a virtual machine, a desktop computer, a laptop computer, a mobile computing device, or any other computing platform from which a user/subscriber/customer/account, or a customer agent (e.g. account) may interact with the manager . The device (e.g. customer device) or the manager may also be virtual servers running in one of the virtual compute clouds (e.g. N-N1). A communication channel may be wired or wireless. The communication channel may operate over an intranet, a private network, a public network, or encrypted private channels over a public network. In some embodiments, the manager presents an API (Application Programming Interface) via the communication channel to the device (e.g. customer device). In some embodiments, the interface presented by the manager is a web interface or website. In some embodiments, the device (e.g. customer device) executes software configured to communicate with the manager.

In various non-limiting embodiments, each cloud is hosted by a cloud provider and directly managed by a cloud controller. Each cloud (e.g. N-N1) may be a multi-tenant cloud, that is, each cloud host may sell cloud based services to multiple parties or tenants. Multi-tenant cloud computing service providers include, for example, Amazon.com, Inc. (e.g., Amazon Web Services), Rackspace Hosting, Inc. (e.g., Rackspace Cloud), Google Inc. (e.g. Google Compute Engine), and Microsoft Corp. (e.g., Windows Azure). Providers generally host servers and services that enable customers to instantiate a number of virtual servers in a variety of different configurations to match their needs and to launch various services related to the virtual servers. For example, Amazon.com, Inc., provides virtual servers in the Amazon Elastic Compute Cloud (Amazon EC), and it provides services in Amazon Simple Storage Service (Amazon S), Amazon Elastic Load Balancer (ELB), Amazon Dynamo DB, and Amazon Relational Database Service (Amazon RDS).

In various non-limiting embodiments, a cloud-based service may be established by a cloud controller (e.g. X) or by the cloud manager. For example, a customer/device may access the manager , e.g., via a device and the communication channel, and request that a service be established, maintained, rerouted, throttled, updated, suspended, terminated, re-assigned, and/or the like. The manager coordinates instantiation of a cloud-based service in a cloud (e.g. N). The customer, account, or network operator (e.g. mobile network operator), may then use the manager to monitor the cloud-based service instance and to handle any other service oriented requests. In some embodiments, the manager provides the device with a token or access entity credentials (e.g. roles and permissions) enabling the device (e.g. customer device) to communicate directly with the service, e.g., via communication channel

In various non-limiting embodiments, the user device, manager, and clouds (eg. N-N1) may be connected in any manner, and via any network or networks. In various non-limiting embodiments, the channels may comprise the Internet, local networks, web servers, file servers, routers, databases, computers, servers, network appliances, or any other computing devices capable of sending and receiving information. A network may comprise computing devices connected via cables, infrared ports, wireless signals, or any other means of connecting multiple computing devices. A network and any devices connected to the networks may communicate via any communication protocol used to communicate among or within computing devices, including without limitation SSL, BitTorrent, HTML, XML, RDP, ICA, FTP, HTTP, SIP, XMPP (also known as Jabber), TCP, IP, UDP, IPX, SPX, NetBIOS, NetBEUI, SMB, SMTP, Ethernet, ARCNET, Fiber Distributed Data Interface (FDDI), RS, IEEE ., IEEE .a, IEE .b, IEEE .g, IEEE .n, WiMax and direct asynchronous connections, or any combination and/or extensions thereof. The network may comprise mobile telephone networks utilizing any protocol or protocols used to communicate among mobile devices, including AMPS, TDMA, CDMA, GSM, GPRS or UMTS.

In various non-limiting LAN-networking environments or including LAN-networks, the Computer 337 is connected to the LAN 303 through an adapter or Network Interface 325, which is one type of communications device. When used in a WAN-networking environment, the Computer 337 typically includes a Modem 327, a type of communications device, or any other type of communications device for establishing communications over the WAN 305. In various non-limiting embodiments, the Modem 327, which may be internal or external, is connected to the System Bus 301 via the serial port interface/SIO 324. In a networked environment, program modules depicted relative to the Computer 337, or portions thereof, may be stored in the remote memory storage device/medium (not shown here).

In addition to the LAN 303 and the WAN 305, the logical connections may include a Public Switched Telephone Network (PSTN) 43, a Mobile Network Operator 42 (with a Mobile Network 309), and a Wireless Access Point 330 (with a Wireless Network 307). When used in PSTN 43, the Computer 337 typically includes a type of communications device such as a Wired-Line Client 111, or any other type of communications device for establishing communications over the PSTN 43. In the PSTN 43 environment, the program modules, or portions thereof, may be stored at the PSTN 43.

In various non-limiting embodiments, the logical connections for the Mobile Network Operator 42 with the associated Mobile Network 309, the Computer 337 typically includes a type of communications device such as the Cellular Client 104, or any other type of communications device for establishing communications over the Mobile Network 309. In the Mobile Network 309 environment, the program modules, or portions thereof, may be electronically stored on the storage medium, e.g. at the MNO 25 and/or within the communications devices.

In various non-limiting embodiments, the logical connections for the Wireless Access Point 330 with the associated Wireless Network 307, the Computer 337 typically includes a type of communications device such as the Mobile Client 61, VOIP Client 107 or any other type of communications device for establishing communications over the Wireless Network 307. In the Wireless Network 307 environment, the program modules or portions thereof may be electronically stored on storage device/medium at the Wireless Access Point 330 and/or within the communications devices.

In various non-limiting embodiments, the disclosure presents various methods performed by a computer having a memory and a processor for data interchange, the method compromising. a receiving a first user input; analyzing the first user input; generating a relative accuracy score, where the first user input is relatively compared with a second input; analyzing the relative accuracy score against a relative accuracy criteria, wherein a violation of the relative accuracy criteria generates a prompt; sending the prompt to an entity; and receiving a decision from the entity.

In various non-limiting embodiments, the disclosure presents various methods performed by a computer having a memory and a processor for information extraction, natural language processing, and relationship mapping, including parsing, analyzing, indexing, classifying, evaluating, and/or the like, including the utilization of semantics analysis where each every data element, object, person, item, node, device, location, subject, delineation, segment, interval, and/or the like, mentioned herein should be considered a node for relationship mapping. Further, where this entire specification, pages, headings, paragraphs, sentences, words, figures, steps, parts, objects, tables, fields, and/or the like, is a node, and/or can be parsed and treated like a node for relationship purposes. Further, each and every element herein this specification, pages, headings, paragraphs, sentences, words, figures, steps, parts, objects, tables, fields, node, user, term, rule, element, and/or the like, can be parsed, analyzed, and evaluated to provide a relationship to each every other node, including nodes referenced outside the specifications, such as website, other art, prior applications. Further, each and every element herein this specification, pages, headings, paragraphs, sentences, words, figures, steps, parts, objects, tables, fields, node, user, term, rule, element, and/or the like, can be parsed, analyzed, and evaluated to generate triples, IP-Triples, triple statements, IP-Statements, and/or the like.

The foregoing description of the present disclosure has been provided for purposes of illustration and description. It is not intended to be exhaustive or to limit any invention to the precise forms disclosed. Many modifications and variations will be apparent to the practitioner skilled in the art. Embodiments were chosen and described in order to best explain the principles of any particular disclosure/invention and its practical application, thereby enabling others skilled in the art to understand any particular disclosure/invention, the various embodiments and with various modifications that are suited to the particular use contemplated. It is intended that the scope of a particular disclosure/invention be defined by the following claims and their equivalents.

It should be noted as well that certain embodiments may be implemented as a system, method or computer program product. Accordingly, aspects may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects may take the form of a computer program product embodied in one or more computer readable medium(s) having computer readable program code embodied therewith.

Any combination of one or more computer readable medium(s) may be utilized. In various non-limiting embodiments, the computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device/medium, a magnetic storage device/medium, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for various aspects may be written in any combination of one or more programming languages, including an object oriented programming language such as Java™ Smalltalk, C++ or the like and conventional procedural programming languages, such as the “C” programming language or similar programming languages. In various non-limiting embodiments, the program code may execute entirely on a single computer (device), partly on a single computer, as a stand-alone software package, partly on single computer and partly on a remote computer or entirely on a remote computer or server. In the latter scenario, the remote computer may be connected to another computer through any type of network, including a local area network (LAN) or a wide area network (WAN), or the connection may be made for example through the Internet 40 using an Internet Service Provider.

Aspects are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. In various non-limiting embodiments, these computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In various non-limiting embodiments, these computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

In various non-limiting embodiments, the computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure. Therefore, one having ordinary skill in the art will readily understand that the disclosure as discussed above may be practiced with steps in a different order, may be practiced with hardware elements in configurations which are different than those which are disclosed, and that embodiments may be combined in any appropriate manner.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In addition, the term application as used herein refers to computer software program in general and can further encompass data, configuration settings, etc., used by the computer software program. Examples include utilities such as e-mail, Short Message Service (SMS) text utility, DTMF, IM, chat interface, web browsers, calculators, viewers, media players, games, calendars, tasks, to-do-lists, shopping-lists, contact managers, home monitoring/security surveillance, etc. In an exemplary aspect, application can refer to software that is suitable for use on a mobile device, especially to being downloaded via a Wireless Local Access Network (WLAN) or Wireless Wide Area Network (WWAN).

As a further example, applications as used herein can also refer to widgets, which can be a code set installed or executed in a webpage without compilation. Examples of widget information which can be downloaded through the Internet 40 include information of weather, sports, financial news, stock data/ticks/reports, stock market data/ticks/reports, medical records, prescription records/data, traffic, real-time search ranking, photos, slides, presentations, videos, playlists, post-it notes, horoscopes, etc. Widgets can be added to social networking profiles, blogs, or Web sites. Examples of types of widgets include (1) a widget engine, (2) GUI widgets (which are a component of a graphical user interface in which the user interacts), (3) Web widgets (which refer to a third party item that can be embedded in a Web page), and (4) mobile widgets (a third party item that can be embedded in a mobile device/phone).

For clarity, examples herein denote applications that are locally stored on user equipment, mobile devices, handset, access terminals, etc. However, implementations can encompass applications that are remotely stored. Similarly, for clarity distributing of the applications to the mobile devices can be described as being wirelessly downloaded from a WWAN or WLAN or P2P. However, implementations can include wired distribution, manual insertion of non-transitory computer readable storage medium, and unlocking a previously installed software object.

The word “exemplary” used anywhere herein is to mean serving as an example, instance, or illustration. Any aspect or design described herein as “exemplary” is not necessarily to be construed as preferred or advantageous over other aspects or designs.

Various aspects will be presented in terms of systems that may include a number of components, modules, and the like. It is to be understood and appreciated that the various systems may include additional components, modules, etc. and/or may not include all of the components, modules, etc. discussed in connection with the Figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet 40 or a local area network (LAN). Of course, those skilled in the art will recognize many modifications may be made to this configuration without departing from the scope of the disclosed aspects.

In various non-limiting embodiments, the steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. In various non-limiting embodiments, the processor and the storage medium may reside in an ASIC. In various non-limiting embodiments, the ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. In various non-limiting embodiments, a process is terminated when its operations are completed. In various non-limiting embodiments, a process may correspond to a method, a function, a procedure, a subroutine, a subprogram, etc. When a process corresponds to a function, its termination corresponds to a return of the function to the calling function or the main function.

In view of the exemplary systems described supra, methodologies that may be implemented in accordance with the disclosed subject matter have been described with reference to several flowcharts, flow diagrams. While for purposes of simplicity of explanation, the methodologies are shown and described as a series of blocks, it is to be understood and appreciated that any claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

Similarly, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or voice/time and/or data

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. In various non-limiting embodiments, a code segment may represent a procedure, a function, a subprogram, a program, a routine, a subroutine, a module, a software package, a class, or a combination of instructions, data structures, or program statements. In various non-limiting embodiments, a code segment may be coupled to another code segment or a hardware circuit by passing and/or receiving information, voice/time and/or data, arguments, parameters, or memory contents. In various non-limiting embodiments, information, arguments, parameters, data, etc. may be passed, forwarded, or transmitted through a suitable means including memory sharing, message passing, token passing, network transmission, etc.

It should be appreciated that any patent, publication, or other disclosure material, in whole or in part, that is said to be incorporated by reference (e.g. incorporated by reference in its entirety for all purposes) herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

Another System and Method of Managing Mobile Network Traffic

Managing Handovers, NCLs and Connections in a Radio Network

In another embodiment of managing mobile network traffic (e.g. in a radio network) of the present disclosure, there is a modification to the traditional handover (or handoff) process in a base station subsystem of the radio network, mobile network and/or mobile network operators. Traditionally, the radio/mobile network handover (or handoff) process involves maintaining a connection between the UE (user equipment, e.g. mobile device) and a first base station (or similar) until a criteria is met (e.g. a weak signal threshold) causing the mobile device to search for a second base station (e.g. with a superior signal/threshold) and thus the connection is transferred from the first base station to the second base station, dropping or releasing the first connection.

Radio Resource Management (RRM)

Device Mobility in EUTRA/LTE (including SRVCC)

Techniques based upon radio quality measures that are managed, for example, by LTE capable terminals, such as cell search, cell reselection, handover, or radio link monitoring. Measures can be delineated into actions during a passive connection with the network or an active connection with the network. Active and passive connections are different radio resource control states that, say the LTE terminal can have with the radio or mobile network. After the LTE terminal is powered up there is no IP addressed assigned to the UE and the UE location is unknown. Here the LTE terminal initiates a cell search and selection, along with system information acquisition process. The process searches synchronization references and specific cell reference signals and performing quality measures to determine if a particular found cell is suitable to connect on.

For the traditional realization of handoffs in a mobile network (or cellular network) each cell is assigned a list of potential target cells, which can be used for handing-off a call from this first source cell to another. These potential target cells are called neighbors and the list is called a neighbor list. A variety of different algorithms may be used for input data from field measurements or computer predictions of radio wave propagation in the areas covered by the cells.

Traditionally during a call one or more parameters of the signal in the channel in the source cell are monitored and assessed in order to decide when a handover (or handoff) may be necessary. The downlink (forward link) and/or uplink (reverse link) directions may be monitored. The handover (or handoff) may be requested by the phone or by the base station (BTS) of its source cell and, in some systems, by a BTS of a neighboring cell. The phone (or mobile device) and the BTSs of the neighboring cells monitor each other others' signals and the best target candidates are selected among the neighboring cells. In some systems, mainly based on CDMA, a target candidate may be selected among the cells which are not in the neighbor list. This is done in an effort to reduce the probability of interference due to a near-far effect.

Signal Nose Ratios

In analog systems the parameters used as criteria for requesting a hard handover (or handoff) are usually based upon the received signal power and the received signal-to-noise ratio (the latter may be estimated in an analog system by inserting additional tones, with frequencies just outside the captured voice-frequency band at the transmitter and assessing the form of these tones at the receiver). In non-CDMA 2G digital systems the criteria for requesting hard handover (or handoff) may be based on estimates of the received signal power, bit error rate (BER) and block error/erasure rate (BLER), received quality of speech (RxQual), distance between the phone and the BTS (estimated from the radio signal propagation delay) and others.

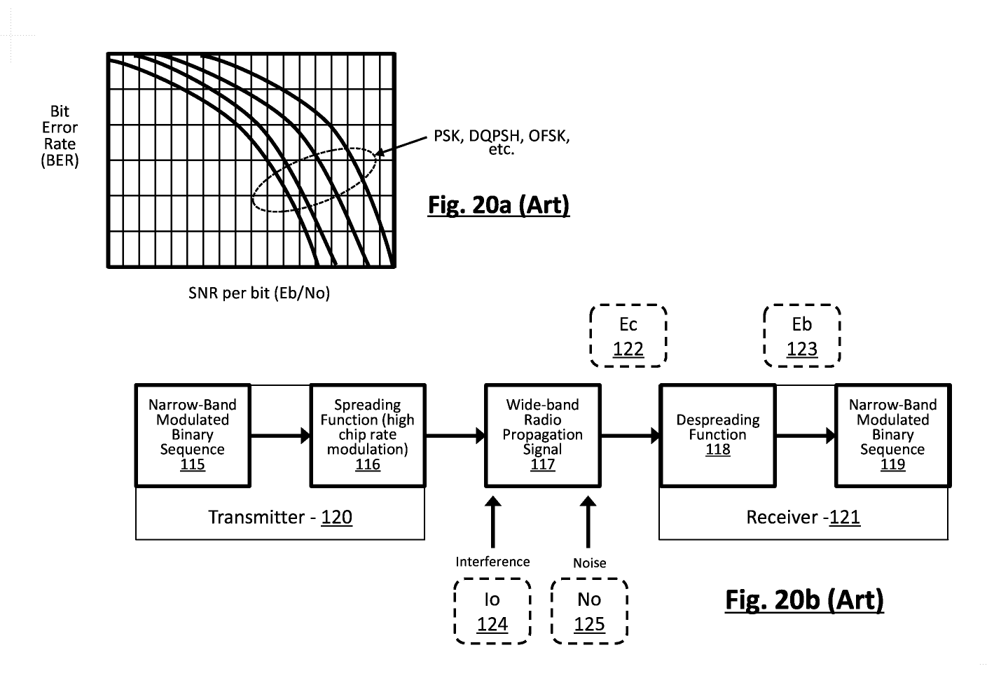

In CDMA and UMTS systems, the most common criterion for requesting a handover (or handoff) is Ec/Io ratio measured in the pilot channel (CPICH) and/or RSCP. First there is the concept of Eb/No which applies to any digital communication system. Here, Ec/Io specifically, is a measure of evaluation and decisions of CDMA and UMTS. Whereas in GSM, C/I is used as a signal-interferences ration. FIG. 20b depicts an example of a simplified diagram of traditional Spread Spectrum Modulation, where the transmitter 120 has a “Narrowband Modulated Binary Sequence” 115 step/part, say a narrowband signal with data or voice modulated. This signal is spread and transmitted per the steps/parts depicted. In the receiver 121, the signal is despread utilizing the same sequence that was spread, thus recovering the base narrowband signal. The E in “Ec” 122 is the signal (average) energy (not to be confused with the average signal power) and “b, c, s, . . . ” is measurable energy at the power points in time, relative to the measure or “length” of the time (whereas the average power is independent of time). Hence, there is an Eb 123, Ec 122, and Es, respectively relating to Bit Chip and Symbol in different times (with some variations per country, technology, etc.). The basic concepts of Eb 123 (Bit Energy) and No 125 (Noise Spectral Density) have been keys to dealing with Bit Error Rates and Modulation Techniques, where Eb 123 represents the amount of energy per bit and No 125 is the unit of Watts/Hz (or mWatts/Hz). The classic definition of Eb/No is Bit Energy on the Spectral Noise Density (units: dB). In a relatively simple digital communication system, the ratio Eb/No is measured at the receiver, and serves to indicate how strong is the signal, where depending on the modulation technique employed (BPSK, QPSK, etc.) there are different curvatures for the Bit Error Rate x Eb/No as depicted in an example in FIG. 20a. For a certain RF signal, the data derived from the curves is employed in an analysis to determine if the bit error rate is acceptable for the given system. Whereas, the gain of particular digital system can be set with a minimum criterion of signal to noise ratio, in order for each to have service (voice/data) operating acceptably. In addition, there are noise levels that every receiver has due to the process of amplification and processing of the signal.

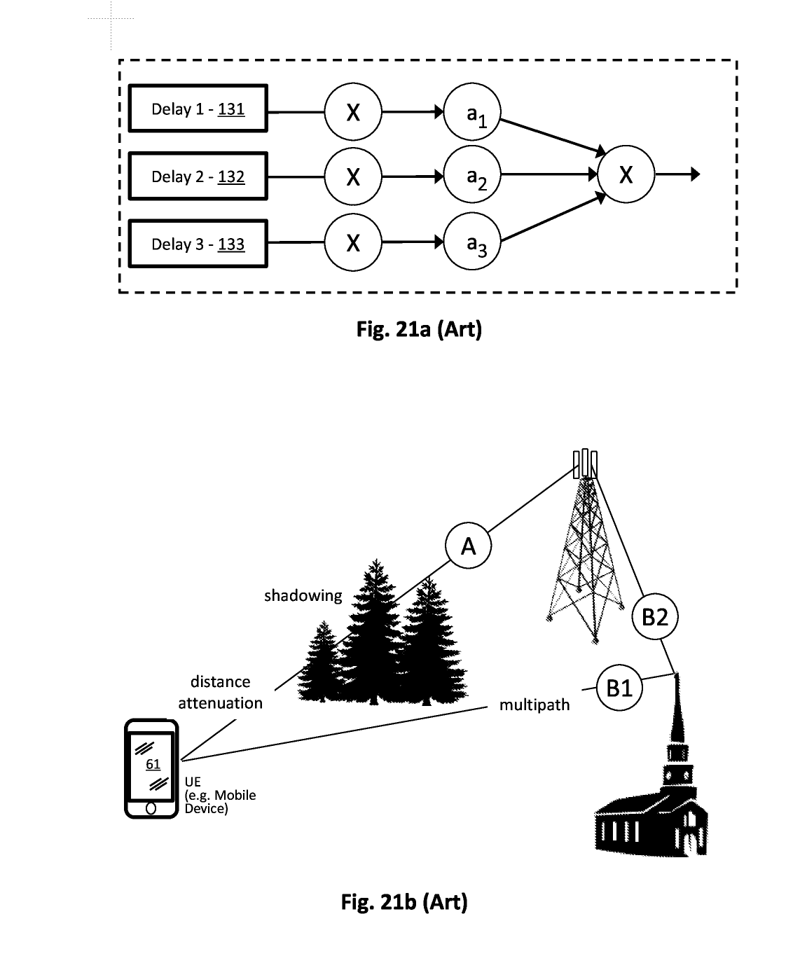

Traditionally in a CDMA system, when the mobile device (e.g. phone) is in a “soft handoff” or a “softer handoff” mode, then there may be connections to several cells simultaneously. Here, the process receives several signals in parallel using a rake receiver. FIG. 21a depicts an example embodiment of a rake receiver. Each signal is processed by a module called a rake finger. A typical design of a rake receiver in a mobile device (e.g. phone) includes three or more rake fingers used in a soft handoff state for processing signals from a plurality of cells and one additional finger used to search for signals from other cells, depicted here with delay 1-131, delay 2-132, and delay 3-133.

In general, the rake receiver is a radio receiver that is designed to counter the effects of multipath fading. FIG. 21b depicts an example of multipaths A and B1/B2. Multipath components are delayed copies of the original transmitted wave traveling through a different path, each with a different magnitude and time-of-arrival at the receiver. Since each component contains the original formation, if the magnitude and time-of-arrival (phase) of each component is computed at the receiver (through a process called channel estimation), then all the components can be added coherently to improve the information reliability. This can result in a higher signal-to-noise ratio (or Eb/No) in a multipath environment. Multipath signals reflected from obstacles and signals from different Node B′s that can be combined using the rake receiver. The rake receiver analyzes the different factors (e.g. attenuation timing) into account along with the receiver fingers to combine multipath signals to one signal.

A set of cells, whose signals are used during a soft handoff, is referred to as an active set. If the search finger locates a sufficiently-strong signal (in terms of high Ec/Io or RSCP) from a new cell this cell is added to the active set. The cells in the neighbor list (called in a CDMA neighboring set) are checked more frequently than the rest and thus a particular handoff with the neighboring cell is more likely, however a particular handoff with others cells outside the neighbor list is also allowed (as may be unavailable with GSM, IS-136/DAMPS, AMPS, NMT, etc.).

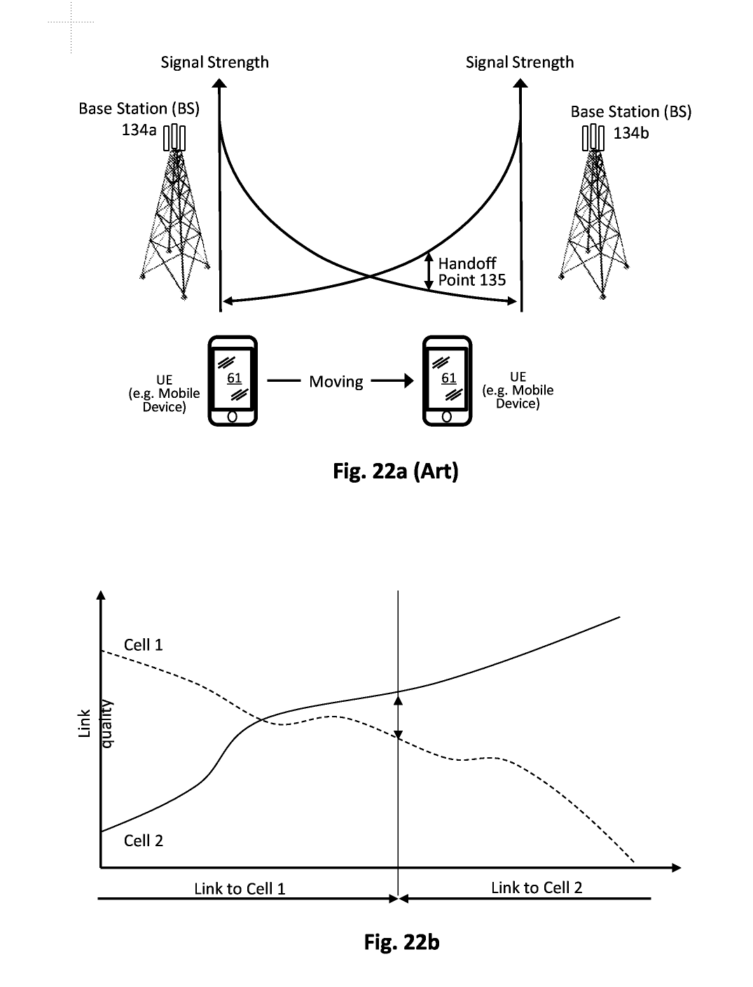

FIG. 22a depicts an example of a hard handoff as the signal strength from one base station (Base Station 134a) becomes relatively weaker and the signal strength from another (Base Station 134b) becomes relatively stronger, prompts a handoff point 135. Hard handoffs are primarily employed in FDMA and TDMA systems (e.g. GSM). Typically, a hard handover is one in which the channel (or connection) in the source cell is released and only then the channel in the target cell is engaged. Thus the connection to the source is broken before or ‘as’ the connection to the target is made—for this reason such handovers are also known as “break-before-make” handover or connection. In general, hard handovers are intended to be instantaneous in order to minimize the disruption to the call. A hard handover is typically perceived by network engineers as an event during the call. It requires the least processing by the mobile network providing service. When a mobile call is between base stations, then the mobile call can switch with any of the base stations, so the base stations bounce the link with the mobile back and forth. This is called ping-ponging (and not be confused with the earlier mentioned “ping-pong” method of the relay method for US ANSI41/WIN protocol messages that utilize a route by DPC-SSN via the relatively simple “ping-pong” TCAP transactions).

Soft Handover (Or Handoff)

There have been some modifications to the handover (or handoff) process where there is a so-called soft handover (or handoff) process and/or a softer handover (or handoff) process. FIG. 22b depicts an example of a soft handoff, where the connections to the first base station and the second base station or the say “two connections” are maintained for a period of time before releasing the connection to the first base station. So basically there is a “one-two-one series of connections” where the two connections are maintained for a particular duration of time during the handover (or handoff) process.

Further, the soft handover typically is one in which the channel in the source cell is retained and used for a while in parallel with the channel in the target cell. In this case the connection to the target is established before the connection to the source is broken, hence this handover is also called a make-before-break. The interval, during which the two connections are used in parallel, may be relatively brief or substantial. For this reason the soft handover is perceived by network engineers as a state of the call, rather than a brief event. Soft handovers may involve using connections to more than two cells: connections to three, four or more cells can be maintained by one phone at the same time. In some cases, when a call is in a state of soft handover, the signal of the best of all used channels can be used for the call at a given moment or all the signals can be combined to produce a clearer copy of the signal. The latter may be more advantageous, and when such combining is performed both in the downlink (forward link) and the uplink (reverse link) the handover is termed as softer.

Softer handovers are possible when the cells involved in the handovers have a single cell site. For example, the cell may contain

Two-Three-Two Series of Connections

Here in the present disclosure, there is an embodiment of a system and an associated computer-implemented method performed by a computer processor for attempting to preferably maintain at least a “two-three-two series (2-3-3) of connections” during a handover (or handoff) process and/or during an on-going mobile usage. For example, during the on-going mobile usage in a particular area and/or with a particular mobile network, and/or say during a particular event, a particular window of time, for a particular fee and/or bid, and/or the like.

Primary/Secondary Connections

In various non-limiting embodiments, the base station subsystem (or similar, e.g. repeaters) of the mobile network (e.g. of a particular mobile network operator) would seek to maintain an at least two connections between an at least two base stations (or similar, e.g. access points) and the mobile device, say during a call/usage (e.g. voice, data, and/or the like). Further, wherein the at least two connections include a designated primary connection and a secondary connection.

In various non-limiting embodiments, the designated primary connection would preferable conduct the on-going mobile usage and the secondary would preferably comprise at least one of the following connections types/roles/functions: a redundant cutover connection, backup connection, duplicate connection, dual-use connection, separate use connection, a data vs voice connection, a voice vs. data connection, a party line connection, a tracking connection, and/or the like. In various non-limiting embodiments, the designated primary connection and a plurality of additional connections would preferably be combined to create a combined connection, per a combination criterion.

In various non-limiting embodiments, the on-going mobile connection involves attempting to preferably maintain the at least two connections with the (designated) primary connection and secondary connection, wherein if the (designated) primary connection is lost, the secondary automatically, systematically, conditionally, and/or manually, becomes the (designated) primary connection, wherein the system automatically, systematically, conditionally, and/or manually seeks a new or replacement secondary connection. Further, wherein if the (designated) primary connection is maintained, but the secondary connection is lost, the system then also automatically, systematically, conditionally, and/or manually seeks for the replacement secondary connection.

In various non-limiting embodiments of this present disclosure, the on-going mobile connection involves attempting to maintain the at least two connections with the (designated) primary connection and secondary connection, wherein if the (designated) primary connection is lost, the secondary automatically, systematically, conditionally, and/or manually, becomes the (designated) primary connection, wherein the system automatically, systematically, conditionally, and/or manually seeks a new or replacement secondary connection. Further, wherein if the (designated) primary connection is maintained, but the secondary connection is lost, the system then also automatically, systematically, conditionally, and/or manually seeks for the replacement secondary connection.

Extra-Soft Handoffs

In various non-limiting embodiments of this present disclosure, the handover (or handoff) process involves attempting to preferably maintain the two connections until one of the two connections meets a first criteria (e.g. a weak signal value/range/threshold) causing the mobile device to automatically, systematically, conditionally, and/or manually search and/or include a tertiary/third connection. Further, wherein the weakest (or say, e.g. a relatively most expensive to the mobile network operator and/or most expensive to the mobile subscriber) of the three connections can be automatically, systematically, conditionally, and/or manually released due to, say a second criteria. In various non-limiting embodiments, the second criteria comprising an at least one of the following: a particular signal value, range, threshold; usage concentration/density; available coverage area/zone; signal-to-noise ratio/value; interference value/level; roaming cost; connection cost; subscriber's plan agreement/criteria/bid; subscriber's per event premium fee/bid/budget; subscriber's usage history, and/or the like.

For example, In various non-limiting embodiments of this present disclosure, the duration of the least two connections and/or the three connections can be based in part on a premium paid by the subscriber in-general, paid per window of time, per location, per device, per family member, per day of the week, and/or the like. In another example, the duration of the least two connections and/or the three connections could be based in part on a winning bid by a particular subscriber within a pool of competing bids and/or subscribers, say for a particular window of time, location, device, family plan member, contracting entity/account, day of the week, and/or the like. In another example, the duration of the least two connections and/or the three connections could be based in part on the costs per connection per window of time and/or status, where there may be connections with a status of say, active, searched, available, considered, bid for, desired, relative-inexpensive, free, wifi, off-network, roaming, and/or the like; and/or associated with one particular mobile network, mobile network operator, and/or a plurality of mobile network operators, and/or the like.

In various non-limiting embodiments, the mobile device can be modified to facilitate and /or allow for a plurality of connections. In various non-limiting embodiments, a first set of instructions and/or a first logic for determining a number of connections, the designated primary connection, the secondary connection, the combining of connections, the handoff, and/or the like, may be based in part upon a second set of instructions and/or a second logic based inside the mobile device itself.

In various non-limiting embodiments, another benefit of the plurality of connections, is there is an ability to share connections and/or switch between different technologies, say share or switch between wifi and bluetooth, or share or switch between (vs. handoff) wifi and GSM and/or CDMA, or share and switch between wifi with a designated landline and/or with GSM, or share and switch between (or handoff) from GSM to UMTS or from CDMA IS-95 to cdma2000 and come back, as assigned in predetermined logic, say automatically (e.g. per signal strength), systematically (e.g. per mobile operator settings), conditionally (e.g. per user fees and/or bids), and/or manually (e.g. per a user via a user-interface on the mobile device).

It should be appreciated by those skilled in the art that there could be additional embodiments of the system and the associated computer-implemented method performed by the computer processor for attempting to maintain other plurality of series of connections, say a “three-three-three series of connections,” a “three-two-three series of connections,” a “three-four-three series of connections,” and/or the like, depending on the circumstances, say during the handover (or handoff) process and/or during the on-going mobile usage. For example, where there is a number of overlapping connections available, and/or someone has paid a premium to maintain a connection and/or to maintain a plurality of connections in, say a particular area and/or with a particular mobile network, and/or say during a particular event, a particular window of time, for a particular fee and/or bid, and/or the like.

U.S. Pat. No. 6,151,512 to Chheda, et al, entitled “Communication system having optimum resource arrangements in a multi-sectored environment and method therefor” is hereby incorporated by reference in its entirety for all purposes, where the abstract states: A configuration of base stations and sectors within cells of a CDMA wireless communication network provide greater call handling capacity. By optimally configuring sectors of a cell controlled by multiple base stations, fewer channel elements are required to implement the desired service and a resultant system has improved signal demodulation, lower power requirements, improved performance, and lower cost for a service provider. The base stations are configured to support “N” sectored cells to ensure that each cell has a maximum amount of capacity for all mobile users therein. This method involves configuring the sectors serviced by a same base station adjacent to one another. By configuring the sectors associated with base stations in this manner, there are fewer instances of soft handoff and more instances of softer handoff. Furthermore, configuring the sectors to be adjacent to one another ensures optimal power collection by each of the sectors during the communication process.

U.S. Pat. No. 7567807 to Dunn, et al, entitled “Apparatus and method for performing handoff with a mobile station having a smart antenna” is hereby incorporated by reference in its entirety for all purposes, where the abstract states: Disclosed is a mobile station configured to perform soft, softer, and soft softer handoffs. The mobile station comprises a smart antenna module and a logic module which are configured to make use of signals that, up to now, have been categorized as noise, interference, or both. Using the heretofore unused signals allows the handset to perform all of its handoffs more efficiently and in conditions that previously would not have allowed a handoff, which prevents dropped calls and/or poor reception.

U.S. Pat. No. 8,909,227 to Kitazoe, et al, entitled “Handover to any cell of a target base station in a wireless communication system” is hereby incorporated by reference in its entirety for all purposes, where the abstract states: Techniques for performing handover of a user equipment (UE) in a cell-to-base station manner are described. The UE may receive a handover command to perform handover from a source base station to a target base station. The source base station may send context information for the UE to the target base station, and the context information may be available to all cells of the target base station. The UE may attempt handover from a serving cell of the source base station to a first cell of the target base station. The UE may attempt handover to a second cell of the target base station if the handover to the first cell fails. The UE may (i) receive the first and second cells from the source base station or (ii) receive only the first cell from the source base station and determine the second cell based on broadcast system information.

U.S. patent application Ser. No. 13/846,148 to Sriram, et al, entitled “Method and apparatus for network neighbor cell list optimization” is hereby incorporated by reference in its entirety for all purposes, where the abstract states: A method for optimizing a cellular network neighbor cell list (NCL) includes collecting performance measurement (PM) data relating to the performance of the cellular network; based on the processed and analyzed PM data, generating a proposal for optimization of the NCL; computing an SIB1-SIB13, or through SIBn message consistent with the optimization proposal; checking the SIB1-SIB13, or through SIBn message to ensure it can be encoded; and assuming the SIB1-SIB13, or through SIBn message cannot be encoded, reverting to the generating step and generating a new proposal for optimization of the NCL, so as to optimize the NCL.

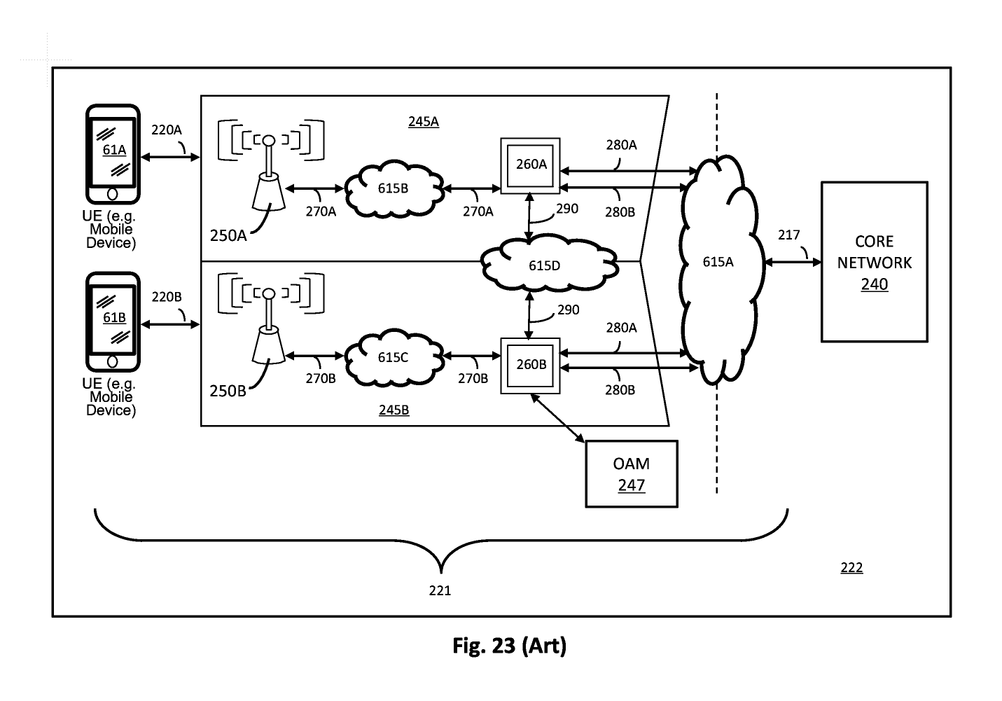

Returning to drawings, FIG. 23 is a schematic block diagram of existing art described in Sriram, et al, of a Universal Mobile Telecommunications System (UMTS) network architecture 222. The network architecture 222 comprises an access network 221 that is operably connected via a first asynchronous transfer mode (ATM) backbone 615A that has a first ATM backbone-core network interface 217 with a core network 240. The first ATM backbone 615A can, for example, be an Internet Protocol (IP) Network 615A. Comprised in access network 221 may be a first UE 61A, a second UE61B, a first Radio Network Subsystem (RNS) 245A, a second RNS 245B, and an Operation and Administration Maintenance (OAM) module 247.

Comprised in first RNS 245A may be a first Base Transmission Station (BTS) 250A or first node B 250A, a first Radio Network Controller (RNC) 260A, and a second ATM backbone 615B. The second ATM backbone 615B can, for example, be an Internet Protocol (IP) Network 615B. The first UE 61A may communicate wirelessly via a first UE-first BTS interface 220A with the first BTS 250A. The first BTS 250A may be operably connected with the first RNC 260A via the second ATM backbone 615B over a first BTS-first RNC interface 270A.

The first RNC 260A may be operably connected with the core network 240 via the first ATM backbone 615A over a first RNC-core network interface 280A. The first RNC-core network interface 280 may be one of a circuit switched interface 280A and a packet-switched interface 280B. The first RNC 260A may also be operably connected via a first RNC-OAM module interface 229A with the OAM module 247.

Comprised in second RNS 245B may be a second BTS 250B, a second RNC260B, and a third ATM backbone 615C. The third ATM backbone 615B can, for example, be an Internet Protocol (IP) Network 615C. The second UE 61B may communicate wirelessly via a second UE-second BTS interface 220B with the second BTS 250B. The second BTS 250B may be operably connected with the second RNC 260B via the third ATM backbone 615B over a second BTS-third ATM backbone interface 270B.

The second RNC 260B may be operably connected with the core network 240 via the first ATM backbone 615A over a second RNC-core network interface 280. The second RNC-core network interface 280 may be one of a circuit switched interface 280A and a packet-switched interface 280B. The second RNC 260B may also be operably connected via a second RNC-OAM module interface 229B with the OAM module 247. The first RNC 260A may be operably connected with the second RNC 260B via the first ATM backbone 615D (or 615A) over a first RNC-second RNC interface 290.

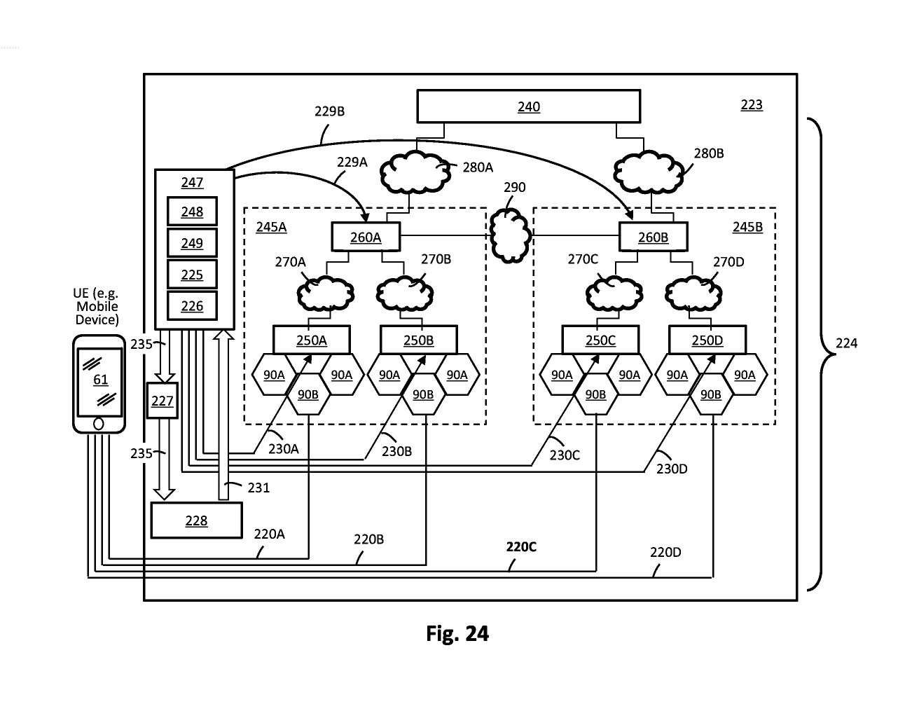

FIG. 24 is a schematic block diagram of an embodiment of a UMTS network architecture 223 for neighbor cell list optimization. In various non-limiting embodiments, the network architecture 223 comprises an access network 224 and the core network 240. The access network 224 comprises the UE 61, the first RNS 245A, the second RNS 245B, and an OAM module 247. The first RNS 245A comprises one or more of a first BTS 250A, a second BTS 250B, and a first RNC 260A. The UE 61 communicates wirelessly via one or more UE-BTS interfaces 220 with one or more of the BTS's 250A-250D. The UE-BTS interface 250A, for example, uses a serving cell 90B, also known as a source cell 90. The serving cell 90B may have neighboring cells, e.g. 90A.

In various non-limiting embodiments, the first BTS 250A operably connects with the first RNC 260A over the first BTS-first RNC interface 270A. Similarly, the second BTS 250B operably connects with the first RNC 260A over the second BTS-first RNC interface 270B. The first RNC 260A operably connects with the core network 240 via the first RNC-core network interface 280A. The first RNC-core network interface 280A may be one of a circuit switched interface 280A or a packet-switched interface 280B. The first RNC 260A may be operably connected with the OAM module 247 via the first RNC-OAM interface 229A. The first and second BTSs 250A and 250B may be respectively operably connected with the OAM module 247 via respective first and second BTS-OAM interfaces 230A and 230B.

In various non-limiting embodiments, the second RNS 245B may comprise one or more of a third BTS 250C, a fourth BTS 250D, and a second RNC 260B. The third BTS 250C may be operably connected with the second RNC 260B over a third BTS-second RNC interface 270C. Similarly, the fourth BTS 250D may be operably connected with the second RNC 260B over a fourth BTS-second RNC interface 270D. The second RNC 260B may be operably connected with the core network 240 via a second RNC-core network interface 280B. The second RNC-core network interface 280B may be one of a circuit switched interface 280B and a packet-switched interface 280B. The second RNC 260B may be operably connected with the OAM module 247 via the second RNC-OAM interface 229B. In various non-limiting embodiments, the third and fourth BTSs 250C and 250D may be respectively operably connected with the OAM module 247 via respective third and fourth BTS-OAM interfaces 230C and 230D.

In various non-limiting embodiments, the first RNC 260A may be operably connected with the second RNC 260B over the first RNC-second RNC interface 290. The OAM module 247 may comprise a Performance Measurement (PM) subsystem 225. The PM subsystem 225 collects from one or more of the first RNC 260A and the second RNC 260B PM data describing the performance of the network. The PM data collected by the PM subsystem 225 may comprise one or more key performance indicators (KPI's).

In various non-limiting embodiments, the KPI's may comprise one or more of an identification of one or more proposed optimizations of Information Elements (IE's) comprised in the NCL, a log of network performance, an initial attachment success rate, a service request rate, a handover success rate, one or more Handover (HO) failure reasons, a circuit switched call origination rate, a circuit switched call termination rate, a packet switched call origination rate, a packet switched call termination rate, an identification of one or more missing neighbors, an identification of one or more new neighbors to be added to the NCL, an identification of one or more excessive neighbor relations, an identification of one or more one-way neighbors, and an identification of one or more current neighbors to be deleted from the NCL, physical location, transmitter output power, primary scrambling code, uplink frequencies, downlink frequencies, parameters defining network configuration, coverage, capacity, and quality of service (QOS).

In various non-limiting embodiments, the OAM module 247 may comprise an SIB integrity Checker subsystem 226. The SIB Integrity Checker subsystem 226 can be configured to check the SIB1-SIB13, or through SIBn message generated by the system in order to determine if the System Information Block 11 (SIB11) message can be encoded. In various non-limiting embodiments, the PM subsystem 225 may be configured to gather PM data from the first RNC 260A over the first RNC-OAM interface 229A. Similarly, the PM subsystem 225 may be configured to gather PM data from the second RNC 260B over the first RNC-OAM interface 229B. PM data may be roughly described as counters that are triggered when a certain type of procedure is executed. Examples of possible procedures include total attempts, successful attempts, trigger cause, and cause of a failure (e.g. of a handover). Using PM data, all the KPI's can be computed at one or more of the network element levels and the network level.

In various non-limiting embodiments, the PM subsystem 225 may also be configured to gather PM data from one or more of the BTSs 250A-250D over respective BTS-OAM interfaces 230A-230D. The PM subsystem 225 may also be configured to process the PM data. The PM subsystem 225 may be operably connected via PM subsystem-optimization server interface 235 to an NCL optimization sever 227. The NCL optimization server may be further configured to identify the types of procedures and activities occurring in one or more of the first RNS 245A and the second RNS 245B. The NCL optimization server 227 may thereby help generate and optimize one or more KPI's for NCL's comprised in one or more of the first RNS 245A and the second RNS 245B. The HO failure causes may comprise one or more of a late HO, an early HO, an HO to the wrong cell, and a ping pong, i.e., an HO in which two cells continually exchange an HO back and forth. A ping pong HO may occur among adjacent cells. A ping pong HO may occur among non-adjacent cells.

In various non-limiting embodiments, the optimization server 227 may analyze the PM data 225. The optimization server 227 may compute one or more KPI's describing one or more of areas where failures are occurring and proposed ways to further optimize the NCL's and thereby to further optimize the network's operation. This computation may occur automatically. This computation may be performed using criteria that are input by an operator prior to operation. Alternatively, this computation may be performed using criteria that are input by an operator during operation. The NCL optimization server 227 may use the computed KPI's to generate an NCL optimization proposal 228. The NCL optimization proposal 228 may comprise proposals regarding one or more of an identification of one or more missing neighbors, an identification of one or more new neighbors to be added to the NCL, an identification of one or more current neighbors to be deleted from the NCL, and an identification of one or more proposed optimizations of Information Elements (IE's) comprised in the NCL.

In various non-limiting embodiments, the NCL optimization server 227 may transmit the NCL optimization proposal 228 via interface 231 to the OAM module 247. Following receipt by the OAM module 247 of the NCL optimization proposal 228, an optimized NCL may be generated by the OAM module 247 and checked by the SIB Integrity Checker 226 to determine if the System Information Block 11 (SIB11) message can be encoded. The SIB1-SIB13, or through SIBn message may comprise one or more Information Elements (IE's) relating to the Cell Information List on which the UE may perform measurements. For example, the SIB11 may comprise one or more of an intra-frequency neighbor cell information list, an inter-frequency neighbor cell information list, and an inter-Radio Access Technology (RAT) neighbor cell information list. If the SIB11 does not pass the check by the SIB Integrity Checker 226, the SIB Integrity Checker sends an appropriate message to the OAM module 247. The OAM module 247 then proceeds to generate an alternative NCL optimization proposal 228 and the process proceeds as outlined above.

If the SIB11 message passes the check by the SIB Integrity Checker 226, it may then be transmitted over the first RNC-OAM module interface 229A to be applied by the first RNC 260A. Alternatively, or additionally, following receipt by the OAM module 247 of the NCL optimization proposal 228, an optimized NCL may be generated by the OAM module 247 and, assuming it passes the integrity check by the SIB Integrity Checker 226, may be transmitted over the second RNC-OAM module interface 229B to be applied by the second RNC 260B.

During the cell setup process, the first RNC 260A may perform ASN.1 encoding of the SIB11 message while enforcing 3GPP rules and limitations, after which it may be sent over the first BTS-first RNC interface 270A to the first BTS. Alternatively, or additionally, the SIB11 message may be sent over the second BTS-first RNC interface 270B to the second BTS. Alternatively, or additionally, during the cell setup process, the second RNC 260B may perform ASN.1 encoding of the SIB11 message while enforcing 3GPP rules and limitations, after which it may be sent over the third BTS-second RNC interface 270C to the third BTS. Alternatively, or additionally, the SIB11 message may be sent over the fourth BTS-second RNC interface 270D to the fourth BTS. A failure to encode the SIB11 message means the cell is unavailable and will result in degradation of the KPI's and of the network's performance

In various non-limiting embodiments, the OAM module 247 may be configured to decode the ASN.1-encoded SIB11 message. The OAM module 247 may be further configured to compute the optimized NCL data. The optimized NCL data may then be compared with NCL data obtained from one or more of the first RNC 260A, the second RNC 260B, and the OAM module 247. This comparison can be used to determine the optimization scheme incorporated into the ASN.1 encoding of the SIB11 message. The OAM module 247 may be further configured to compute the size of at least one of the IE's comprised in the SIB11 message.

According to embodiments of the disclosure, therefore, the size of the SIB11 message can be computed both before and after the proposed optimization, to determine if the SIB11 message can be effectively encoded by one or more of RNC's 260A and 260B. When features such as hierarchical cell structure or hierarchical cell selection (HCS) are activated by a service provider, a reduction may result in the number of neighbor cells 90A that can be encoded by the RNC's 260A and 260B. According to embodiments of the disclosure, cell outage under such situations can be minimized. One or more of the first through fourth BTSs 270A-270D may in turn transmit the optimized NCL to the UE 61 over BTS-UE interface 220.

In various non-limiting embodiments, the UE 61 may communicate wirelessly via one or more UE-BTS interfaces 220 with one or more of the BTS's 250A-250D. The UE may receive an NCL from one or more of the BTS's 250A-250D via one or more UE-BTS interfaces 220. The UE-BTS interface 220A, for example, may use a serving cell 90B, also known as a source cell 220. The serving cell 90B may have neighboring cells 90A. The UE 61 may obtain an optimized NCL from the serving cell 90B. The optimized NCL may indicate one or more of the signal strength of the serving cell 90B and the signal strength of one or more neighbor cells 90A as defined in the NCL.

When it comes to pre-launch optimization of a network, planning tools and drive tests have been traditionally considered sufficient. However, planning tools and drive tests may not maximally optimize a network as conditions evolve over time, as planning tools and drive tests may not promote a network with maximal possible efficiency as conditions evolve over time. Conditions such as adding equipment, equipment failures, equipment not recognized (e.g. neighboring cells), and traffic congestion obviously evolve over time.

Identifying missing neighbors is often an activity that provides significant gains when performing Radio Frequency (RF) optimization. Each cell site has unique configuration data and comprises data that can be optimized, such as, for example, one or more of physical location, transmitter output power, primary scrambling code, uplink frequencies, downlink frequencies, parameters defining network configuration, and neighbor cell list.

Network performance directly impacts handover success rate, coverage and capacity, and quality of service (QoS). Optimally, the NCL may be regularly updated and optimized so as to improve network performance. Accordingly, certain problems that could otherwise occur may be avoided according to embodiments of the disclosure. Wrong or missing neighbor relations that might otherwise contribute to dropped calls may be avoided according to embodiments of the disclosure. Excessive neighbor relations in a cell that might otherwise contribute to an incorrect handover decision may be avoided according to embodiments of the disclosure. One or more of one-way neighbors and incorrect neighbors, which might otherwise contribute to poor network performance, may be avoided according to embodiments of the disclosure.

Also, addition and removal of BTSs requires ongoing reconfiguration and optimization. In a UMTS network, when a new BTS is brought into service, when configuration changes are made to an existing BTS, and/or when a reset is performed on an existing BTS, the affected BTS will perform a BTS setup. As part of this BTS setup procedure, the BTS will request to be audited by a Radio Network Controller (RNC). The BTS provides to the RNC at least one of information about one or more of the cells belonging to the RNC and information regarding local Cell Identifiers (Cell IDs).

In various non-limiting embodiments, for each cell, the RNC may perform a cell setup procedure during which the physical radio channels are configured. During the cell setup procedures, one or more of the common transport channels are set up and configured. Examples of possible transport channels include a Paging Channel (PCH), a Forward Access Channel (FACH), and a Resources Access Channel (RACH). After cell setup has been completed, the BTS may request a System Information Update (SIU). As part of the SIU, several System Information Blocks (SIBs) messages may be transmitted. These SIBs comprise parameters such as, for example, one or more counters for changing Radio Resource Control (RRC) states and a UMTS Registration Area (URA). A Master Information Block (MIB) may comprise information about which of the System Information Blocks (SIBs) are provided in response to receipt of a given Cell ID.

Subsequently, an SIB may be sent by the RNC to a BTS to be broadcast to the UEs. The RNC can also request the BTS to automatically create and update certain BTS-related system information of interest. Often, but not necessarily, the RNC will broadcast to the BTS the BTS-related system information of interest. For example, the RNC may request that the BTS automatically perform one or more of creating and updating information regarding scheduling of system broadcast information comprised in the RNC. As another example, the RNC may request that the BTS automatically perform one or more of creating and updating according to the scheduling parameters system information relating to BTS and comprised in the RNC. The BTS is responsible for broadcasting the received and updated system information relating to BTS.

In various non-limiting embodiments, the System Information Block 11 (SIB11) may comprise one or more Information Elements relating to the Cell Information List on which the UE may perform measurements. For example, the SIB11 may comprise one or more of an intra-frequency neighbor cell information list, an inter-frequency neighbor cell information list, and an inter-Radio Access Technology (RAT) neighbor cell information list. All the cells in the Cell Information List are either in the Active Set or the Monitored Set. The network can also request the UE to report on the detected cell list. The detected cell list comprises cells that the UEs can see but that were not comprised in the Cell Information List. The NCL can be optimized using detected set reporting.

3GPP imposes limitations on a network. First, the 3GPP TS 25.331 standards define the maximum number of neighbor cells monitored by a UE to 96. Comprised in this maximum 96 neighbor cells are 32 intra-frequency cells including the serving cell. Further comprised in the maximum 96 neighbor cells are 32 inter-frequency cells, a number that assumes the presence of the maximum number of additional carriers, that is, two additional carriers. Further comprised in the maximum 96 neighbor cells are 32 Global System for Mobile Communications (GSM) cells. Depending on the UE, these 32 GSM cells may be distributed across a maximum of 32 distinct GSM carriers.

A second set of limitations resulting from 3GPP stems from the fact that UE's read the neighbor cell list from the SIB11 message and optionally from the SIB12 message. According to embodiments of the disclosure, optionally, the SIB12 message can also be configured to carry neighbor cell information. If neighbors are configured using the SIB12 message, then the header of the SIB11 message must contain the information that there is a SIB12 message with data.

In various non-limiting embodiments, a Broadcast Transport Channel (BCH) is used to broadcast SIB messages using a fixed transport block size of 246 bits and a Transmission Time Interval (TTI) of approximately 20 milliseconds. A single transport block may be sent during each TTI. This results in a corresponding bit rate of approximately 12.3 kilobits per second (kbps). The Radio Link Control (RLC) and Medium Access Control (MAC) layers do not add any overhead, allowing the RRC layer to use all the 246 bits. The RRC layer adds its own header, which uses 24 bits and leaves a maximum of 222 bits for each segment of the Abstract Syntax Notation 1 (ASN.1) encoded SIB message. The RRC header is smaller and a maximum of 226 bits can be used when segmentation is not required and a complete SIB can be sent in a single transport block. A maximum of 16 segments can be used to transfer a single ASN.1-encoded SIB and hence the 3GPP standard limits the maximum size of the SIB message to a critical size, for example, to 3,552 bits (or 444 bytes).

However, 3,552 bits is typically not sufficient to transfer full information about 96 neighbor cells. Accordingly, the 3,552-bit critical size limit restricts the number of neighboring cells that can be included in an SIB11 message. The exact number of neighboring cells that can be included in the SIB11 message depends upon the quantity of Information Elements (IEs) associated with a corresponding neighbor. If the number of IEs associated with each neighbor increases, the number of corresponding neighbors that can be included decreases. The attributes of the data comprised in the IE's associated with a corresponding neighbor cell can be categorized as one of MD (Mandatory Default), CV (Conditional Value), and OP (Optional) attributes.

In case the encoding of the SIB11 message exceeds the 3GPP limitation, a warning alarm is sent to the Operations and Maintenance Console (OMC) to inform the user to re-adjust one or more of the number of neighboring cells and the number of IE's associated with our or more neighbor cells.

In order to have the smallest SIB11 message size and in order to accommodate the maximum possible neighbors in the NCL, all used IE's may be optimized. The optimizable parameters may be the IE's whose attributes are either MD or CV. An example of an IE that may be optimized is the UMTS Terrestrial Radio Access Absolute Radio Frequency Channel Number (UARFCN) uplink. If the distance between the uplink and the downlink frequency is the standard duplex distance, then the UARFCN uplink (Nu) may not be encoded. The band may be deduced from the UARFCN (Nd) and the Mobile Country Code. If a frequency does not belong to one of the bands as specified in 3GPP T525.104, the UARFCN cannot typically be optimized.

In various non-limiting embodiments, an example of an IE that may be optimized is frequency information. If two consecutive cells have the same frequency information (Nu, if any, and Nd), then the frequency information IE of the second cell would preferably not be encoded. In order to have the best optimization, the new inter-frequency cells of the inter-frequency cell information list must be sorted. The first key sort is preferably the UARFCN downlink (Nd) IE and the second key sort is preferably the UARFCN uplink IE (Nu), if any. The second key sort is used to optimize the ASN.1-encoded cells with the same value of Nd.

In various non-limiting embodiments, a tradeoff exists between the numbers of neighboring cells populated and the number of IE parameters that deviate from the default values. In various non-limiting embodiments, the optimizing of the IEs included in the SIB11 and extending of the neighboring cells impacts the performance of the RNC and the UE. In various non-limiting embodiments, the RNC may take more time to build the SIB11/SIB12 message, which may in turn have an impact on cell initialization time. Also, the UE may require more time and power to measure and monitor the additional neighbor cells that are received in the SIB11/SIB12.

In various non-limiting embodiments, in case the SIB11 encoding exceeds the 3GPP limitation, a warning alarm is sent to the OMC to inform the user to re-adjust either the number of neighboring cells or the data provisioned for the MD (Mandatory default), CV (Conditional on value), or OP (Optional) attributes of the neighboring cells. It can be relatively easy to debug and resolve during initial deployments.

In case the RNC fails to encode and send the SIB11 message to the BTS during Cell Setup, an alarm is generated and sent to the OMC and the cell is marked as disabled or failed. During new BTS integration, this issue is easy to debug and resolve.

Following cell setup if the RNC fails to encode and send an SIB11 message to the BTS as part of optimization data changes or configuration data changes, when the cell is operational, an alarm is generated and sent to the OMC and the cell is marked to be in the enabled/degraded state. So the cell will continue to broadcast the current SIB11 message and will not use the new optimization data changes or the new configuration data changes. The cell will be marked as disabled or failed, and will have to undergo a cell setup procedure again. These issues are very difficult to debug and require more time and effort than the original optimization exercise. Also, they have a negative impact on the network performance and on KPI's.

In various non-limiting embodiments, the SIB11 messages are encoded in the RNC and a non-optimized NCL adds to the computing overhead on the RNC. Also, if the encoded SIB11 message exceeds a critical size after ASN.1 encoding is performed, it will not be sent to the BTS. For example, the critical size may be 3,552 bits. This may result in no neighbor cells being available for the UE to monitor, in turn potentially resulting in dropped calls. Also, if the BTS does not have a good SIB11 message to decode, the cell will not initialize properly. The RNC will generate one or more alarms if the SIB11 message encoding fails. Recovering the cell may require experts to identify the root cause of the problem and to fix the problem by a trial and error process of removing cells from the NCL. This process may be time-consuming and may lead to customer disapproval.

With the rapid increase in data traffic and smart phones, optimization of network performance becomes ever more critical. However, changes to promote optimization may, despite extensive advance planning, lead to degradation of KPI's below the levels experienced prior to the changes. Additionally, such changes may lead to failures of cells to properly initialize. Detailed investigation may be needed to determine the root causes of the difficulties, which could, for example, be attributable to a failure to properly encode the SIB11 messages.

Even if the number of neighbors is not changed, its parameters are modified from the default values as part of the optimization process, the number of bits used by the each neighbor cell may increase. This could potentially result in the size of the ASN.1-encoded SIB11 message exceeding the 3,552 bit critical size limit, in turn resulting in a failure to encode the SIB11 message.

According to embodiments of the disclosure, an integrity check is performed to compute the size of the SIB11 message and to ensure that its size is less than or equal to a critical size prior to performing an optimization data change or a configuration data change on the IE of a neighboring cell. For example, the critical size may be 3,552 bits.

According to embodiments of the disclosure, the size of the current SIB11 message can be computed using an SIB11 message received from a BTS and using a snapshot of RNC data from the OMC. Accordingly, the ASN.1-encoded SIB11 message can be decoded and a proposed optimization rule can be generated to compute the bits used per IE. According to embodiments of the disclosure, the size of the SIB11 message can then be computed both before and after the proposed optimization changes. According to embodiments of the disclosure, a determination can be made whether the size of the SIB11 message will impact the operational state of the BTS or the cell. According to embodiments of the disclosure, if it is determined that the SIB11 message is successfully encoded, the proposed optimization changes can be propagated. If it is determined that the SIB11 message is not successfully encoded, the proposed optimization changes can be iteratively reworked without impacting the operational network.

First, according to embodiments of the disclosure, the neighbor cells are identified. Next, according to embodiments of the disclosure, the functional neighbor cells are identified by measuring the Soft handover (SHO) KPI for each cell and its neighbors. According to embodiments of the disclosure, after ranking all the neighbor cells by their respective SHO KPI's, an NCL is computed for each cell.

According to embodiments of the disclosure, the ASN.1-encoded SIB11 message is computed for each cell, using the snapshot data from the RNC and with the new parameter changes proposed to the NCL as part of the optimization proposal. If the SIB11 message can be successfully encoded in under a critical size limit, for example, in under 3,552 bits, the NCL optimization proceeds using the optimization proposal. On the other hand, if the encoding of the SIB11 message fails, the functional NCL is iterated to remove neighbor cells until the SIB 11 message can be successfully encoded.

Alternatively, or additionally, parameter changes are made in the optimization proposal to ensure that the SIB11 message can be successfully encoded. The computation, according to embodiments of the disclosure, of the ASN.1-encoded SIB11 message size, can take place offline in the OMC. Advantageously, according to embodiments of the disclosure, network operation issues due to optimization changes are thereby eliminated. According to embodiments of the disclosure, the ASN.1 encoding of the SIB11 message on the OMC should be computed using the same optimization algorithm that is used on the RNC to ensure that the correct ASN-1 encoded message is sent to the BTS. Embodiments of the disclosure may help smooth the process of NCL optimization. Embodiments of the disclosure may be applied to other messages that have multiple restrictions in terms of size and number of elements.

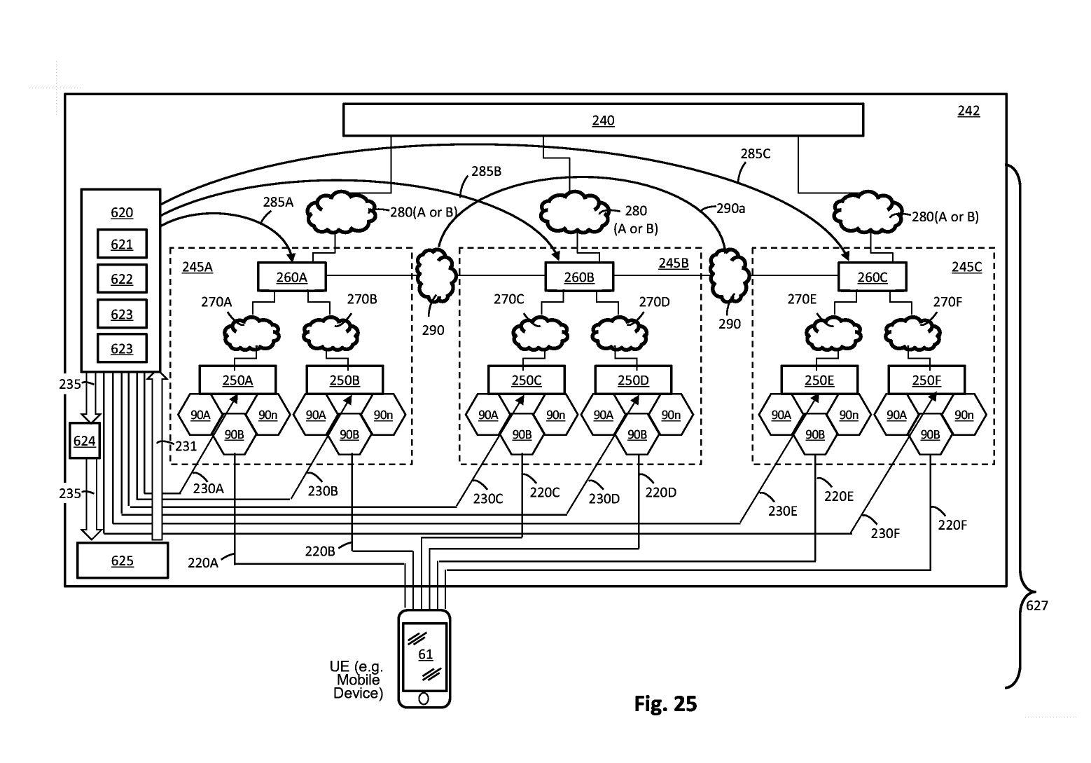

FIG. 25 is another embodiment of a schematic block diagram of a UMTS network architecture 242 for neighbor cell list optimization according to various non-limiting embodiments of the disclosure. The network architecture 242 may comprise an access network 627 and the core network 240. The access network 627 in turn may comprise the UE 61, the first RNS 245A, the second RNS 245B, and an OAM module 620. The first RNS 245A may comprise one or more of a first BTS 250A, a second BTS 250B, and a first RNC 260A.

In various non-limiting embodiments, the UE 61 may communicate wirelessly via one or more UE-BTS interfaces 220 with one or more of the BTS's 250A-250F. The UE-BTS interface 250A, for example, may use a serving cell 90B, also known as a source cell 220. The serving cell 90B may have neighboring cells 90A-90n (where n may be any, all, or relatively unlimited). Each of these interfaces may be a serving/source cell or primary/master cell, secondary/slave cell, and/or a tertiary cell. Further, each of these interfaces may be a source cell simultaneously, where for example, cell 90B is a serving/source cell for first voice channel, say on a first channel, while on a different channel of cell 90B and/or the cell 90A is a serving/source cell for another, second voice channel, say on a second channel, and while on another channel of cell 90B or 90A or on the cell 90n is a serving/source cell for another channel, say data on a third channel. In addition, a particular channel on cell 90A could be an active serving/source cell for a first UE 61 for a particular function, say for data, while also being a secondary/slave cell for voice. Here, for example, the UE 61 may have a criteria setup where voice quality is ranks superior to data throughput at a given moment and/or window of time, where cell 90B is acting as the serving/source cell, cell 90A is acting as the serving/source cell for data, but is also the secondary/slave cell should it be need for improving voice quality. For example, where a criteria measures the quality of a voice conversation upon each cell and handover the call when a particular threshold is met. Here, the serving/source cell, 90B can switch functions and become the secondary/slave cell for data.

Returning to FIG. 25, the first BTS 250A may be operably connected with the first RNC 260A over the first BTS-first RNC interface 270A. Similarly, the second BTS 250B may be operably connected with the first RNC 260A over the second BTS-first RNC interface 270B. The first RNC 260A may be operably connected with the core network 240 via the first RNC-core network interface 280 (e.g. 280A or 280B). The first RNC-core network interface 280 may be one of a circuit switched interface 280A and a packet-switched interface 280B. The first RNC 260A may be operably connected with the OAM module 620 via the first RNC-OAM interface 285A. The first and second BTSs 250A and 250B may be respectively operably connected with the OAM module 620 via respective first and second BTS-OAM interfaces 230A and 230B.

In various non-limiting embodiments, the second RNS 245B may comprise one or more of a third BTS 250C, a fourth BTS 250D, and a second RNC 260B. The third BTS 250C may be operably connected with the second RNC 260B over a third BTS-second RNC interface 270C. Similarly, the fourth BTS 250D may be operably connected with the second RNC 260B over a fourth BTS-second RNC interface 270D. The second RNC 260B may be operably connected with the core network 240 via a second RNC-core network interface 280 (e.g. 280A or 280B). The second RNC-core network interface 280 may be one of a circuit switched interface 280A and a packet-switched interface 280B. The second RNC 260B may be operably connected with the OAM module 620 via the second RNC-OAM interface 285B. The third and fourth BTSs 250C and 250D may be respectively operably connected with the OAM 620 via respective third and fourth BTS-OAM interfaces 230C and 230D.

In various non-limiting embodiments, the first RNC 260A may be operably connected with the second RNC 260B over the first RNC-second RNC interface 290, the second RNC 260B may be operably connected with the third RNC 260C over the second RNC-third RNC interface 290, The first RNC 260A may be operably connected with the first third 260C over the first RNC-third RNC interface 290a.

In various non-limiting embodiments, the OAM module 620 may comprise a Performance Measurement (PM) subsystem 621. The PM subsystem 622 collects from one or more of the first RNC 260A, the second RNC 260B, and the third RNC 260C PM data describing the performance of the network. The PM data collected by the PM subsystem 621 may comprise one or more key statistics, criteria, and/or performance indicators (KPI's).

In various non-limiting embodiments, the OAM module 620 may comprise a UE Analyzer (UEA) subsystem 622. The first RNC 260A, the second RNC 260B, and the third RNC 260C may also collect, retrieve, analyze, anticipate, project, and/or the like, other data besides the cell PM data For example, UE data describing relatively current, realtime, and historical events, statistics, locations, and behavioral data, patterns, and/or related data for traffic/congestion, the specific UE, UE subscriber plan, payment history, shopping history, consumption rate, bit rates, UE device(s), location(s), patterns, and/or the like. In addition, similar data, statistics, patterns, and/or behaviors for relatively similar UE devices, usage patterns, current, realtime, and historical events, statistics, locations, and behavioral data, patterns, and/or related data for traffic/congestion, for similar UE or segment, similar or segment of UE subscriber plans, payment history, shopping history, consumption rate, bit rates, UE device(s) owned/used, location(s), patterns, and/or the like. The location data can be collected, measured, analyzed, anticipated, and/or projected from GPS data, triangulation, relative signal strength (e.g. relative to an access point and/or relative to other UE, and/or relative to time due travel), and/or the like. The UE data collected by the UEA subsystem 622 is not limited to a particular or specific UE, or similar UE, and the UE data may comprise one or more key statistics, criteria, and/or performance indicators (KPI's).

In various non-limiting embodiments, the PM, UE/UEA, and/or KPI data, statistics, proposal, projects, and/or criteria may comprise one or more of an identification of one or more proposed optimizations of Information Elements (IE's) comprised in the NCL, a log of network performance, an initial attachment success rate, a service request rate, a handover success rate, one or more HO failure reasons, a circuit switched call origination rate, a circuit switched call termination rate, a packet switched call origination rate, a packet switched call termination rate, an identification of one or more missing neighbors, an identification of one or more new neighbors to be added to the NCL, an identification of one or more excessive neighbor relations, an identification of one or more one-way neighbors, and an identification of one or more current neighbors to be deleted from the NCL, physical location, transmitter output power, primary scrambling code, uplink frequencies, downlink frequencies, parameters defining network configuration, coverage, capacity, and quality of service (QoS).

In various non-limiting embodiments, the UEA 622 may also generate a list of dynamic and intelligent criteria (e.g. a first, second, third, fourth, fifth, sixth, and so on, criteria) along with what, how, where, why, and when to either automatically, systematically, (via an artificial intelligence subsystem not depicted), conditionally, and/or along with any system-selections/inputs, carrier-selections/inputs, and/or user-selective conditions/inputs, either in advance, relatively recently, relatively realtime, and/or realtime. The list of UEA generated dynamic and intelligent criteria may also be prioritized per a particular event, condition, location, user, plan, time of day, series of events, threshold, and/or the like. Further, the criteria within a particular criteria may be conditional and/or prioritized per a particular event, condition, location, user, plan, time of day, series of events, threshold, and/or the like.

In various non-limiting embodiments, the OAM module 620 may comprise an SIB analyzer subsystem 623. The SIB analyzer subsystem 623 may be configured to check each SIB message (e.g. SIB1 through SIB to “n”) generated by the system in order to determine if the System Information Block (SIB) message has integrity and can be encoded, transmitted, received, and/or utilized. Further, if there are any alternative distribution methods for effective communicating the proposal, updates, criteria, and/or the like, e.g. the updated or new optimization plan, NCL, criteria, conditions, location, requests, and/or the like.

In various non-limiting embodiments, the PM subsystem 621, UEA 622 subsystem, and/or SIB analyzer 623 subsystem may be configured to gather, project, and/or analyze data, statistics, criteria, conditions, and/or the like, from the first RNC 260A over the first RNC-OAM interface 285A. Similarly, the PM subsystem 621, UEA 622 subsystem, and/or SIB analyzer 623 may be configured to gather, project, and/or analyze data, statistics, criteria, conditions, and/or the like, from the second RNC 260B over the second RNC-OAM interface 285B. Similarly, the PM subsystem 621, UEA 622 subsystem, and/or SIB analyzer 623 may be configured to gather, project, and/or analyze data, statistics, criteria, conditions, and/or the like, from the third RNC 260C over the second RNC-OAM interface 285C.

In various non-limiting embodiments, the PM subsystem 621, UEA 622 subsystem, and/or SIB analyzer 623 subsystem may be configured to gather, project, and/or analyze data, statistics, criteria, conditions, and/or the like, from the BTSs 250A-250F over respective BTS-OAM interfaces 230A-230F.

In various non-limiting embodiments, the PM subsystem 621, UEA 622 subsystem, and/or SIB analyzer 623 subsystem may also be configured to process the PM data The PM subsystem 621, UEA 622 subsystem, and/or SIB analyzer 623 subsystem may be operably connected via subsystem-optimization server interface 235 to an NCL optimization sever 624. The NCL optimization server may be further configured to identify the types of procedures and activities occurring in one or more of the first RNS 245A, the second RNS 245B, and/or the third RNS 245C. Further, there could far more RNS's connected and/or utilized.

In various non-limiting embodiments, the NCL optimization server 624 may thereby help generate and optimize one or more KPI's for NCL's comprised in one or more of the first RNS 245A, the second RNS 245B, the third RNS 245C, and/or so on. In addition, to the aforementioned HO failure causes that comprise one or more of a late HO, an early HO, an HO to the wrong cell, and a ping pong, i.e., an HO in which two cells continually exchange an HO back and forth, there can also be an HO failure in terms of properly assigning the primary/serving cell versus the secondary/slave cell, and/or the tertiary cell. Further, there could be a failure in maintaining a dual primary source/serving cell or dual channels for a particular purpose, say one for voice and one for data.

In addition, an issue could occur where the ping pong HO may occur among adjacent cells for an exchange between primary/sourcing/serving/master cell for voice and the primary/sourcing/serving/master cell for data. Where a ping pong HO may occur back and forth that falls outside an acceptable threshold, condition, and/or criteria. For example, a condition could be implemented when following a handover between a first primary/sourcing channel of a particular cell (say for voice) and another second primary/sourcing channel (say for data) of the same or another particular cell, where there a condition may be implemented, say a timer may be initiated for a period of time, to prevent a switch back handover, say unless a particular threshold of QoS and/or Signal Strength is exceeded, say significantly beyond the initial threshold value that triggered/initiated the handover.

In various non-limiting embodiments, the optimization server 624 may analyze the collected data to anticipate future locations of a particular UE, potential future HO failures and proposed ways to further optimize the NCL's and thereby to further optimize the network's operation. This computation may occur automatically, systematically (via an artificial intelligence subsystem not depicted), conditionally, and/or along with system-selective, carrier-selections, and/or user-selective conditions, either in advance, relatively recently, relatively realtime, and/or realtime. These computations and inputs may be performed using criteria that are input by an operator prior to operation, selective conditions, either in advance, relatively recently, relatively realtime, and/or realtime, and/or by the user, say by upgrading a plan in near realtime, conditionally, or in realtime, say as prompted on the screen.

In various non-limiting embodiments, the list of generated and prioritized criteria may be performed using existing criteria that are input by an operator, similar conditions, similar events, similar UE, similar location, similar series of events, similar behaviors, similar time of day, similar HO conditions/failures, similar traffic congestion, data volume, voice traffic volume per a channel, cell, BTS, MSC, and/or the like. The NCL optimization server 624 may use the computed collected data and/or KPI's to generate an iterative NCL optimization proposal 625 with a unique ID, criteria list, and/or prioritize each. The NCL optimization proposal 625 with its unique ID may comprise a proposal regarding one or more of an identification of one or more missing neighbors, an identification of one or more new neighbors to be added to the NCL, an identification of one or more current neighbors to be deleted from the NCL, and an identification of one or more proposed optimizations of Information Elements (IE's) comprised in the NCL, and/or relevant to particular location, moment in time, event, condition, UE, segment of UE, segment of UE plans, a carrier, and/or the like, and/or some combination, collection, and/or permutation of these. The NCL optimization server 624 may transmit the NCL optimization proposal 625, statistics, projects, criteria, and/or the like via interface 231 to the OAM module 620.

Following receipt by the OAM module 620, an optimized NCL and the like, may be generated by the OAM module 620 and checked by the SIB Analyzer 623 to determine if each of the System Information Blocks (SIB1 through SIBn) messages can be encoded. Each SIB message may comprise one or more Information Elements (IE's) relevant and relating to the Cell Information List on which the UE may perform measurements. For example, a particular SIB1-SIB13, or through SIBn message may comprise one or more of an intra-frequency neighbor cell information list, an inter-frequency neighbor cell information list, and an inter-Radio Access Technology (RAT) neighbor cell information list. If the particular SIB 1-SIB 13, or through SIBn message does not pass the check by the SIB Analyzer 623, the SIB Analyzer may send an appropriate message to the OAM module 620, and/or generate an alternative NCL optimization proposal 625, criteria, condition, event, handover, and/or the like, and/or proceeds as outlined above.

In various non-limiting embodiments, if the SIB 1-SIB 13, or through SIBn message passes the check by the SIB Analyzer 623, it may then be automatically, systematically, conditionally, and/or selectively (e.g. by the carrier, UE, user, user plan, and/or the like) transmitted over the first RNC-OAM module interface 285A to be applied by the first RNC 260A. Alternatively, or additionally, following receipt by the OAM module 620 of the NCL optimization proposal 625, an optimized NCL may be generated by the OAM module 620 and, assuming it passes the integrity check by the SIB Analyzer 623, it may be it may then be automatically, systematically, conditionally, and/or selectively (e.g. by the carrier, UE, user, user plan, and/or the like) transmitted over the second RNC-OAM module interface 285B to be applied by the second RNC 260B. Alternatively, or additionally, following receipt by the OAM module 620 of the NCL optimization proposal 625, an optimized NCL may be generated by the OAM module 620 and, assuming it passes the integrity check by the SIB Analyzer 623, it may be it may then be automatically, systematically, conditionally, and/or selectively (e.g. by the carrier, UE, user, user plan, and/or the like) transmitted over the third RNC-OAM module interface 285C to be applied by the second RNC 260C.

During the cell setup process, the first RNC 260A may perform ASN.1 encoding of each SIB message while enforcing 3GPP rules and limitations, after which it may be sent over the first BTS-first RNC interface 270A to the first BTS. Alternatively, or additionally, each SIB message may be sent over the second BTS-first RNC interface 270B to the second BTS. Alternatively, or additionally, during the cell setup process, the second RNC 260B may perform ASN.1 encoding of each SIB message while enforcing 3GPP rules and limitations, after which it may be sent over the third BTS-second RNC interface 270C to the third BTS. Alternatively, or additionally, each SIB message may be sent over the fourth BTS-second RNC interface 270D to the fourth BTS. A failure to encode a particular SIB message may mean that a particular cell is unavailable and may result in degradation of some KPI's and of the network's performance, where additional alerts may be generated. In addition, historical data can be collected to determine similar events, similar series of events that lead up to the particular failure, and historical data regarding relatively successful workarounds relative to a similar, say UE, UE plan, segment of UEs, similar moment in time, overall traffic volume, voice usage volume, data usage volume, handover failure, and/or the like. For example, where a series of historical resolutions for similar events can be prioritized and iteratively tried and/or tested per a threshold for measure relative successfulness for each particular workaround.

In various non-limiting embodiments, the OAM module 620 is preferably configured to decode the ASN.1-encoded necessary SIB message. The OAM module 620 is preferably further configured to compute the optimized NCL data. The optimized NCL data may then be compared with NCL data obtained from one or more of the first RNC 260A, the second RNC 260B, the third RNC 260C, and the OAM module 620. This comparison can preferably be used to determine the optimization scheme incorporated into the ASN.1 encoding of each SIB message. The OAM module 620 is further configured to compute the size of at least one of the IE's comprised in each of the SIB messages. According to embodiments of the disclosure, therefore, the size of each SIB message can preferably be computed both before and after the proposed optimization, to determine if each SIB message can be effectively encoded by one or more of RNC's 260A, 260B, 260C, and so on.

When features such as hierarchical cell structure or hierarchical cell selection (HCS) are activated by a service provider/mobile network operator/carrier, a reduction may result in the number of neighbor cells 90A-90n that can be encoded by the RNC's 260A, 260B, 260C, and so on.

One or more of the first through sixth BTSs 270A-270F may in turn transmit the optimized NCL to the UE 61 over BTS-UE interface 220. The UE 61 may communicate wirelessly via one or more UE-BTS interfaces 220 with one or more of the BTS's 250A-250F. The UE may receive an NCL from one or more of the BTS's 250A-250F via one or more UE-BTS interfaces 220. The UE-BTS interface 220A, for example, may use a serving cell 90B, also known as a source cell 220/ The serving cell 90B may have neighboring cells 90A. The UE 61 may obtain an optimized NCL from the serving cell 90B. The optimized NCL may indicate one or more of the signal strength of the serving cell 90B and the signal strength of one or more neighbor cells 90A as defined in the NCL.

In various non-limiting embodiments, a serving cell and a source cell are interchangeable. In various non-limiting embodiments, a serving cell and a primary cell are interchangeable. In various non-limiting embodiments, a sourcing cell and primary cell are interchangeable. In various non-limiting embodiments, a sourcing cell, primary cell, and/or active cell are interchangeable. In various non-limiting embodiments, a master cell and primary cell are interchangeable. In various non-limiting embodiments, a sourcing cell, serving cell, primary cell, first cell, active cell, and/or master cell are interchangeable.

In various non-limiting embodiments, a secondary cell and a slave cell are interchangeable. In various non-limiting embodiments, a non-serving cell and a slave cell are interchangeable. In various non-limiting embodiments, a non-sourcing cell and a slave cell are interchangeable. In various non-limiting embodiments, a secondary cell, slave cell and/or passive cell, are interchangeable. In various non-limiting embodiments, a non-sourcing cell and a target cell are interchangeable. In various non-limiting embodiments, a secondary cell, second cell, slave cell, non-serving cell, target cell, passive cell, and/or non-sourcing cell are interchangeable.

In various non-limiting embodiments, a cell channel and a cell frequency are interchangeable. In various non-limiting embodiments, a cell channel and a channel are interchangeable. In various non-limiting embodiments, a cell and channel are interchangeable. In various non-limiting embodiments, a channel and access point are interchangeable. In various non-limiting embodiments, a cell, channel, frequency, cell frequency, access point, and/or a cell channel are interchangeable.

In various non-limiting embodiments, a node B and a base station are interchangeable. In various non-limiting embodiments, a node B and a cell are interchangeable. In various non-limiting embodiments, a cell and base station are interchangeable. In various non-limiting embodiments, a node B, base station, and/or cell are interchangeable.

In various non-limiting embodiments, a mobile terminal and a UE are interchangeable. In various non-limiting embodiments, a device and a client are interchangeable. In various non-limiting embodiments, a UE and client interchangeable. In various non-limiting embodiments, a UE and device are interchangeable. In various non-limiting embodiments, a mobile terminal, mobile device, device, client, computer, handset, phone, UE terminal, UE device, and/or UE are interchangeable.

According to embodiments of the disclosure, the ASN.1-encoded SIB1-SIB13, or through SIBn message is computed for each cell, using the snapshot data from the RNC and with the new parameter changes proposed to the NCL as part of the optimization proposal. If a given SIB message can be successfully encoded in under a critical size limit/threshold, for example, in under 3,552 bits for a SIB1-SIB13, or through SIBn message, the NCL optimization proceeds using the optimization proposal. On the other hand, if the encoding of the give SIB message fails, the functional NCL can be setup to conditionally and/or iteratively remove particular neighbor cells until the given SIB message (e.g. a given SIB1-SIBn message or the like) can be successfully encoded.

Alternatively, or additionally, parameter changes are made in the optimization proposal to preferably ensure that each SIB message can preferably be successfully encoded. The computation, according to embodiments of the disclosure, of the ASN.1-encoded of a give SIB message size, can take place offline in the OMC. Advantageously, according to embodiments of the disclosure, network operation issues due to optimization changes are thereby preferably eliminated or conditionally addressed, and/or tested via historical relatively successful solutions per similar conditions, and/or events. According to embodiments of the disclosure, the ASN.1 encoding of a given SIB message on the OMC would preferably tracked and computed using the same optimization algorithm that is used on the RNC to preferably ensure that the correct ASN-1 encoded message is sent to the BTS. Embodiments of the disclosure would preferably help test and discover relatively successful workarounds for behaviors, patterns, anomalies, and/or the like. Embodiments of the disclosure may be applied to other messages that have multiple restrictions in terms of size and number of elements.

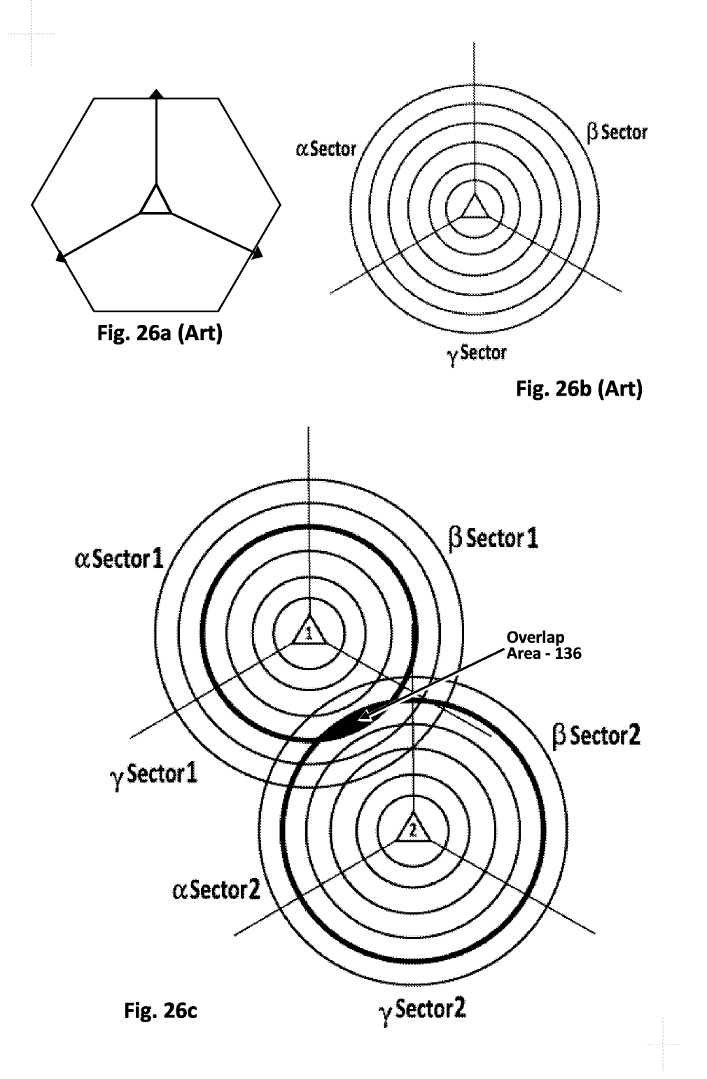

FIG. 26a depicts an illustrative diagram of existing art of a base station having three sectors. Some base stations or cells have a single transmitter radiating its signal out with an Omni relatively circular pattern. However, more and more, especially in crowded area, each base station or cell is split into sections where more than one transmitter/transceiver is employed, where each transmitter then emits a directional pattern, typically out from the center of the cell. Here, each sector of the three sectors in FIG. 26a has a base station transmitter emitting from the center out. For illustrative purposes, each base station sector includes directional antennas that typically transmit and receive in a beam width of 120° or more. The boundaries of the base station are identified by the hexagon and the dividing lines with arrowheads. FIG. 26b also depicts an illustrative diagram of existing art of the same or similar base station having three sectors and again each sector has a base station transmitter. The base station or “cell” provides a region of radio coverage and the illustrative base station here is a series of concentric circles and is divided into three sectors: alpha (α), beta (β) and gamma (γ). For illustrative purposes, each base station sector includes directional antennas that typically transmit and receive in a beam width of 120° or more. The boundaries of the base station are identified by dividing lines emanating out from the center triangle. The circles are used to show a more typical radiation pattern because cells do not have straight boundaries (as with hexagons) and are more rounded.

FIG. 26c depicts an illustrative diagram of two overlapping base station each having three sectors and again each sector has a base station transmitter. There can be a plurality of base station types, a variety of transmitter patterns employed. For simplicity, only two overlapping base stations are shown in FIG. 26c. A base station (BS or sometimes referred as a BSS) may be a fixed station used for communicating with the UEs (user equipment, e.g. a mobile device, terminal, client/computer) and may also be referred to as a Node B, an access point, eNB (for an evolved Node B), etc. Each Node B provides communication coverage for a particular geographic area. To improve system capacity, a node B's coverage area may be partitioned into multiple smaller areas, e.g., three smaller areas, again, Alpha Sector, Beta Sector, and a Gamma Sector. Each smaller area may be served by a respective Node B or eNB subsystem. In 3GPP, the term “cell” can refer to the smallest coverage area of an eNB and/or an eNB subsystem serving this coverage area. In other systems, the term “sector” can refer to the smallest coverage area and/or the subsystem serving this coverage area. For clarity, 3GPP concept of cell is generally used herein. An Overlap Area 136 depicts an area where a handover may be conditionally triggered to occur as the UE/device employing the base station 1 in the Gamma Sector 1 begins to enter the alpha Sector 2 on Base Station 2. Here, the condition to trigger the handover is typically caused by a signal strength criteria, condition, or threshold event, where the signal strength from the sourcing transmitter has dropped before a particular threshold. For example, as was depicted in FIGS. 22a and 22b.

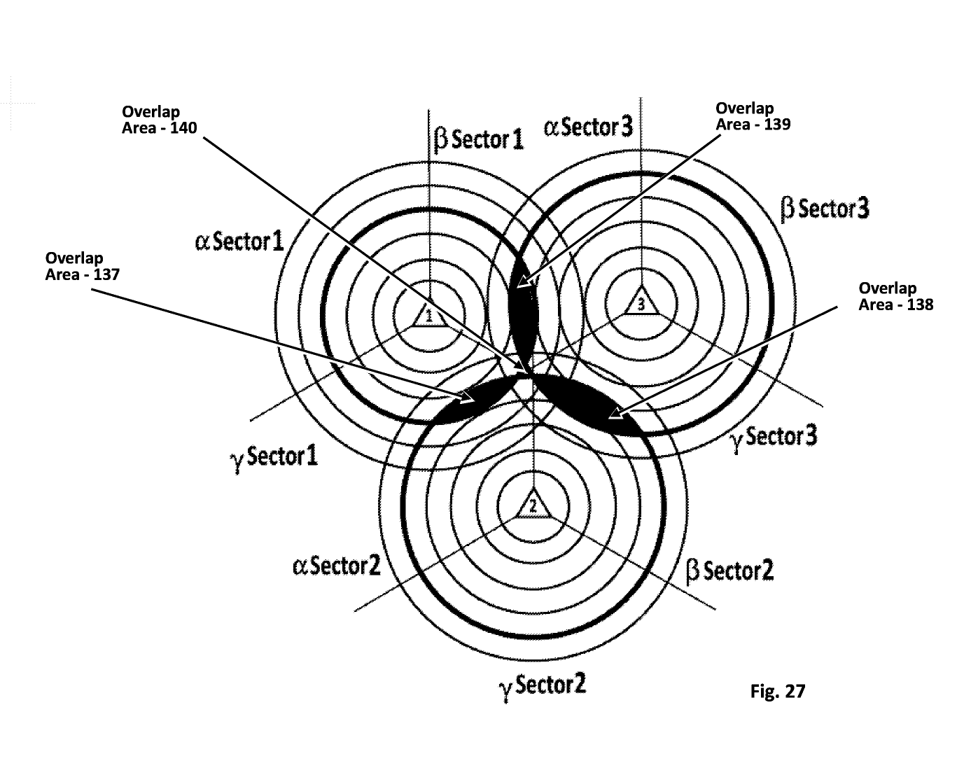

FIG. 27 depicts an illustrative diagram of three overlapping base station and again each having three sectors or partitions for the Alpha Sector, Beta Sector, and a Gamma Sector. An Overlap Area 137 depicts an area where a handover may be conditionally triggered to occur as the UE/device employing the base station 1 in the Gamma Sector 1 begins to enter the alpha Sector 2 on Base Station 2 or vice versa, that is to say, the UE/device is instead employing the alpha Sector 2 on Base Station 2 and is entering the Gamma Sector 1 on base station 1. An Overlap Area 138 depicts an area where a handover may be conditionally triggered to occur as the UE/device employing the base station 2 in the Beta Sector 2 begins to enter the Gamma Sector 3 on Base Station 3 or vice versa; and whereas an Overlap Area 139 depicts an area where a handover may be conditionally triggered to occur as the UE/device employing the base station 3 in the Alpha Sector 3 begins to enter the Beta Sector 1 on Base Station 1, or vice versa.

An Overlap Area 140 depicts an area where several sectors overlap, that is the Alpha Sector 2, Gamma Sector 1, and Gamma Sector 3, where the conditions to produce and/or a trigger a handover may be more complex and trigger what are called ping-pong effects. That is the UE get a handover triggered from a first cell transmitter to a second cell transmitter, only for the handover to occur in the reverse moments later. This becomes a bigger issue, if each handover triggers an event, say a charge for roaming In various non-limiting embodiments of this disclosure, the system would preferably reduce, minimize, or even eliminate such ping pong events by creating a list of criteria, where a first criteria would trigger a handover, but in addition, trigger a new second criteria for the subsequent handover. Here, the criteria for a handover may be temporarily delay, made relatively more stringent, and/or the like.

In various non-limiting embodiments of this disclosure, the system would preferably generate a historically lists of events regarding relative success and/or failed of handovers, ping-pong handovers, and/or the like, with associated statistics, data, events, UE, carriers, equipment, weather, temperature, congestion, throughput, overall traffic, voice traffic, data traffic, location of each UE, and/or the like, relative to a series of events leading to the failure, ping-pong, and/or the like. Relative success could be measured/evaluated and/or tracked relative to a number of completed handovers versus failed handovers, customer complaints, customer churn, test-handovers for data collection and statistics, and/or the like.

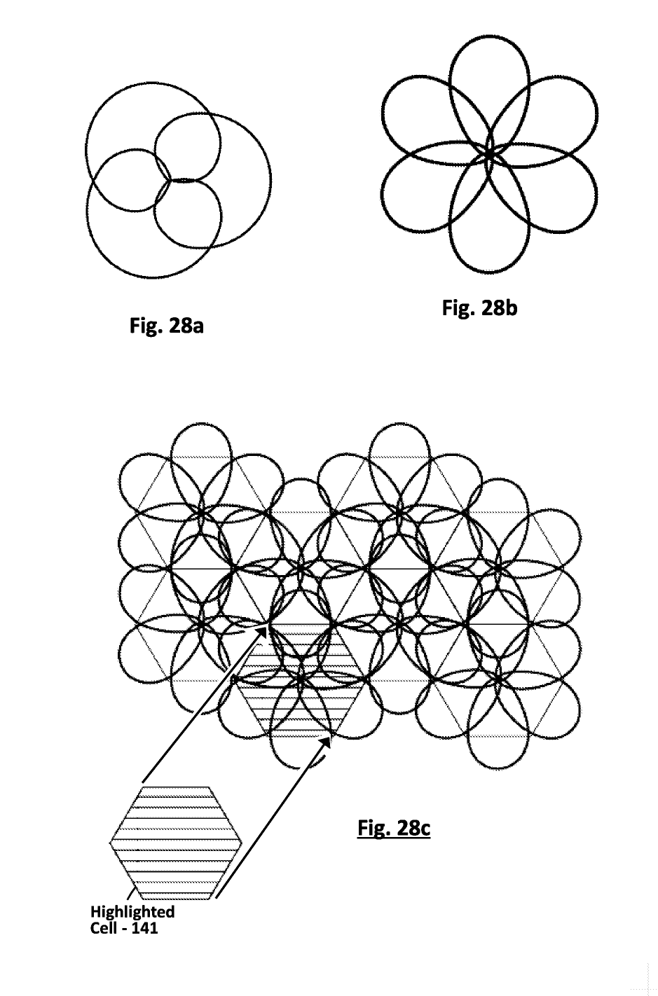

FIG. 28a depicts an illustrative diagram of three overlapping base station and here with a different antenna transmitting pattern producing a larger overlapping pattern/area. FIG. 28b depicts another illustrative diagram with a different overlapping antenna transmitting pattern, here with six overlapping patterns/areas. FIG. 28c depicts an illustrative diagram with eight neighboring cells, each with a pattern of six transmitters, as depicted in FIG. 28b. A highlighted cell 141 shaded with a horizontal line pattern has been pulled outside the cell patterns to illustrate the relationship between a cell pattern with its neighboring cells and its relative relationship to the actual transceiver pattern deployed within each cell. The purpose is to illustrate the variety of patterns and issues for a UE moving throughout the area and receiving a signal from more than one transmitter simultaneously, where these are just eight neighboring cells and just one of a range of variety of patterns that can create relatively complex overlapping patterns and handover issues. With a plurality of base stations, especially in crowded, say metropolitan area, and/or with overlapping competing technologies (3G, 4G, LTE, Wifi, WiMax, 3GPRS, etc.), and/or competing base stations from a variety of competing carriers (e.g. Verizon, ATT, T-mobile, Sprint, etc.), the challenges increase for managing handovers. However, with the increase in base stations and ever smaller cells, there are opportunities for providing better quality of service, where for example, a UE could be camped/connected/linked with more than one source, say for maintaining a better quality voice conversation, three-way calls, and/or with one connection dedicated to voice and another dedicated for data, each with maintained secondary and tertiary handover targets. Further, where the handover targets are conditional, with prioritized NCLs that are generated persistently and iteratively. Furthermore, where each handover is tracked for relative successfulness, and/or compared with an anticipated handover (say for a particular device in the near term), and/or a projected handover (say for a projection based on a particular pattern of usage for a segment of UEs).

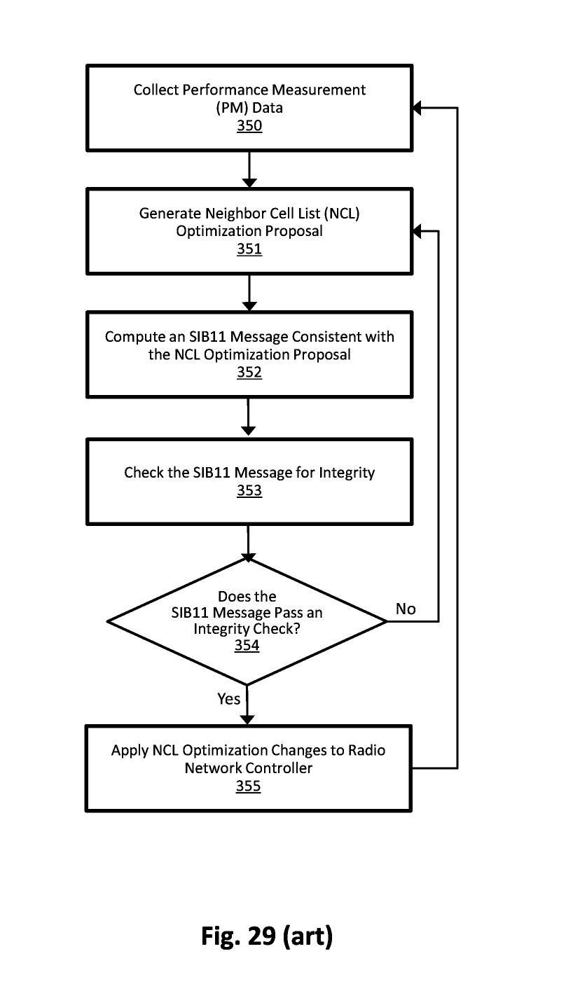

FIG. 29 is a flowchart of existing art of a method for optimizing network neighbor cell lists. In block 350, PM data is collected regarding the performance of the network. The PM data comprises key performance indicators (KPI's). Block 350 then transfers control to block 351. In block 351, an NCL optimization proposal is generated, so as to optimize one or more KPI's.

The KPI's includes one or more of an identification of one or more proposed optimizations of Information Elements (IE's) comprised in the NCL, a log of network performance, an initial attachment success rate, a service request rate, a handover success rate, one or more HO failure reasons, a circuit switched call origination rate, a circuit switched call termination rate, a packet switched call origination rate, a packet switched call termination rate, an identification of one or more missing neighbors, an identification of one or more new neighbors to be added to the NCL, an identification of one or more excessive neighbor relations, an identification of one or more one-way neighbors, and an identification of one or more current neighbors to be deleted from the NCL, physical location, transmitter output power, primary scrambling code, uplink frequencies, downlink frequencies, parameters defining network configuration, coverage, capacity, and quality of service (QOS).

This generation of the optimization proposal may occur automatically. This generation may be performed using criteria that are input by an operator prior to operation. Alternatively, this generation may be performed using criteria that are input by an operator during operation. The NCL optimization proposal may comprise proposals regarding one or more of an identification of one or more missing neighbors, an identification of one or more new neighbors to be added to the NCL, an identification of one or more current neighbors to be deleted from the NCL, and an identification of one or more proposed optimizations of Information Elements (IE's) comprised in the NCL.

One specific approach to generating the NCL entails first identifying the neighbor cells, next identifying the functional neighbor cells by measuring the Soft handover (SHO) KPI for each cell and its neighbors, then ranking all the neighbors by their SHO KPI, and finally computing an NCL optimization proposal for each cell.

Block 351 then transfers control to block 352. In block 352, an SIB1-SIB13, or through SIBn message consistent with the NCL optimization proposal may be generated. Block 352 then transfers control to block 353. In block 353, the SIB1-SIB13, or through SIBn message using the optimized NCL may be checked for integrity to determine if the SIB1-SIB13, or through SIBn message can be encoded and to determine what the message size would be. It may be determined if the SIB1-SIB13, or through SIBn message is less than or equal to a critical size limit. For example, the critical size limit may be 3,552 bits. Block 353 then transfers control to block 354.

In block 354, it is queried whether the SIB1-SIB13, or through SIBn message passes an integrity check. If it does pass, block 354 transfers control to block 355. If it does not pass, the process reverts to block 351 so that a new NCL optimization proposal may be generated. In block 355, the NCL optimization changes are applied to the RNC. Block 355 then transfers control to block 350 so that the process can begin again. Alternatively (not shown), block 355 terminates the process.

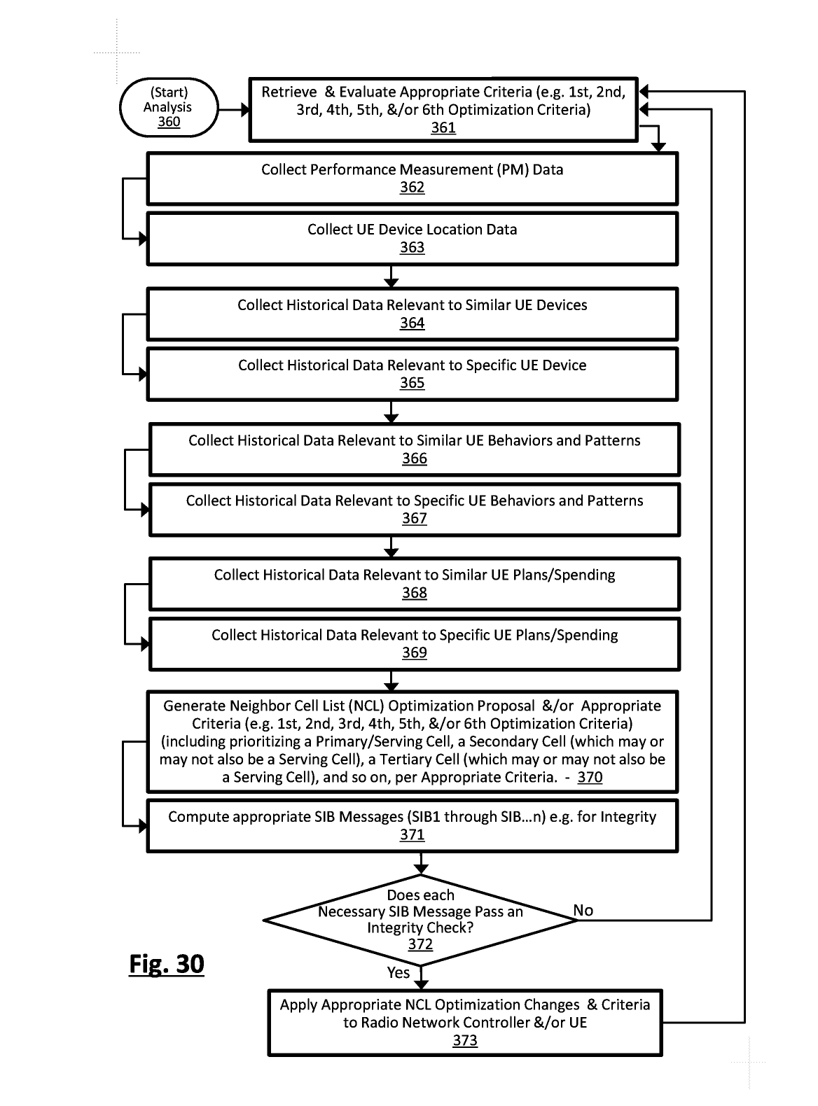

FIG. 30 is a flowchart of an exemplary embodiment of a method for optimizing network neighbor cell lists. Starting with a terminal 360, where an Analysis (start) 360 terminal proceeds to a step 361, where a “Retrieve and Evaluate Appropriate Criteria (e.g. 1st, 2nd, 3rd, 4th, 5th, &/or 6th Optimization Criteria)” is executed. From step 361, the process advances to a step 362, where a “Collect Performance Measurement (PM) Data,” is executed. Here, the PM data is collected regarding KPI and performance of the network, relative to what is available, what can be collected with a timer condition, say for each relevant cell, transmitter/transceiver, channel, the network equipment, usage, and/or the like.

In addition, the KPI may include one or more of an identification of one or more proposed optimizations of Information Elements (IE's) comprised in the NCL, a log of network performance, an initial attachment success rate, a service request rate, a handover success rate, one or more HO failure reasons, a circuit switched call origination rate, a circuit switched call termination rate, a packet switched call origination rate, a packet switched call termination rate, an identification of one or more missing neighbors, an identification of one or more new neighbors to be added to the NCL, an identification of one or more excessive neighbor relations, an identification of one or more one-way neighbors, and an identification of one or more current neighbors to be deleted from the NCL, physical location, transmitter/transceiver output power, primary scrambling code, uplink frequencies, downlink frequencies, parameters defining network configuration, coverage, capacity, and quality of service (QoS). In various non-limiting embodiments of this disclosure, the approach to generating a NCL entails first identifying the neighbor cells, next identifying the functional neighbor cells by measuring the Soft handover (SHO) KPI for each cell and its neighbors, then ranking all the neighbors by their SHO KPI, and finally computing an NCL optimization proposal for each cell.

In various non-limiting embodiments of this disclosure, the list KPI would preferably be uniquely ID, time and date-stamped, along with a cluster analysis of related conditions and ranks for such things as time of day, day of the week, overall traffic congestion, voice traffic volume, data traffic volume, bit rates, throughput, weather conditions, types of UE, percentage per type of UE, along with relative day over day, week over week, month over month, year over year comparison statistics and data

In various non-limiting embodiments of this disclosure, the system would preferably generate, evaluate, index, study, and/or test realtime data, historically data, anticipated data, and/or projected data, generation of the optimization proposal may occur automatically. In various non-limiting embodiments of this disclosure, the system would preferably perform evaluations and data generation using criteria that are input by an operator prior to operation. In various non-limiting embodiments of this disclosure, the system would preferably perform evaluations and data generation using a particular criteria inputs in near realtime, and acted on in near realtime, inputs in near realtime and acted on per a delay criteria, and/or near realtime and tested offline. Any given and uniquely Identified NCL optimization proposal may comprise proposals regarding one or more of an identification of one or more missing neighbors, an identification of one or more new neighbors to be added to the NCL, an identification of one or more current neighbors to be deleted from the NCL, and an identification of one or more proposed optimizations of Information Elements (IE's) comprised in the NCL, workaround suggestions, proposals relative to a service level plan, proposals relative to changing conditions, proposals relative to a particular UE, proposals relative to a particular segment of UE, window of time/day, event, potential emergency/event, and/or the like, and/or some combination, collections, and/or permutation of these.

Returning to FIG. 30, from step 362, the process advances to a step 363, where a “Collect UE Device Location Data,” is executed. In various non-limiting embodiments of this disclosure, the system would preferably collect, evaluate, index, study, and/or test realtime data, historically data, anticipated data, and/or projected data, relative to the location of UE device, which may occur automatically, conditionally, systematically (e.g. via an artificial intelligent subsystem), separately, simultaneously, anticipated, come from anticipations, projections, and/or the like. In various non-limiting embodiments of this disclosure, the system would preferably electronically retrieve and store this UE Device indexed statistical, data, behaviors, and/or patterns that could be collected, measured, analyzed, anticipated, and/or projected from GPS data, triangulation, relative signal strength (e.g. relative to an access point and/or relative to other UE, and/or relative to time due travel), and/or the like.

In various non-limiting embodiments of this disclosure, the system would preferably collect, evaluate, index, study, and/or test realtime data, historically data, anticipated data, and/or projected data, relative to the location of UE device, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

From step 363, the process advances to a step 364, where a “Collect Historical Data Relevant to Similar UE Devices,” is executed. In various non-limiting embodiments of this disclosure, here the system would preferably collect, evaluate, index, study, and/or test realtime data, historically data, anticipated data, and/or projected data, relative to the historical data relevant to Similar UE Devices, which may occur automatically, conditionally, systematically (e.g. via an artificial intelligent subsystem), separately, simultaneously, anticipated, come from anticipations, projections, and/or the like. Here, the UE device data collected by the UEA subsystem 622 is limited to a particular or specific UE, or similar UE, and the UE data may comprise one or more key statistics, criteria, and/or performance indicators (KPI's). In an alternative embodiment of this disclosure, the UE device data collected by the UEA subsystem 622 would not necessarily be limited to a particular or specific UE, or similar UE.

In various non-limiting embodiments of this disclosure, the system would preferably electronically store and retrieve UE Device indexed statistical, data, behaviors, and/or patterns relative to how similar or not similar to a particular UE via a set measurements/metrics, in addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to Similar UE devices, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

From step 364, the process advances to a step 365, where a “Collect Historical Data Relevant to Specific UE Device,” is executed. In various non-limiting embodiments of this disclosure, here the system would preferably collect, evaluate, index, study, and/or test realtime data, historically data, anticipated data, and/or projected data, relative to the specific UE Device, say the specific UE Device interacting with the system, which may occur automatically, conditionally, systematically (e.g. via an artificial intelligent subsystem), separately, simultaneously, anticipated, come from anticipations, projections, and/or the like. Here, the UE device data collected by the UEA subsystem 622 is limited to a specific UE device, and the UE data may comprise one or more key statistics, criteria, and/or performance indicators (KPI's).

In various non-limiting embodiments of this disclosure, the system would preferably electronically store and retrieve this specific UE Device indexed statistical, data, behaviors, and/or patterns relative to how similar or not similar to a particular segment of UE devices via a set measurements/metrics, in addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to this specific UE device, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like. In an alternative embodiment of this disclosure, the UE device data collected by the UEA subsystem 622 could be for a specific device, but not necessarily the specific UE interacting with the system, but instead a use case or worse scenario.

From step 365, the process advances to a step 366, where a “Collect Historical Data Relevant to Similar UE Behaviors and Patterns,” is executed. In various non-limiting embodiments of this disclosure, here the system would preferably collect, evaluate, index, study, and/or test realtime data, historically data, anticipated data, and/or projected data, relative to the historical data relevant to Similar UE Behaviors and Patterns, which may occur automatically, conditionally, systematically (e.g. via an artificial intelligent subsystem), separately, simultaneously, anticipated, come from anticipations, projections, and/or the like. Here, the UE Behavior and Pattern data collected by the UEA subsystem 622 is limited to similar UE Behaviors and Patterns, and may comprise one or more key statistics, criteria, and/or performance indicators (KPI's), say for commuting patterns per day, time of day, directions, paths, dwell times long a given path, and/or the like. In an alternative embodiment of this disclosure, the UE historical behavior or pattern data collected by the UEA subsystem 622 would not necessarily be limited to a particular or specific UE, but behaviors and/or patterns relative to particular cell location, say relative overall traffic patterns, and/or the like.

In various non-limiting embodiments of this disclosure, the system would preferably electronically store and retrieve UE behaviors and patterns to generate statistical, data, and index the behaviors and patterns relative to how similar or not similar to a particular segment, say of like UEs, like commuters, like UE plans, and/or the like, via a set measurements/metrics. In addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to Similar UE behaviors and/or patterns, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

From step 366, the process advances to a step 367, where a “Collect Historical Data Relevant to Specific UE Behaviors and Patterns,” is executed. In various non-limiting embodiments of this disclosure, here the system would preferably collect, evaluate, index, study, and/or test realtime data, historically data, anticipated data, and/or projected data, relative to the historical data relevant to a specific UE Behaviors and Patterns, which may occur automatically, conditionally, systematically (e.g. via an artificial intelligent subsystem), separately, simultaneously, anticipated, come from anticipations, projections, and/or the like. Here, the specific UE Behavior and Pattern data collected by the UEA subsystem 622 is limited to a specific UE and its Behavior and Patterns, and may comprise one or more key statistics, criteria, and/or performance indicators (KPI's), say for commuting patterns per day, time of day, directions, paths, dwell times long a given path, and/or the like, for the specific UE Device, say the specific UE Device interacting with the system.

In various non-limiting embodiments of this disclosure, the system would preferably electronically store and retrieve specific UE behaviors and patterns to generate statistical, data, and index the behaviors and patterns relative to how similar or not similar to a particular UE or UE segment, say of like UEs, like commuters, like UE plans, and/or the like, via a set measurements/metrics. In addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to Similar UE behaviors and/or patterns, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like. In an alternative embodiment of this disclosure, the historical behavior or pattern data for the specific UE collected by the UEA subsystem 622 would not necessarily be limited to the particular or specific UE Device interacting with the system, but instead, say for behaviors and/or patterns relative to particular UE Device (e.g. a worst-case scenario) or other cell location, say relative overall traffic patterns, and/or the like.

From step 367, the process advances to a step 368, where a “Collect Historical Data Relevant to Similar UE Plans/Spending,” is executed. In various non-limiting embodiments of this disclosure, here the system would preferably collect, evaluate, index, study, and/or test realtime data, historically data, anticipated data, and/or projected data, relative to the historical data relevant to similar UE Plans/Spending, which may occur automatically, conditionally, systematically (e.g. via an artificial intelligent subsystem), separately, simultaneously, anticipated, come from anticipations, projections, and/or the like. Here, the similar UE Plans/Spending data collected by the UEA subsystem 622 is limited to similar UE Plans/Spending and may comprise one or more key statistics, criteria, and/or performance indicators (KPI's), say for contract terms, including, say a current contract start date/end date, previous contract start dates/end dates, devices purchased, minutes consumed when/where, data consumed when/where, SMS consumed when/where, downloads when/where, internet usage when/where, wifi usage when/where, mobile purchases of what, when, where, how, and/or the like. In an alternative embodiment of this disclosure, the UE plan/spending data collected by the UEA subsystem 622 would not necessarily be limited to plans or spending of a similar UE, but instead the plans and/or spending relative to particular cell location, say relative overall UEs under a similar plan, subscription, usage pattern, and/or the like.

In various non-limiting embodiments of this disclosure, the system would preferably electronically store and retrieve UE plans and spending to generate statistical, data, and index the behaviors and patterns relative to how similar or not similar to a particular segment, say of like UEs, like commuters, like UE plans, and/or the like, via a set measurements/metrics. In addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to Similar UE Plans and Spending, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

From step 368, the process advances to a step 369, where a “Collect Historical Data Relevant to Specific UE Plans/Spending,” is executed. In various non-limiting embodiments of this disclosure, here the system would preferably collect, evaluate, index, study, and/or test realtime data, historically data, anticipated data, and/or projected data, relative to the historical data relevant to specific UE Plan/Spending, which may occur automatically, conditionally, systematically (e.g. via an artificial intelligent subsystem), separately, simultaneously, anticipated, come from anticipations, projections, and/or the like. Here, the specific UE Plan/Spending data collected by the UEA subsystem 622 is limited to specific UE Plan/Spending and may comprise one or more key statistics, criteria, and/or performance indicators (KPI's), say for a contract term(s), including, say a current contract start date/end date, previous contract start dates/end dates, devices purchased, minutes consumed when/where, data consumed when/where, SMS consumed when/where, downloads when/where, internet usage when/where, wifi usage when/where, mobile purchases of what, when, where, how, and/or the like for the specifically designated UE device. In an alternative embodiment of this disclosure, the UE plan/spending data collected by the UEA subsystem 622 would not necessarily be limited to a plan or spending of the specific UE device interacting at the time, but instead the plan and/or spending relative to a particular cell location, say relative the overall UEs under a specific plan, subscription, usage pattern/segment, and/or the like.

In various non-limiting embodiments of this disclosure, the system would preferably electronically store and retrieve the UE plan and spending to generate statistical, data, and index the behaviors and patterns relative to how similar or not similar to a particular segment, say of like UEs, like commuters, like UE plans, and/or the like, via a set measurements/metrics. In addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to the specific UE Plan and Spending, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

From step 369, the process advances to a step 370, where a “Generate Neighbor Cell List (NCL) Optimization Proposal &/or Appropriate Criteria (e.g. 1st, 2nd, 3rd, 4th, 5th, &/or 6th Optimization Criteria) (including prioritizing a Primary/Serving Cell, a Secondary Cell (which may or may not also be a Serving Cell), a Tertiary Cell (which may or may not also be a Serving Cell), and so on, per Appropriate Criteria,” is executed. In various non-limiting embodiments of this disclosure, the system would preferably dynamically, intelligently, and electronically, store and retrieve a list of criteria, conditions, and rules to iteratively generate NCLs as required, say automatically, systematically, (via an artificial intelligence subsystem not depicted), conditionally, and/or along with any system-selections/inputs, carrier-selections/inputs, and/or user-selective conditions/inputs, either in advance, relatively recently, relatively realtime, and/or realtime.

In various non-limiting embodiments of this disclosure, the generated dynamic and intelligent criteria may also be prioritized per a particular event, condition, location, user, plan, time of day, series of events, threshold, and/or the like. In various non-limiting embodiments of this disclosure, a set of criteria within a particular criteria (e.g. 1st, 2nd, 3rd, 4th, 5th, &/or 6th Optimization Criteria) may be conditional and/or prioritized per a particular event, condition, location, user, plan, time of day, series of events, threshold, and/or the like. In various non-limiting embodiments of this disclosure, the system would preferably generate, evaluate, index, study, and/or test realtime each generated criteria relative to measurable success for relatively fewer dropped calls, call quality, signal strength relative to a window of time/usage pattern, customer retention, customer satisfaction, customer upgrades (e.g. hardware or software), and/or the like. Further, each generated criteria can be electronically store and retrieve indexed statistical, data, behaviors, and/or patterns relative to collecting relevant data, generating anticipated NPLs, proposals, subsequent criteria, and/or generating anticipated patterns, and tracked and tested against anticipated data, and/or projected data.

In various non-limiting embodiments of this disclosure, a first criteria is the initial or default criteria, a second criteria (and so on) are/is a subsequent criteria or a conditional criteria for a particular set of conditions (say the conditional criteria for a particular time of day, device, user, traffic pattern, plan, history, and/or the like), and/or for a particular level of service, say a simultaneous connection for voice and data, simultaneous connection to more than one voice channel to preserve quality, and/or switch back and forth as necessary to preserve the best condition/quality.

Returning to FIG. 30, from step 370, the process advances to a step 371, where a “Compute appropriate SIB Messages (SIB1 through SIB...n) e.g. for Integrity,” is executed. In various non-limiting embodiments of this disclosure, here the system would preferably evaluate the active criteria to determine what specific SIB Messages are required per what particular specifications, routing information, existing and/or potential issues, bottlenecks, and/or the like, to execute the criteria, generate the appropriate SIB Messages and transmit to the appropriate recipients per the criteria.

From step 371, the process advances to a query 372, where the query asks “Does each Necessary SIB Message Pass an Integrity Check?” In various non-limiting embodiments of this disclosure, here the system would preferably evaluate the active criteria to determine what specific SIB Messages pass a specific Integrity Check and/or similar for each necessary SIB Message computed in step 371.

If the answer to query 372 is no, the process returns back to step 361. If the answer to query 372 is instead, “yes,” then process advances to a step 373 with an “Apply Appropriate NCL Optimization Changes & Criteria to Radio Network Controller &/or UE,” is executed. Here, per the relevant criteria, the process may conditionally terminate or loop and return to step 361. In various non-limiting embodiments of this disclosure, the system would preferably monitor the success of delivering each SIB Message, and/or make modifications to the data, criteria, a particular SIB message accordingly, and/or retransmit a particular SIB message if necessary.

In various non-limiting embodiments of this disclosure, each SIB message and SIB message criteria, SIB message transmission, retransmission, and/or the like is tracked relative to a delivery in time, a successful delivery, a successful implementation, and/or relative to the number of modification implemented, and/or the like, what specific information was relative most valuable to least relative to minimizing dropped calls, signal strengths, maintaining a particular level of service, avoiding congestion, and/or the like, for a particular set of conditions (say the conditional criteria for a particular time of day, device, user, traffic pattern, plan, history, and/or the like), and/or for a particular level of service, and/or the like.

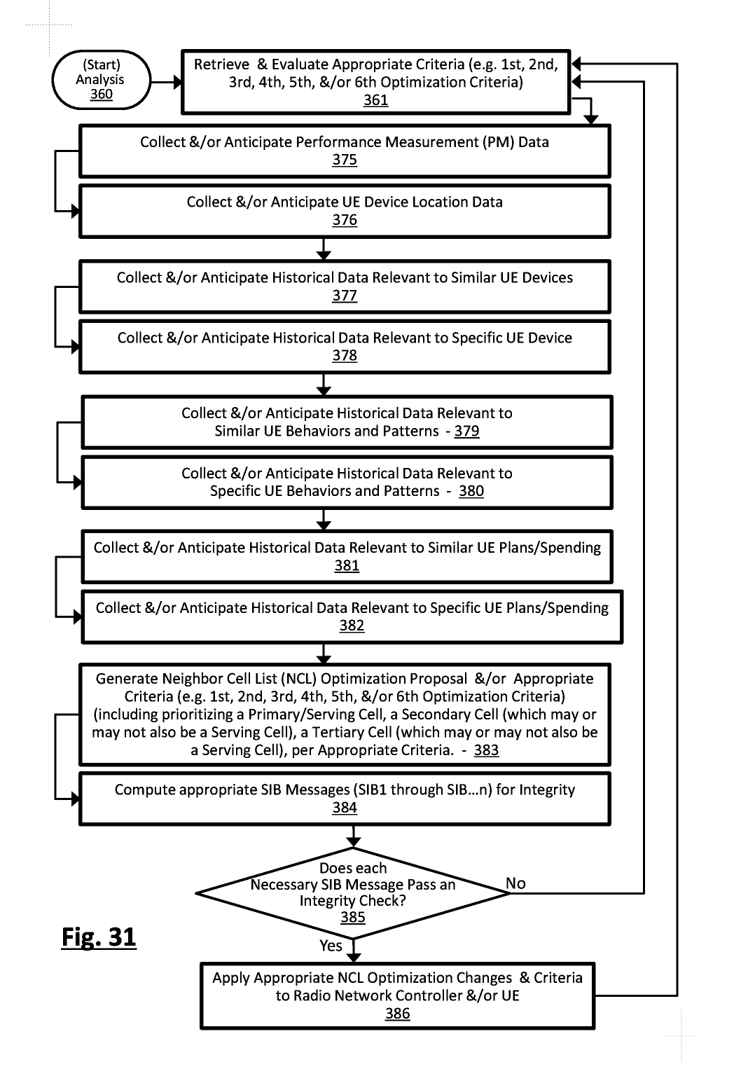

FIG. 31 is a flowchart of another non-limiting embodiment of a method for optimizing network neighbor cell lists. Here, similar to FIG. 30, starting with a terminal 360, where an Analysis (start) 360 terminal proceeds to a step 361, where a “Retrieve and Evaluate Appropriate Criteria (e.g. 1st, 2nd, 3rd, 4th, 5th, &/or 6th Optimization Criteria)” is executed. From step 361, the process advances to a step 375, where a “Collect and/or Anticipate Performance Measurement (PM) Data,” is executed. Here, the system would preferably be focused on collecting, generating, indexing data, tracking and testing anticipations, opposed to performing near realtime and realtime NPL proposals, criteria, and/or the like, as in FIG. 30. From step 375, the process advances to a step 375, where a “Collect and/or Anticipate UE Device Location Data,” is executed. In various non-limiting embodiments of this disclosure, the system would preferably collect, evaluate, index, study, and/or test realtime data, historically data, anticipated data, and/or projected data, relative to the location of UE device, which may occur automatically, conditionally, systematically (e.g. via an artificial intelligent subsystem), separately, simultaneously, anticipated, come from anticipations, projections, and/or the like. In various non-limiting embodiments of this disclosure, the system would preferably electronically retrieve and store this UE Device indexed statistical, data, behaviors, and/or patterns that could be collected, measured, analyzed, anticipated, and/or projected from GPS data, triangulation, relative signal strength (e.g. relative to an access point and/or relative to other UE, and/or relative to time due travel), and/or the like.

In various non-limiting embodiments of this disclosure, the system would preferably continually, persistently, and iteratively generate, evaluate, index, study, and/or test realtime data, historically data, anticipated data, and/or projected data, to electronically store and retrieve indexed statistical, data, behaviors, and/or patterns relative to collecting relevant data, generating anticipated NPLs, proposals, criteria, and/or generating anticipated patterns, say relative to areas of perceived congestion, handover failures, peak demand, and/or the like.

In various non-limiting embodiments of this disclosure, the evaluating, generating, indexing, and/or the like of anticipated data, refers to data relevant to an event in the relative near term, say during an on-going connection session with a particular UE, and/or a relatively small window of time, say for the next 30 minutes, where the system and methods can track anticipated data relative to actual events, to continually and persistently learn to improve anticipations, and/or projections. In various non-limiting embodiments of this disclosure, the evaluating, generating, indexing, and/or the like of projected data/projections, refers to data relevant to an event in the relative more distant future when compared to anticipated data, say projections for the following week, for the same given day/time, where projections are preferably compared with existing defaults, and analyzed and/or tested for reliability, anomalies, and/or updating existing defaults, indexes, assumptions, historical data/statistics, and/or the like.

In various non-limiting embodiments of this disclosure, the system would preferably generate, evaluate, index, study, and/or test realtime data, historically data, anticipated data, and/or projected data, to electronically store and retrieve indexed statistical, data, behaviors, and/or patterns relative to collecting relevant data, generating projected NPLs, proposals, criteria, and/or generating projected patterns, say relative to areas of perceived congestion, handover failures, peak demand, and/or the like. In various non-limiting embodiments of this disclosure, the evaluating, generating, indexing, and/or the like of projected data/projections and anticipated data/anticipation, can be run, tested, evaluated, challenged, and/or like, automatically, conditionally, systematically (e.g. via an artificial intelligent subsystem), separately, simultaneously, and/or the like, against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

In various non-limiting embodiments of this disclosure, the anticipation/projection models can be further improved from the reveal anomalies, issues/faults, insufficient-tolerances, potential problems, and/or the like, that were unperceived/unanticipated/not-projected. In various non-limiting embodiments of this disclosure, designated network equipment can be actually or artificially be taken off line, to evaluate effects on the system, traffic, handover relative successfulness, assumptions, defaults, anticipations/projections, and/or the like.

In various non-limiting embodiments of this disclosure, the system, subsystem, and methods for evaluating, generating, indexing, and/or the like of projected data/projections refers to data relevant to a future event, say projections for a potential emergency situation, where for example, certain locations and/or network equipment would likely be overloaded, or fail, due to a natural or man-made disaster. Here, in various non-limiting embodiments of this disclosure, the system, subsystem, and methods for evaluating, generating, indexing, and/or the like of projected data/projections and anticipated data/anticipation, can be run, tested, evaluated, challenged, and/or like, automatically, conditionally, systematically (e.g. via an artificial intelligent subsystem), separately, simultaneously, and/or the like, against, say simulated computer models to test anticipated/projected concerns, issues, and/or reveal anomalies, unperceived/unanticipated/not-projected issues/faults, insufficient-tolerances, potential problems, and/or the like, relative to a variety of emergency conditions, and/or evolving conditions, and/or the like.

Traditional planning tools and pre-launch optimization efforts tend to incorporate relatively little and limited knowledge, compared to the intelligence that is gleaned from real world usage and dynamic conditions. Furthermore, intelligent and dynamic NCLs that are optimized far more accurately and often (e.g. in realtime and/or iteratively indexed for known or special conditions) will be required for more advanced demands, traffic, and applications. For example, allowing more than one voice communication connection, and/or a voice communication on a first network and/or first cell while allowing a second connection, e.g. for data traffic on another network and/or cell. In addition, background persistent testing of anticipated and projected testing, can produce system intelligence in realtime, and/or in virtual offline test cases.

Returning to FIG. 31, in various non-limiting embodiments of this disclosure, the system would preferably collect, evaluate, index, study, and/or test realtime data, historically data, anticipated data, and/or projected data, relative to the location of UE device, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

From step 376, the process advances to a step 377, where a “Collect and/or Anticipate Historical Data Relevant to Similar UE Devices,” is executed. In various non-limiting embodiments of this disclosure, here the system would preferably collect, evaluate, index, study, and/or test realtime data, historically data, anticipated data, and/or projected data, relative to the historical data relevant to Similar UE Devices, which may occur automatically, conditionally, systematically (e.g. via an artificial intelligent subsystem), separately, simultaneously, anticipated, come from anticipations, projections, and/or the like. Here, the UE device data collected by the UEA subsystem 622 is limited to a particular or specific UE, or similar UE, and the UE data may comprise one or more key statistics, criteria, and/or performance indicators (KPI's). In an alternative embodiment of this disclosure, the UE device data collected by the UEA subsystem 622 would not necessarily be limited to a particular or specific UE, or similar UE.

In various non-limiting embodiments of this disclosure, the system would preferably electronically store and retrieve UE Device indexed statistical, data, behaviors, and/or patterns relative to how similar or not similar to a particular UE via a set measurements/metrics, in addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to Similar UE devices, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

From step 377, the process advances to a step 378, where a “Collect and/or Anticipate Historical Data Relevant to Specific UE Device,” is executed. In various non-limiting embodiments of this disclosure, here the system would preferably collect, evaluate, index, study, and/or test realtime data, historically data, anticipated data, and/or projected data, relative to the specific UE Device, say the specific UE Device interacting with the system, which may occur automatically, conditionally, systematically (e.g. via an artificial intelligent subsystem), separately, simultaneously, anticipated, come from anticipations, projections, and/or the like. Here, the UE device data collected by the UEA subsystem 622 is limited to a specific UE device, and the UE data may comprise one or more key statistics, criteria, and/or performance indicators (KPI's).

In various non-limiting embodiments of this disclosure, the system would preferably electronically store and retrieve this specific UE Device indexed statistical, data, behaviors, and/or patterns relative to how similar or not similar to a particular segment of UE devices via a set measurements/metrics, in addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to this specific UE device, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like. In an alternative embodiment of this disclosure, the UE device data collected by the UEA subsystem 622 could be for a specific device, but not necessarily the specific UE interacting with the system, but instead a use case or worse scenario.

From step 378, the process advances to a step 379, where a “Collect and/or Anticipate Historical Data Relevant to Similar UE Behaviors and Patterns,” is executed. In various non-limiting embodiments of this disclosure, here the system would preferably collect, evaluate, index, study, and/or test realtime data, historically data, anticipated data, and/or projected data, relative to the historical data relevant to Similar UE Behaviors and Patterns, which may occur automatically, conditionally, systematically (e.g. via an artificial intelligent subsystem), separately, simultaneously, anticipated, come from anticipations, projections, and/or the like. Here, the UE Behavior and Pattern data collected by the UEA subsystem 622 is limited to similar UE Behaviors and Patterns, and may comprise one or more key statistics, criteria, and/or performance indicators (KPI's), say for commuting patterns per day, time of day, directions, paths, dwell times long a given path, and/or the like. In an alternative embodiment of this disclosure, the UE historical behavior or pattern data collected by the UEA subsystem 622 would not necessarily be limited to a particular or specific UE, but behaviors and/or patterns relative to particular cell location, say relative overall traffic patterns, and/or the like.

In various non-limiting embodiments of this disclosure, the system would preferably electronically store and retrieve UE behaviors and patterns to generate statistical, data, and index the behaviors and patterns relative to how similar or not similar to a particular segment, say of like UEs, like commuters, like UE plans, and/or the like, via a set measurements/metrics. In addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to Similar UE behaviors and/or patterns, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

From step 379, the process advances to a step 380, where a “Collect and/or Anticipate Historical Data Relevant to Specific UE Behaviors and Patterns,” is executed. In various non-limiting embodiments of this disclosure, here the system would preferably collect, evaluate, index, study, and/or test realtime data, historically data, anticipated data, and/or projected data, relative to the historical data relevant to a specific UE Behaviors and Patterns, which may occur automatically, conditionally, systematically (e.g. via an artificial intelligent subsystem), separately, simultaneously, anticipated, come from anticipations, projections, and/or the like. Here, the specific UE Behavior and Pattern data collected by the UEA subsystem 622 is limited to a specific UE and its Behavior and Patterns, and may comprise one or more key statistics, criteria, and/or performance indicators (KPI's), say for commuting patterns per day, time of day, directions, paths, dwell times long a given path, and/or the like, for the specific UE Device, say the specific UE Device interacting with the system.

In various non-limiting embodiments of this disclosure, the system would preferably electronically store and retrieve specific UE behaviors and patterns to generate statistical, data, and index the behaviors and patterns relative to how similar or not similar to a particular UE or UE segment, say of like UEs, like commuters, like UE plans, and/or the like, via a set measurements/metrics. In addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to Similar UE behaviors and/or patterns, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like. In an alternative embodiment of this disclosure, the historical behavior or pattern data for the specific UE collected by the UEA subsystem 622 would not necessarily be limited to the particular or specific UE Device interacting with the system, but instead, say for behaviors and/or patterns relative to particular UE Device (e.g. a worst-case scenario) or other cell location, say relative overall traffic patterns, and/or the like.

From step 380, the process advances to a step 381, where a “Collect and/or Anticipate Historical Data Relevant to Similar UE Plans/Spending,” is executed. In various non-limiting embodiments of this disclosure, here the system would preferably collect, evaluate, index, study, and/or test realtime data, historically data, anticipated data, and/or projected data, relative to the historical data relevant to similar UE Plans/Spending, which may occur automatically, conditionally, systematically (e.g. via an artificial intelligent subsystem), separately, simultaneously, anticipated, come from anticipations, projections, and/or the like. Here, the similar UE Plans/Spending data collected by the UEA subsystem 622 is limited to similar UE Plans/Spending and may comprise one or more key statistics, criteria, and/or performance indicators (KPI's), say for contract terms, including, say a current contract start date/end date, previous contract start dates/end dates, devices purchased, minutes consumed when/where, data consumed when/where, SMS consumed when/where, downloads when/where, internet usage when/where, wifi usage when/where, mobile purchases of what, when, where, how, and/or the like. In an alternative embodiment of this disclosure, the UE plan/spending data collected by the UEA subsystem 622 would not necessarily be limited to plans or spending of a similar UE, but instead the plans and/or spending relative to particular cell location, say relative overall UEs under a similar plan, subscription, usage pattern, and/or the like.

In various non-limiting embodiments of this disclosure, the system would preferably electronically store and retrieve UE plans and spending to generate statistical, data, and index the behaviors and patterns relative to how similar or not similar to a particular segment, say of like UEs, like commuters, like UE plans, and/or the like, via a set measurements/metrics. In addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to Similar UE Plans and Spending, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

From step 381, the process advances to a step 382, where a “Collect and/or Anticipate Historical Data Relevant to Specific UE Plans/Spending,” is executed. In various non-limiting embodiments of this disclosure, here the system would preferably collect, evaluate, index, study, and/or test realtime data, historically data, anticipated data, and/or projected data, relative to the historical data relevant to specific UE Plan/Spending, which may occur automatically, conditionally, systematically (e.g. via an artificial intelligent subsystem), separately, simultaneously, anticipated, come from anticipations, projections, and/or the like. Here, the specific UE Plan/Spending data collected by the UEA subsystem 622 is limited to specific UE Plan/Spending and may comprise one or more key statistics, criteria, and/or performance indicators (KPI's), say for a contract term(s), including, say a current contract start date/end date, previous contract start dates/end dates, devices purchased, minutes consumed when/where, data consumed when/where, SMS consumed when/where, downloads when/where, internet usage when/where, wifi usage when/where, mobile purchases of what, when, where, how, and/or the like for the specifically designated UE device. In an alternative embodiment of this disclosure, the UE plan/spending data collected by the UEA subsystem 622 would not necessarily be limited to a plan or spending of the specific UE device interacting at the time, but instead the plan and/or spending relative to a particular cell location, say relative the overall UEs under a specific plan, subscription, usage pattern/segment, and/or the like.

In various non-limiting embodiments of this disclosure, the system would preferably electronically store and retrieve the UE plan and spending to generate statistical, data, and index the behaviors and patterns relative to how similar or not similar to a particular segment, say of like UEs, like commuters, like UE plans, and/or the like, via a set measurements/metrics. In addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to the specific UE Plan and Spending, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

From step 382, the process advances to a step 383, where a “Generate Neighbor Cell List (NCL) Optimization Proposal &/or Appropriate Criteria (e.g. 1st, 2nd, 3rd, 4th, 5th, &/or 6th Optimization Criteria) (including prioritizing a Primary/Serving Cell, a Secondary Cell (which may or may not also be a Serving Cell), a Tertiary Cell (which may or may not also be a Serving Cell), and so on, per Appropriate Criteria,” is executed. In various non-limiting embodiments of this disclosure, the system would preferably dynamically, intelligently, and electronically, store and retrieve a list of criteria, conditions, and rules to iteratively generate NCLs as required, say automatically, systematically, (via an artificial intelligence subsystem not depicted), conditionally, and/or along with any system-selections/inputs, carrier-selections/inputs, and/or user-selective conditions/inputs, either in advance, relatively recently, relatively realtime, and/or realtime.

In various non-limiting embodiments of this disclosure, the generated dynamic and intelligent criteria may also be prioritized per a particular event, condition, location, user, plan, time of day, series of events, threshold, and/or the like. In various non-limiting embodiments of this disclosure, a set of criteria within a particular criteria (e.g. 1st, 2nd, 3rd, 4th, 5th, &/or 6th Optimization Criteria) may be conditional and/or prioritized per a particular event, condition, location, user, plan, time of day, series of events, threshold, and/or the like. In various non-limiting embodiments of this disclosure, the system would preferably generate, evaluate, index, study, and/or test realtime each generated criteria relative to measurable success for relatively fewer dropped calls, call quality, signal strength relative to a window of time/usage pattern, customer retention, customer satisfaction, customer upgrades (e.g. hardware or software), and/or the like. Further, each generated criteria can be electronically store and retrieve indexed statistical, data, behaviors, and/or patterns relative to collecting relevant data, generating anticipated NPLs, proposals, subsequent criteria, and/or generating anticipated patterns, and tracked and tested against anticipated data, and/or projected data.

In various non-limiting embodiments of this disclosure, a first criteria is the initial or default criteria, a second criteria (and so on) are/is a subsequent criteria or a conditional criteria for a particular set of conditions (say the conditional criteria for a particular time of day, device, user, traffic pattern, plan, history, and/or the like), and/or for a particular level of service, say a simultaneous connection for voice and data, simultaneous connection to more than one voice channel to preserve quality, and/or switch back and forth as necessary to preserve the best condition/quality.

Returning to FIG. 31, from step 383, the process advances to a step 384, where a “Compute appropriate SIB Messages (SIB1 through SIB...n) e.g. for Integrity,” is executed. In various non-limiting embodiments of this disclosure, here the system would preferably evaluate the active criteria to determine what specific SIB Messages are required per what particular specifications, routing information, existing and/or potential issues, bottlenecks, and/or the like, to execute the criteria, generate the appropriate SIB Messages and transmit to the appropriate recipients per the criteria.

From step 384, the process advances to a query 385, where the query asks “Does each Necessary SIB Message Pass an Integrity Check?” In various non-limiting embodiments of this disclosure, here the system would preferably evaluate the active criteria to determine what specific SIB Messages pass a specific Integrity Check and/or similar for each necessary SIB Message computed in step 384.

If the answer to query 385 is no, the process returns back to step 361. If the answer to query 385 is instead, “yes,” then process advances to a step 386 with an “Apply Appropriate NCL Optimization Changes & Criteria to Radio Network Controller &/or UE,” is executed. Here, per the relevant criteria, the process may conditionally terminate or loop and return to step 361. In various non-limiting embodiments of this disclosure, the system would preferably monitor the success of delivering each SIB Message, and/or make modifications to the data, criteria, a particular SIB message accordingly, and/or retransmit a particular SIB message if necessary.

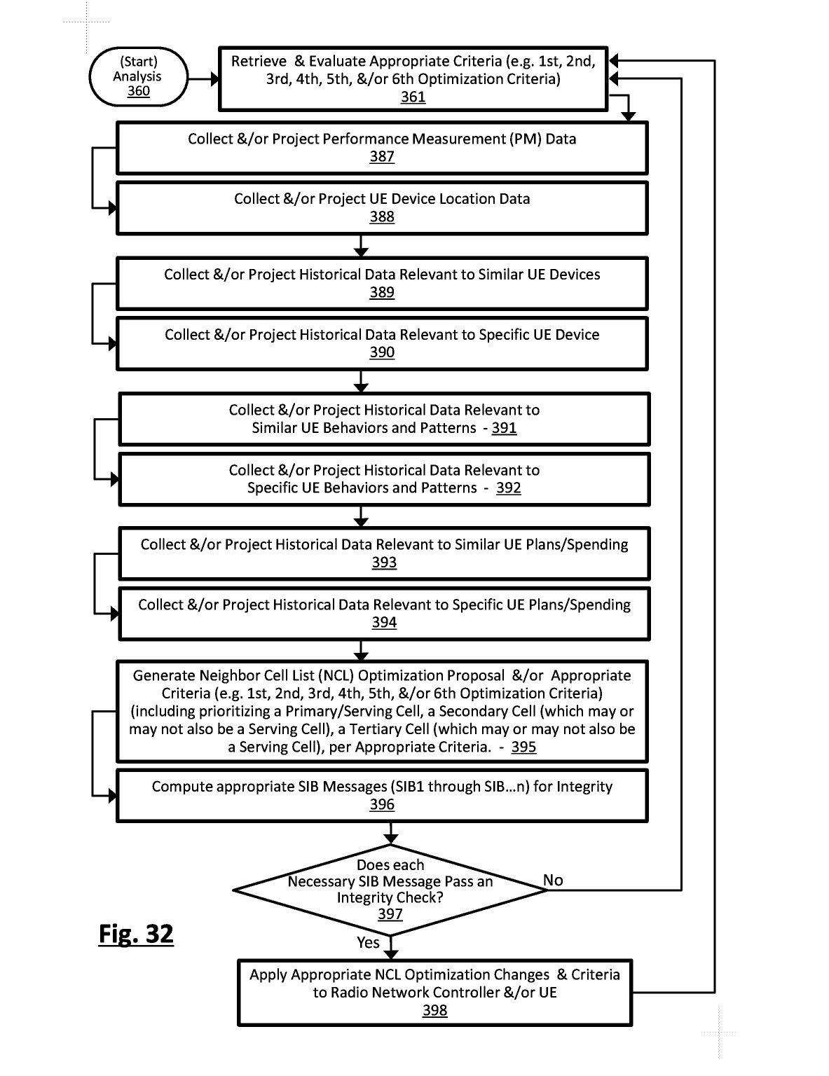

FIG. 32 is a flowchart of another non-limiting embodiment of a method for optimizing network neighbor cell lists. Here, similar to FIGS. 30 and 31, starting with a terminal 360, where an Analysis (start) 360 terminal proceeds to a step 361, where a “Retrieve and Evaluate Appropriate Criteria (e.g. 1st, 2nd, 3rd, 4th, 5th, &/or 6th Optimization Criteria)” is executed. From step 361, the process advances to a step 387, where a “Collect and/or Project Performance Measurement (PM) Data,” is executed. From step 387, the process advances to a step 387, where a “Collect and/or Project UE Device Location Data,” is executed. Here, similar to FIG. 31, the system would preferably be focused on collecting, generating, indexing data, tracking and testing projections, opposed to performing near realtime and realtime NPL proposals, criteria, and/or the like, as in FIG. 30. In various non-limiting embodiments of this disclosure, the system would preferably collect, evaluate, index, study, and/or test realtime data, historically data, anticipated data, and/or projected data, relative to the location of UE device, which may occur automatically, conditionally, systematically (e.g. via an artificial intelligent subsystem), separately, simultaneously, anticipated, come from anticipations, projections, and/or the like. In various non-limiting embodiments of this disclosure, the system would preferably electronically retrieve and store this UE Device indexed statistical, data, behaviors, and/or patterns that could be collected, measured, analyzed, anticipated, and/or projected from GPS data, triangulation, relative signal strength (e.g. relative to an access point and/or relative to other UE, and/or relative to time due travel), and/or the like.

In various non-limiting embodiments of this disclosure, the system would preferably collect, evaluate, index, study, and/or test realtime data, historically data, anticipated data, and/or projected data, relative to the location of UE device, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

From step 388, the process advances to a step 389, where a “Collect and/or Project Historical Data Relevant to Similar UE Devices,” is executed. In various non-limiting embodiments of this disclosure, here the system would preferably collect, evaluate, index, study, and/or test realtime data, historically data, anticipated data, and/or projected data, relative to the historical data relevant to Similar UE Devices, which may occur automatically, conditionally, systematically (e.g. via an artificial intelligent subsystem), separately, simultaneously, anticipated, come from anticipations, projections, and/or the like. Here, the UE device data collected by the UEA subsystem 622 is limited to a particular or specific UE, or similar UE, and the UE data may comprise one or more key statistics, criteria, and/or performance indicators (KPI's). In an alternative embodiment of this disclosure, the UE device data collected by the UEA subsystem 622 would not necessarily be limited to a particular or specific UE, or similar UE.

In various non-limiting embodiments of this disclosure, the system would preferably electronically store and retrieve UE Device indexed statistical, data, behaviors, and/or patterns relative to how similar or not similar to a particular UE via a set measurements/metrics, in addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to Similar UE devices, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

From step 389, the process advances to a step 390, where a “Collect and/or Project Historical Data Relevant to Specific UE Device,” is executed. In various non-limiting embodiments of this disclosure, here the system would preferably collect, evaluate, index, study, and/or test realtime data, historically data, anticipated data, and/or projected data, relative to the specific UE Device, say the specific UE Device interacting with the system, which may occur automatically, conditionally, systematically (e.g. via an artificial intelligent subsystem), separately, simultaneously, anticipated, come from anticipations, projections, and/or the like. Here, the UE device data collected by the UEA subsystem 622 is limited to a specific UE device, and the UE data may comprise one or more key statistics, criteria, and/or performance indicators (KPI's).

In various non-limiting embodiments of this disclosure, the system would preferably electronically store and retrieve this specific UE Device indexed statistical, data, behaviors, and/or patterns relative to how similar or not similar to a particular segment of UE devices via a set measurements/metrics, in addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to this specific UE device, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like. In an alternative embodiment of this disclosure, the UE device data collected by the UEA subsystem 622 could be for a specific device, but not necessarily the specific UE interacting with the system, but instead a use case or worse scenario.

From step 390, the process advances to a step 391, where a “Collect and/or Project Historical Data Relevant to Similar UE Behaviors and Patterns,” is executed. In various non-limiting embodiments of this disclosure, here the system would preferably collect, evaluate, index, study, and/or test realtime data, historically data, anticipated data, and/or projected data, relative to the historical data relevant to Similar UE Behaviors and Patterns, which may occur automatically, conditionally, systematically (e.g. via an artificial intelligent subsystem), separately, simultaneously, anticipated, come from anticipations, projections, and/or the like. Here, the UE Behavior and Pattern data collected by the UEA subsystem 622 is limited to similar UE Behaviors and Patterns, and may comprise one or more key statistics, criteria, and/or performance indicators (KPI's), say for commuting patterns per day, time of day, directions, paths, dwell times long a given path, and/or the like. In an alternative embodiment of this disclosure, the UE historical behavior or pattern data collected by the UEA subsystem 622 would not necessarily be limited to a particular or specific UE, but behaviors and/or patterns relative to particular cell location, say relative overall traffic patterns, and/or the like.

In various non-limiting embodiments of this disclosure, the system would preferably electronically store and retrieve UE behaviors and patterns to generate statistical, data, and index the behaviors and patterns relative to how similar or not similar to a particular segment, say of like UEs, like commuters, like UE plans, and/or the like, via a set measurements/metrics. In addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to Similar UE behaviors and/or patterns, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

From step 391, the process advances to a step 392, where a “Collect and/or Project Historical Data Relevant to Specific UE Behaviors and Patterns,” is executed. In various non-limiting embodiments of this disclosure, here the system would preferably collect, evaluate, index, study, and/or test realtime data, historically data, anticipated data, and/or projected data, relative to the historical data relevant to a specific UE Behaviors and Patterns, which may occur automatically, conditionally, systematically (e.g. via an artificial intelligent subsystem), separately, simultaneously, anticipated, come from anticipations, projections, and/or the like. Here, the specific UE Behavior and Pattern data collected by the UEA subsystem 622 is limited to a specific UE and its Behavior and Patterns, and may comprise one or more key statistics, criteria, and/or performance indicators (KPI's), say for commuting patterns per day, time of day, directions, paths, dwell times long a given path, and/or the like, for the specific UE Device, say the specific UE Device interacting with the system.

In various non-limiting embodiments of this disclosure, the system would preferably electronically store and retrieve specific UE behaviors and patterns to generate statistical, data, and index the behaviors and patterns relative to how similar or not similar to a particular UE or UE segment, say of like UEs, like commuters, like UE plans, and/or the like, via a set measurements/metrics. In addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to Similar UE behaviors and/or patterns, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like. In an alternative embodiment of this disclosure, the historical behavior or pattern data for the specific UE collected by the UEA subsystem 622 would not necessarily be limited to the particular or specific UE Device interacting with the system, but instead, say for behaviors and/or patterns relative to particular UE Device (e.g. a worst-case scenario) or other cell location, say relative overall traffic patterns, and/or the like.

From step 392, the process advances to a step 393, where a “Collect and/or Project Historical Data Relevant to Similar UE Plans/Spending,” is executed. In various non-limiting embodiments of this disclosure, here the system would preferably collect, evaluate, index, study, and/or test realtime data, historically data, anticipated data, and/or projected data, relative to the historical data relevant to similar UE Plans/Spending, which may occur automatically, conditionally, systematically (e.g. via an artificial intelligent subsystem), separately, simultaneously, anticipated, come from anticipations, projections, and/or the like. Here, the similar UE Plans/Spending data collected by the UEA subsystem 622 is limited to similar UE Plans/Spending and may comprise one or more key statistics, criteria, and/or performance indicators (KPI's), say for contract terms, including, say a current contract start date/end date, previous contract start dates/end dates, devices purchased, minutes consumed when/where, data consumed when/where, SMS consumed when/where, downloads when/where, internet usage when/where, wifi usage when/where, mobile purchases of what, when, where, how, and/or the like. In an alternative embodiment of this disclosure, the UE plan/spending data collected by the UEA subsystem 622 would not necessarily be limited to plans or spending of a similar UE, but instead the plans and/or spending relative to particular cell location, say relative overall UEs under a similar plan, subscription, usage pattern, and/or the like.

In various non-limiting embodiments of this disclosure, the system would preferably electronically store and retrieve UE plans and spending to generate statistical, data, and index the behaviors and patterns relative to how similar or not similar to a particular segment, say of like UEs, like commuters, like UE plans, and/or the like, via a set measurements/metrics. In addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to Similar UE Plans and Spending, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

From step 393, the process advances to a step 394, where a “Collect and/or Project Historical Data Relevant to Specific UE Plans/Spending,” is executed. In various non-limiting embodiments of this disclosure, here the system would preferably collect, evaluate, index, study, and/or test realtime data, historically data, anticipated data, and/or projected data, relative to the historical data relevant to specific UE Plan/Spending, which may occur automatically, conditionally, systematically (e.g. via an artificial intelligent subsystem), separately, simultaneously, anticipated, come from anticipations, projections, and/or the like. Here, the specific UE Plan/Spending data collected by the UEA subsystem 622 is limited to specific UE Plan/Spending and may comprise one or more key statistics, criteria, and/or performance indicators (KPI's), say for a contract term(s), including, say a current contract start date/end date, previous contract start dates/end dates, devices purchased, minutes consumed when/where, data consumed when/where, SMS consumed when/where, downloads when/where, internet usage when/where, wifi usage when/where, mobile purchases of what, when, where, how, and/or the like for the specifically designated UE device. In an alternative embodiment of this disclosure, the UE plan/spending data collected by the UEA subsystem 622 would not necessarily be limited to a plan or spending of the specific UE device interacting at the time, but instead the plan and/or spending relative to a particular cell location, say relative the overall UEs under a specific plan, subscription, usage pattern/segment, and/or the like.

In various non-limiting embodiments of this disclosure, the system would preferably electronically store and retrieve the UE plan and spending to generate statistical, data, and index the behaviors and patterns relative to how similar or not similar to a particular segment, say of like UEs, like commuters, like UE plans, and/or the like, via a set measurements/metrics. In addition to relative to currently proposed NPLs, default NPLs, anticipated NPLs, proposals, criteria, and/or generating anticipated patterns, say relative to areas of perceived congestion, handover failures, peak demand, and/or the like. In various non-limiting embodiments of this disclosure, the system would preferably collect, evaluate, index, study, and/or test realtime data, historically data, anticipated data, and/or projected data, relative to the specific UE Plan and Spending, which could be tracked and tested automatically, conditionally, systematically (e.g. via an artificial intelligent subsystem), separately, simultaneously, and/or the like against assumptions, anticipations, projections, and/or the like, including against, say simulated computer models to test anticipated/projected concerns, issues, and/or reveal anomalies, unperceived/unanticipated/not-projected issues/faults, insufficient-tolerances, potential problems, potential threats, security concerns, opportunities, up-sales, software updates suggested, required, and/or the like.

From step 394, the process advances to a step 395, where a “Generate Neighbor Cell List (NCL) Optimization Proposal &/or Appropriate Criteria (e.g. 1st, 2nd, 3rd, 4th, 5th, &/or 6th Optimization Criteria) (including prioritizing a Primary/Serving Cell, a Secondary Cell (which may or may not also be a Serving Cell), a Tertiary Cell (which may or may not also be a Serving Cell), and so on, per Appropriate Criteria,” is executed. In various non-limiting embodiments of this disclosure, the system would preferably dynamically, intelligently, and electronically, store and retrieve a list of criteria, conditions, and rules to iteratively generate NCLs as required, say automatically, systematically, (via an artificial intelligence subsystem not depicted), conditionally, and/or along with any system-selections/inputs, carrier-selections/inputs, and/or user-selective conditions/inputs, either in advance, relatively recently, relatively realtime, and/or realtime.

In various non-limiting embodiments of this disclosure, the generated dynamic and intelligent criteria may also be prioritized per a particular event, condition, location, user, plan, time of day, series of events, threshold, and/or the like. In various non-limiting embodiments of this disclosure, a set of criteria within a particular criteria (e.g. 1st, 2nd, 3rd, 4th, 5th, &/or 6th Optimization Criteria) may be conditional and/or prioritized per a particular event, condition, location, user, plan, time of day, series of events, threshold, and/or the like. In various non-limiting embodiments of this disclosure, the system would preferably generate, evaluate, index, study, and/or test realtime each generated criteria relative to measurable success for relatively fewer dropped calls, call quality, signal strength relative to a window of time/usage pattern, customer retention, customer satisfaction, customer upgrades (e.g. hardware or software), and/or the like. Further, each generated criteria can be electronically store and retrieve indexed statistical, data, behaviors, and/or patterns relative to collecting relevant data, generating anticipated NPLs, proposals, subsequent criteria, and/or generating anticipated patterns, and tracked and tested against anticipated data, and/or projected data.

In various non-limiting embodiments of this disclosure, a first criteria is the initial or default criteria, a second criteria (and so on) are/is a subsequent criteria or a conditional criteria for a particular set of conditions (say the conditional criteria for a particular time of day, device, user, traffic pattern, plan, history, and/or the like), and/or for a particular level of service, say a simultaneous connection for voice and data, simultaneous connection to more than one voice channel to preserve quality, and/or switch back and forth as necessary to preserve the best condition/quality. In various non-limiting embodiments of this disclosure, each criteria, e.g. the first criteria, second and so on, would preferably be persistently tested and tracked, and/or include data regarding how long each remained active, inactive, what caused the change to inactive, what changes were or have been made and the relative success for each change.

Returning to FIG. 32, from step 395, the process advances to a step 396, where a “Compute appropriate SIB Messages (SIB1 through SIB . . . n) e.g. for Integrity,” is executed. In various non-limiting embodiments of this disclosure, here the system would preferably evaluate the active criteria to determine what specific SIB Messages are required per what particular specifications, routing information, existing and/or potential issues, bottlenecks, and/or the like, to execute the criteria, generate the appropriate SIB Messages and transmit to the appropriate recipients per the criteria.

From step 396, the process advances to a query 397, where the query asks “Does each Necessary SIB Message Pass an Integrity Check?” In various non-limiting embodiments of this disclosure, here the system would preferably evaluate the active criteria to determine what specific SIB Messages pass a specific Integrity Check and/or similar for each necessary SIB Message computed in step 396.

If the answer to query 397 is no, the process returns back to step 361. If the answer to query 397 is instead, “yes,” then process advances to a step 398 with an “Apply Appropriate NCL Optimization Changes & Criteria to Radio Network Controller &/or UE,” is executed. Here, per the relevant criteria, the process may conditionally terminate or loop and return to step 361. In various non-limiting embodiments of this disclosure, the system would preferably monitor the success of delivering each SIB Message, and/or make modifications to the data, criteria, a particular SIB message accordingly, and/or retransmit a particular SIB message if necessary.

The present disclosures may be embodied in other specific apparatus and/or methods. The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the appended claims. Moreover, fabrication details are merely exemplary; the disclosure is defined by the following claims.

What is claimed is:

1. A computer-implemented method for managing a radio network, comprising:
retrieving and evaluating a first criteria electronically stored in an Operation and Administration Maintenance (OAM) module;
obtaining and evaluating capabilities and indicia of an active mobile terminal or User Equipment (UE) in an at least one radio network comprising a plurality of cells or frequencies regarding the capability of the active mobile terminal or User Equipment (UE) for a pairing from an at least one primary cell or frequency to a handover to an at least one secondary cell or frequency in the plurality of cells or frequencies according at least in part to the first criteria;
obtaining and evaluating capabilities and indicia of the at least one radio network comprising a plurality of cells or frequencies regarding the capability of the active mobile terminal or User Equipment (UE) for the pairing from the at least one primary cell or frequency to the handover to the at least one secondary cell or frequency in the plurality of cells or frequencies according at least in part to the first criteria; and
generating a prioritized list of Neighboring Cell or Frequency Candidates (NCFC) according at least in part to the first criteria, wherein OAM persistently generates prioritized NCFC comprising at least two primary cells or frequencies.

2. The computer-implemented method of claim 1, wherein the generated and prioritized list of NCFC comprises prioritized primary cells and secondary cells according at least in part to the first criteria.

3. The computer-implemented method of claim 2, wherein the primary cells or frequencies are sourcing cells or frequencies for an active connection with the active mobile terminal or User Equipment (UE).

4. The computer-implemented method of claim 3, wherein the secondary cells or frequencies are target cells or frequencies for a handover.

5. The computer-implemented method of claim 4, wherein OAM persistently generates prioritized NCFC comprising at least two secondary cells or frequencies.

6. The computer-implemented method of claim 5, wherein OAM persistently generates prioritized NCFC comprising at least two tertiary cells or frequencies.

7. The computer-implemented method of claim 6, wherein the active mobile terminal or User Equipment (UE) can employ more than one primary cell or frequency simultaneously.

8. The computer-implemented method of claim 7, wherein the active mobile terminal or User Equipment (UE) can employ more than one secondary cell or frequency simultaneously.

9. The computer-implemented method of claim 8, wherein an employment of more than one primary cell or frequency simultaneously may be accomplished by a smart transceiver or smart antenna.

10. The computer-implemented method of claim 9, wherein the employment of more than one primary cell or frequency simultaneously may be accomplished by a multi-frequency transceiver or antenna.

11. The computer-implemented method of claim 10, wherein the employment of more than one primary cell or frequency simultaneously may be accomplished by a multi-frequency transceiver or smart antenna.

12. The computer-implemented method of claim 11, wherein a base station selectively transmits to more than one primary cell or frequency simultaneously.

13. The computer-implemented method of claim 12, wherein the base station selectively transmissions to more than one primary cell or frequency simultaneously can employ more than one radio technology.

14. The computer-implemented method of claim 1, wherein the evaluation of the first criteria may occur in part at a base station operatively coupled to the at least one radio network.

15. The computer-implemented method of claim 1, wherein the active mobile terminal or User Equipment (UE) is paired with a Node B belonging to the plurality of cells or frequencies in the at least one radio network.

16. The computer-implemented method of claim 1, wherein the evaluation of the capability of an active mobile terminal or User Equipment (UE) may comprise more than one radio network each comprising the plurality of cells or frequencies regarding the capability of the active mobile terminal or User Equipment (UE) for a handover from the at least one primary cell or frequency to the handover to the at least one secondary cell or frequency in the plurality of cells or frequencies according at least in part to the first criteria.

17. The computer-implemented method of claim 1, wherein the receiving and evaluating of the first criteria, further comprises a second criteria, the second criteria comprising a proximity criteria, a signal strength criteria, a relative historical handover success rate criteria, a quality of service criteria, a bandwidth criteria, a throttle criteria, a congestion limitation criteria, a temporal criteria, an emergency criteria, and an override criteria.

18. The computer-implemented method of claim 1, wherein the receiving and evaluating of the first criteria, further comprises a third criteria, the third criteria comprising a UE device type criteria, a UE software version criteria, a UE plan level criteria, and a UE location criteria, a UE proximity criteria, a UE consumption criteria, a UE usage criteria, a UE history criteria, and a UE exception criteria.

19. The computer-implemented method of claim 1, wherein the obtained and evaluated capabilities and indicia of the active mobile terminal or User Equipment (UE) in an at least one radio network comprising performance measurements (PM) and key performance indicators (KPI).

20. The computer-implemented method of claim 1, wherein the obtained and evaluated capabilities and indicia of the at least one radio network comprising performance measurements (PM) and key performance indicators (KPI).
